(19) United States
(12) Patent Application Publication
(10) Pub. No.: US 2009/0211962 A1
(43) Pub. Date: Aug. 27, 2009

(54) PROCESSING CHAMBERS FOR USE WITH APHERESIS DEVICES

(76) Inventors: Kyungyoon Min, Kildeer, IL (US); Richard I. Brown, Northbrook, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/392,952

(22) Filed: Feb. 25, 2009

Related U.S. Application Data
(60) Provisional application No. 61/031,990, filed on Feb. 27, 2008.

(51) Int. Cl. B01D 33/74

(52) U.S. Cl. 210/378

(57) ABSTRACT

Processing chamber for use with apheresis devices are described herein. An example centrifugal processing chamber includes first and second lateral walls spaced at a distance from one another. Additionally, the example centrifugal processing chamber includes a channel at least partially defined by the first and second lateral walls. Further, the centrifugal processing chamber includes an inlet fluidly coupled to the channel to convey blood to the channel. Further still, the centrifugal processing chamber includes a first outlet fluidly coupled to the channel having a first opening adjacent the first lateral wall. The first outlet is to convey separated plasma from the channel. Additionally, the centrifugal processing chamber includes a second fluid outlet fluidly coupled to the channel having a second opening adjacent the second lateral wall. The second outlet is to convey separated red blood cells from the channel. Additionally, the processing chamber includes a barrier formed along the second lateral wall to intercept platelets. The first and second lateral walls are spaced such that the distance between the first and second lateral walls enables at least one therapeutic unit of single dose platelets to pool adjacent the barrier without spilling into the first outlet or the second outlet.

### RELATED APPLICATION

This patent claims priority to U.S. Provisional Patent Application No. 61/031,990, filed on Feb. 27, 2008, which is hereby incorporated herein by reference in its entirety.

### FIELD OF THE DISCLOSURE

This patent relates generally to processing chambers and, more particularly, to processing chambers for use with apheresis devices.

### BACKGROUND

Today people routinely separate whole blood, usually by centrifugation, into its various therapeutic components, such as red blood cells, platelets, and plasma.

Conventional blood processing methods use durable centrifuge equipment in association with single use, sterile processing systems, typically made of plastic. The operator loads the disposable systems upon the centrifuge before processing and removes them afterwards.

Many conventional blood centrifuges are of a size that does not permit easy transport between collection sites. Furthermore, loading and unloading operations can sometimes be time consuming and tedious.

In addition, a need exists for further improved systems and methods for collecting blood components in a way that lends itself to use in a variety of applications, particularly, but not exclusively, where the operational and performance demands upon such fluid processing systems become more complex and sophisticated, even as the demand for smaller and more portable systems intensifies. The need therefore exists for automated blood processing controllers that can gather and generate more detailed information and control signals to aid the operator in maximizing processing and separation efficiencies.

The present subject matter described below has particular, but not exclusive application, in portable blood processing systems, such as those described in U.S. Pat. Nos. 6,348,156; 6,875,191; 7,011,761; 7,087,177; and 7,297,272 and U.S. Patent Application Publication No. 2005/0137516, which are hereby incorporated herein by reference, and such as embodied in the ALYX® blood processing systems marketed by Fenwal, Inc. of Lake Zurich, Ill.

### SUMMARY

An example processing chamber for use with apheresis devices are described herein. An example centrifugal processing chamber includes first and second lateral walls spaced at a distance from one another. Additionally, the example centrifugal processing chamber includes a channel at least partially defined by the first and second lateral walls. Further, the centrifugal processing chamber includes an inlet fluidly coupled to the channel to convey blood to the channel. Further still, the centrifugal processing chamber includes a first outlet fluidly coupled to the channel having a first opening adjacent the first lateral wall. The first outlet is to convey separated plasma from the channel. Additionally, the centrifugal processing chamber includes a second fluid outlet fluidly coupled to the channel having a second opening adjacent the second lateral wall. The second outlet is to convey separated red blood cells from the channel. Additionally, the processing chamber includes a barrier formed along the second lateral wall to intercept platelets. The first and second lateral walls are spaced such that the distance between the first and second lateral walls enables at least one therapeutic unit of single dose platelets to pool adjacent the barrier without spilling into the first outlet or the second outlet.

### BRIEF DESCRIPTION OF THE DRAWINGS

FIG. 1 is a perspective view of a blood or blood component processing system, with the disposable processing set of the system shown out of association with the processing device prior to use.

FIG. 2 is a perspective view of the system shown in FIG. 1, with the doors to the centrifuge station and pump and valve station being shown open to accommodate mounting of the processing set.

FIG. 3 is a perspective view of the system shown in FIG. 1 with the processing set fully mounted on the processing device and ready for use.

FIG. 4 is a right perspective front view of the case that houses the processing device shown in FIG. 1, with the lid closed for transporting the device.

FIG. 5 is a schematic view of a blood processing circuit, which can be programmed to perform a variety of different blood processing procedures in association with the device shown in FIG. 1.

FIG. 6 is an exploded perspective view of a cassette, which contains the programmable blood processing circuit shown in FIG. 5, and the pump and valve station on the processing device shown in FIG. 1, which receives the cassette for use.

FIG. 7 is a plane view of the front side of the cassette shown in FIG. 6.

FIG. 8 is an enlarged perspective view of a valve station on the cassette shown in FIG. 6.

FIG. 9 is a plane view of the back side of the cassette shown in FIG. 6.

FIG. 10 is a plane view of a universal processing set, which incorporates the cassette shown in FIG. 6, and which can be mounted on the device shown in FIG. 1, as shown in FIGS. 2 and 3.

FIG. 11 is a top section view of the pump and valve station in which the cassette as shown in FIG. 6 is carried for use.

FIG. 12 is a schematic view of a pneumatic manifold assembly, which is part of the pump and valve station shown in FIG. 6, and which supplies positive and negative pneumatic pressures to convey fluid through the cassette shown in FIGS. 7 and 9.

FIG. 13 is a perspective front view of the case that houses the processing device, with the lid open for use of the device, and showing the location of various processing elements housed within the case.

FIG. 14 is a schematic view of the controller that carries out the process control and monitoring functions of the device shown in FIG. 1.

FIGS. 15A, 15B, and 15C are schematic side views of the processing chamber 18 (e.g., blood separation chamber) that the device shown in FIG. 1 incorporates, showing the plasma and red blood cell collection tubes and the associated two in-line sensors, which detect a normal operating condition (FIG. 15A), an overspill condition (FIG. 15B), and an underspill condition (FIG. 15C).

FIG. 16 is a perspective view of a fixture that, when coupled to the plasma and red blood cell collection tubes hold the tubes in a desired viewing alignment with the in-line sensors, as shown in FIGS. 15A, 15B, and 15C.

FIG. 17 is a perspective view of the fixture shown in FIG. 16, with a plasma cell collection tube, a red blood cell collection tube, and a whole blood inlet tube attached, gathering the tubes in an organized, side-by-side array.

FIG. 18 is a perspective view of the fixture and tubes shown in FIG. 17, as being placed into viewing alignment with the two sensors shown in FIGS. 15A, 15B, and 15C.

FIG. 19 is a schematic view of the sensing station, of which the first and second sensors shown in FIGS. 15A, 15B, and 15C form a part.

FIG. 20 is a graph of optical densities as sensed by the first and second sensors plotted over time, showing an underspill condition.

FIG. 21 is an exploded top perspective view of a molded centrifugal blood processing container, which can be used in association with the device shown in FIG. 1.

FIG. 22 is a bottom perspective view of the molded processing container shown in FIG. 21.

FIG. 23 is a top view of the molded processing container shown in FIG. 21.

FIG. 24 is a side section view of the molded processing container shown in FIG. 21, showing an umbilicus to be connected to the container.

FIG. 24A is a top view of the connector that connects the umbilicus to the molded processing container in the manner shown in FIG. 24, taken generally along line 24A-24A in FIG. 24.

FIG. 25 is a side section view of the molded processing container shown in FIG. 24, after connection of the umbilicus to the container.

FIG. 26 is an exploded, perspective view of the centrifuge station of the processing device shown in FIG. 1, with the processing container mounted for use.

FIG. 27 is a further exploded, perspective view of the centrifuge station and processing container shown in FIG. 26.

FIG. 28 is a side section view of the centrifuge station of the processing device shown in FIG. 26, with the processing container mounted for use.

FIG. 29 is a top view of a molded centrifugal blood processing container as shown in FIGS. 21 to 23, showing a flow path arrangement for separating whole blood into plasma and red blood cells.

FIGS. 30 to 33 are top views of molded centrifugal blood processing containers as shown in FIGS. 21 to 23, showing other flow path arrangements for separating whole blood into plasma and red blood cells.

FIG. 34 is a schematic view of another blood processing circuit, which can be programmed to perform a variety of different blood processing procedures in association with the device shown in FIG. 1.

FIG. 35 is a plane view of the front side of a cassette, which contains the programmable blood processing circuit shown in FIG. 34.

FIG. 36 is a plane view of the back side of the cassette shown in FIG. 35.

FIGS. 37A to 37E are schematic views of the blood processing circuit shown in FIG. 34, showing the programming of the cassette to carry out different fluid flow tasks in connection with processing whole blood into plasma and red blood cells.

FIGS. 38A and 38B are schematic views of the blood processing circuit shown in FIG. 34, showing the programming of the cassette to carry out fluid flow tasks in connection with on-line transfer of an additive solution into red blood cells separated from whole blood.

FIGS. 39A and 39B are schematic views of the blood processing circuit shown in FIG. 34, showing the programming of the cassette to carry out fluid flow tasks in connection with on-line transfer of red blood cells separated from whole blood through a filter to remove leukocytes.

FIG. 40 is an example of a weigh scale suited for use in association with the device shown in FIG. 1.

FIG. 41 is an example of another weigh scale suited for use in association with the device shown in FIG. 1.

FIG. 42 is a schematic view of a flow rate sensing and control system for a pneumatic pump chamber employing an electrode to create an electrical field inside the pump chamber.

FIG. 43 is a schematic view of a pneumatic manifold assembly, which is part of the pump and valve station shown in FIG. 6, and which supplies positive and negative pneumatic pressures to convey fluid through the cassette shown in FIGS. 35 and 36.

FIG. 44 is a top plan view of another example of a blood processing chamber suitable for use with the blood processing systems and methods of the present disclosure.

FIG. 45 is front perspective view of the blood processing chamber of FIG. 44, with a portion thereof cut away for illustrative purposes.

FIG. 46 is a top plan view of the blood processing chamber of FIG. 44, illustrating the relative positions of separated blood components during an exemplary blood component collection procedure.

FIG. 47 is a plane view of a disposable set, which can be mounted on the device shown in FIG. 1.

FIG. 48 is a plane view of another disposable set, which can be mounted on the device shown in FIG. 1.

FIG. 49 is a plane view of the front side of a cassette having fourteen ports.

FIG. 50 is a plane view of the rear side of the cassette of FIG. 49.

FIG. 51 is a schematic view of a blood processing circuit defined by the cassette of FIGS. 49 and 50, which can be programmed to perform a variety of different blood processing procedures in association with the device shown in FIG. 1.

FIGS. 52A and 52B are schematic views of the blood processing circuit of FIG. 51, showing the programming of the cassette to carry out different fluid flow tasks in connection with drawing whole blood from a blood source.

FIG. 53 is a schematic view of the blood processing circuit of FIG. 51, showing the programming of the cassette to carry out different fluid flow tasks in connection with separating whole blood into constituent layers.

FIGS. 54A-54C are schematic views of an interleaving process for returning excess red blood cells and plasma to the blood source.

FIGS. 55A and 55B are schematic views of the blood processing circuit of FIG. 51, showing the programming of the cassette to carry out different fluid flow tasks in connection with establishing a target hematocrit in the blood processing chamber.

FIGS. 56A and 56B are schematic views of the blood processing circuit of FIG. 51, showing the programming of the cassette to carry out different fluid flow tasks in connection with recombining the previously separated blood components.

FIG. 57 is a schematic view of the blood processing circuit of FIG. 51, showing the programming of the cassette to carry out different fluid flow tasks in connection with priming the tubing leading to a platelet storage solution container.

FIGS. 58A and 58B are schematic views of the blood processing circuit of FIG. 51, showing the programming of the cassette to carry out different fluid flow tasks in connection with re-separating the previously recombined blood components.

FIG. 59A is a graphical representation of the recirculation rate (in ml/min) versus the platelet concentration in a sample collected radially inward of the red blood cell and plasma interface which has been collected after a predetermined period of recirculation.

FIG. 59B is a graphical representation of the recirculation rate (in ml/min) versus the white blood cell count in a sample collected radially inward of the red blood cell and plasma interface which has been collected after a predetermined period of recirculation.

FIG. 60A is a schematic view of the blood processing circuit of FIG. 51, showing the programming of the cassette to carry out different fluid flow tasks in connection with harvesting platelets using platelet poor plasma.

FIG. 60B is a schematic view of the blood processing circuit of FIG. 51, showing the programming of the cassette to carry out different fluid flow tasks in connection with harvesting platelets using a (non-plasma) platelet storage solution.

FIG. 61A is a graphical representation of white blood cell contamination of a collected platelet product during a platelet harvesting stage.

FIGS. 61B-61D are graphical representations of processing chamber spin speed profiles adapted to minimize the white blood cell contamination illustrated in FIG. 61A.

FIG. 62 is a schematic view of the blood processing circuit of FIG. 51, showing the programming of the cassette to carry out different fluid flow tasks in connection with harvesting red blood cells.

FIGS. 63A-63D are schematic views of an automated burping procedure for removing excess air from a flexible bag containing an amount of a collected blood component.

FIGS. 64A-64C are schematic views of the blood processing circuit of FIG. 51, showing the programming of the cassette to carry out different fluid flow tasks in connection with mixing packed red cells and an additive solution.

FIG. 65 is a plane view of a disposable set, which can be mounted on the device shown in FIG. 1.

FIG. 66 is a plane view of another disposable set, which can be mounted on the device shown in FIG. 1.

FIGS. 67A-67E are schematic views of the blood processing circuit of FIG. 51, showing the programming of the cassette to carry out different fluid flow tasks in connection with collecting a separated blood component and flushing excess separated blood components from a processing system to a blood source.

FIG. 68 is a schematic view of the blood processing circuit of FIG. 51, showing the programming of the cassette to carry out different fluid flow tasks in connection with flushing blood components from a processing chamber.

FIGS. 69A-69C are schematic views of the blood processing circuit of FIG. 51, showing the programming of the cassette to carry out different fluid flow tasks in connection with returning blood components from a processing chamber to a blood source.

The foregoing summary, as well as the following detailed description of certain example implementations, will be better understood when read in conjunction with the appended drawings. For the purpose of illustrating the example methods, systems and apparatus described herein, certain implementations are shown in the drawings. It should be understood, however, that the example methods, systems and apparatus are not limited to the arrangements and instrumentality shown in the attached drawings.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

In some examples, a fixed-volume centrifugable device which, in use, operates to separate blood into a red blood cell layer, a plasma layer, and a layer containing platelets, comprises a channel defined by an inner channel wall and an outer channel wall. The device also includes an inlet in fluid communication with the channel to convey blood into the device, a first outlet in fluid communication with the channel and positioned along the inner channel wall to convey a flow of separated plasma from the device, and a second outlet in fluid communication with the channel and positioned along the outer channel wall to convey a flow of separated red blood cells from the device. A barrier is disposed in the channel to intercept a layer containing platelets, with the inner channel wall being sufficiently spaced from the outer channel wall to allow at least one therapeutic unit of single dose platelets to pool at the barrier without spilling into the first outlet or the second outlet.

In some examples, a blood separation method comprises conveying blood into a fixed-volume device having a first outlet, a second outlet, and a barrier. The device is spun at a separation speed sufficient to separate the blood in the device into a red blood cell layer, a plasma layer, and an interface layer containing platelets. A flow of the separated plasma from the device is conveyed through the first outlet and a flow of the separated red blood cells is conveyed from the device through the second outlet, while retaining substantially all of the interface layer containing platelets in a pool upstream of the barrier. Plasma and red blood cells continue to be conveyed from the device until at least one therapeutic unit of single dose platelets is contained in said pool upstream of the barrier.

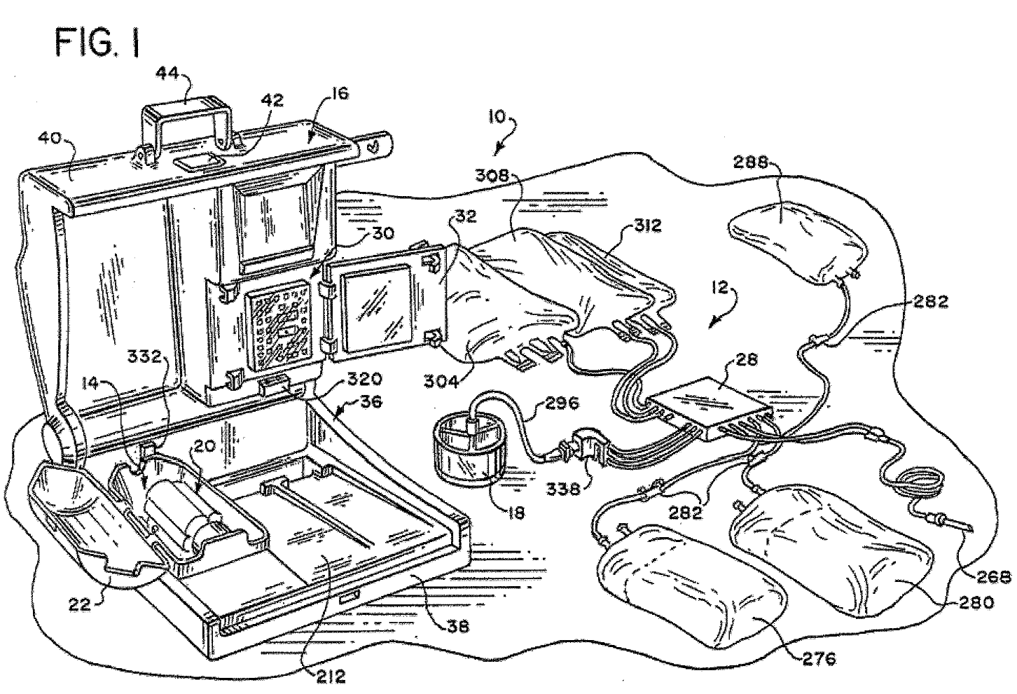

FIG. 1 shows a fluid processing system or apheresis device 10 that embodies various aspects of the present subject matter. The system 10 can be used for processing various fluids. The system 10 is particularly well suited for processing whole blood and other suspensions of biological cellular materials. Accordingly, the illustrated example shows the system 10 used for this purpose.

### I. System Overview

The system 10 includes three principal components. These are (i) a liquid and blood flow set 12; (ii) a blood processing device 14 that interacts with the flow set 12 to cause separation and collection of one or more blood components; and (iii) a controller 16 that governs the interaction to perform a blood processing and collection procedure selected by the operator.

### A. The Processing Device and Controller

The blood processing device 14 and the controller 16 are intended to be durable items capable of long term use. In the illustrated example, the blood processing device 14 and the controller 16 are mounted inside a portable housing or case 36. The case 36 presents a compact footprint, suited for set up and operation upon a table top or other relatively small surface. The case 36 is also intended to be transported easily to a collection site.

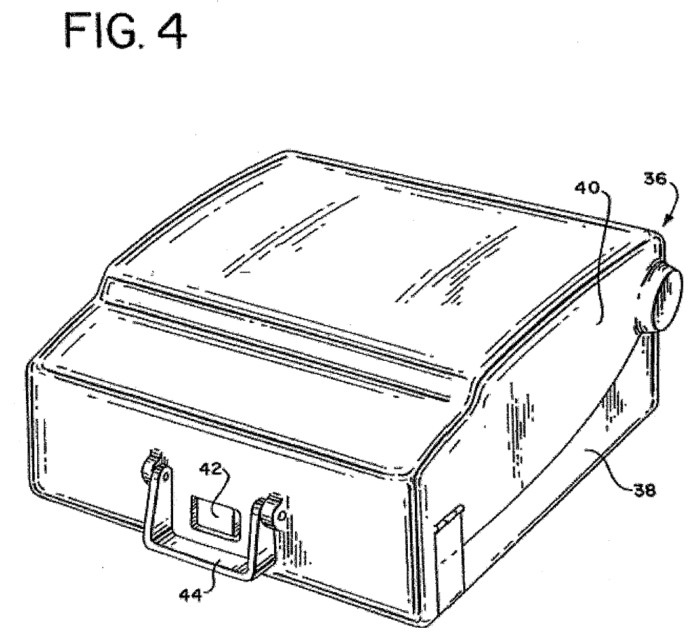

The case 36 includes a base 38 and a hinged lid 40, which opens (as FIG. 1 shows) and closes (as FIG. 4 shows). The lid 40 includes a latch 42, for releasably locking the lid 40 closed. The lid 40 also includes a handle 44, which the operator can grasp for transporting the case 36 when the lid 40 is closed. In use, the base 38 is intended to rest in a generally horizontal support surface.

The case 36 can be formed into a desired configuration, e.g., by molding. In one example, the case 36 is made from a lightweight, yet durable, plastic material.

### B. The Flow Set

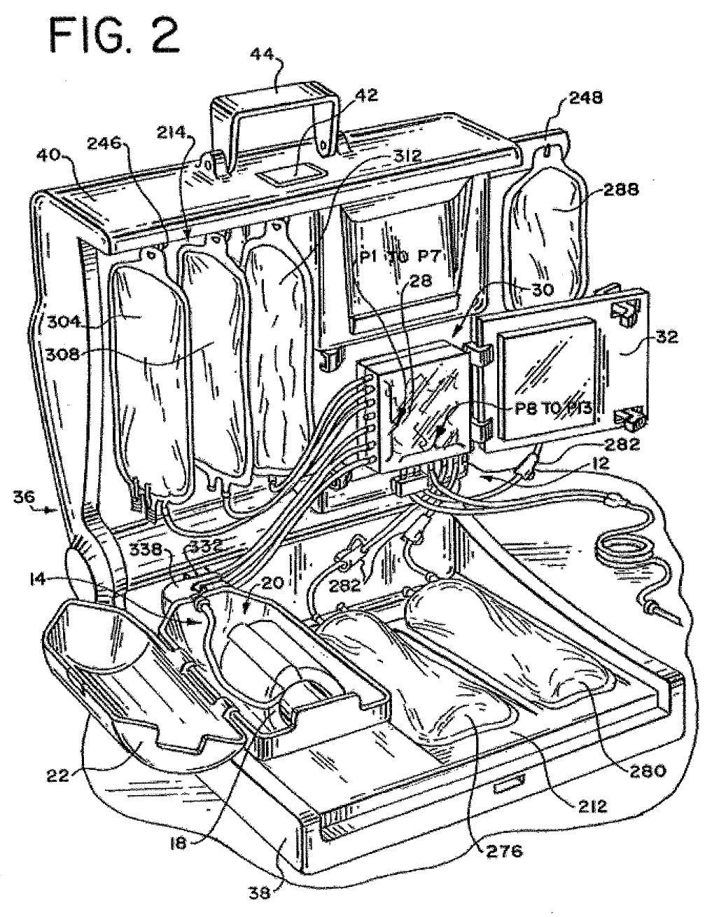

The flow set 12 is intended to be a sterile, single use, disposable item. As FIG. 2 shows, before beginning a given blood processing and collection procedure, the operator loads various components of the flow set 12 in the case 36 in association with the device 14. The controller 16 implements the procedure based upon preset protocols, taking into account other input from the operator. Upon completing the procedure, the operator removes the flow set 12 from association with the device 14. The portions of the set 12 holding the collected blood component or components are removed from the case 36 and retained for storage, transfusion, or further processing. The remainder of the set 12 is removed from the case 36 and discarded.

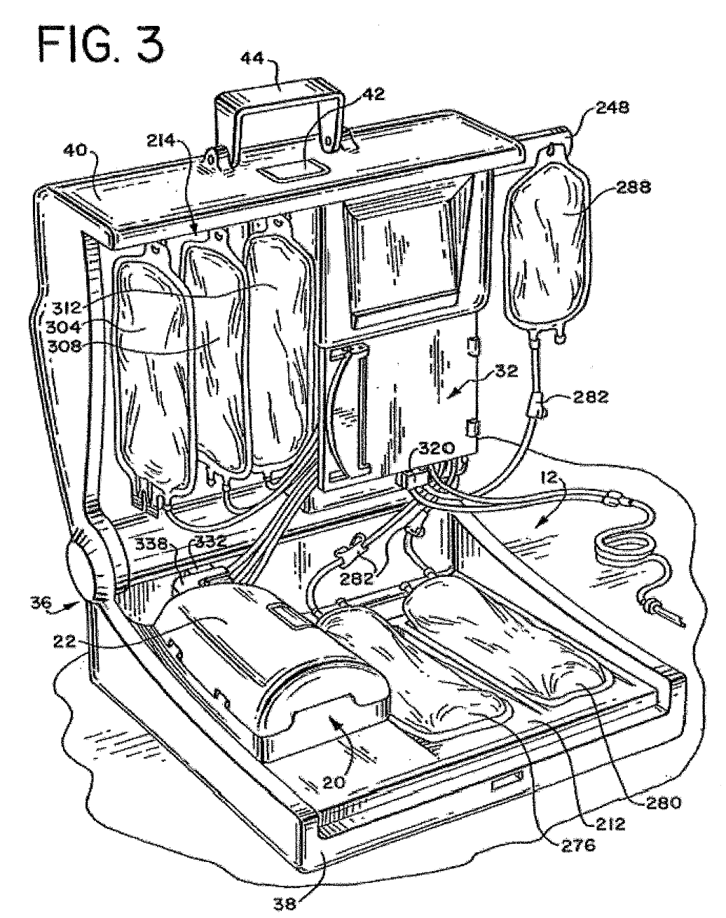

The flow set 12 shown in FIG. 1 includes a blood processing chamber or processing chamber 18 designed for use in association with a centrifuge. Accordingly, as FIG. 2 shows, the processing device 14 includes a centrifuge station 20, which receives the processing chamber 18 for use. As FIGS. 2 and 3 show, the centrifuge station 20 comprises a compartment formed in the base 38. The centrifuge station 20 includes a door 22, which opens and closes the compartment. The door 22 opens to allow loading of the processing chamber 18. The door 22 closes to enclose the processing chamber 18 during operation.

The flow set 12 shown in FIG. 1 includes a blood processing chamber 18 designed for use in association with a centrifuge. Accordingly, as FIG. 2 shows, the processing device 14 includes the centrifuge station 20, which receives the processing chamber 18 for use. As FIGS. 2 and 3 show, the centrifuge station 20 comprises a compartment formed in the base 38. The centrifuge station 20 includes a door 22, which opens and closes the compartment. The door 22 opens to allow loading of the processing chamber 18. The door 22 closes to enclose the processing chamber 18 during operation.

It should also be appreciated that the system 10 need not separate blood centrifugally. The system 10 can accommodate other types of blood separation devices, e.g., a membrane blood separation device.

### II. The Programmable Blood Processing Circuit

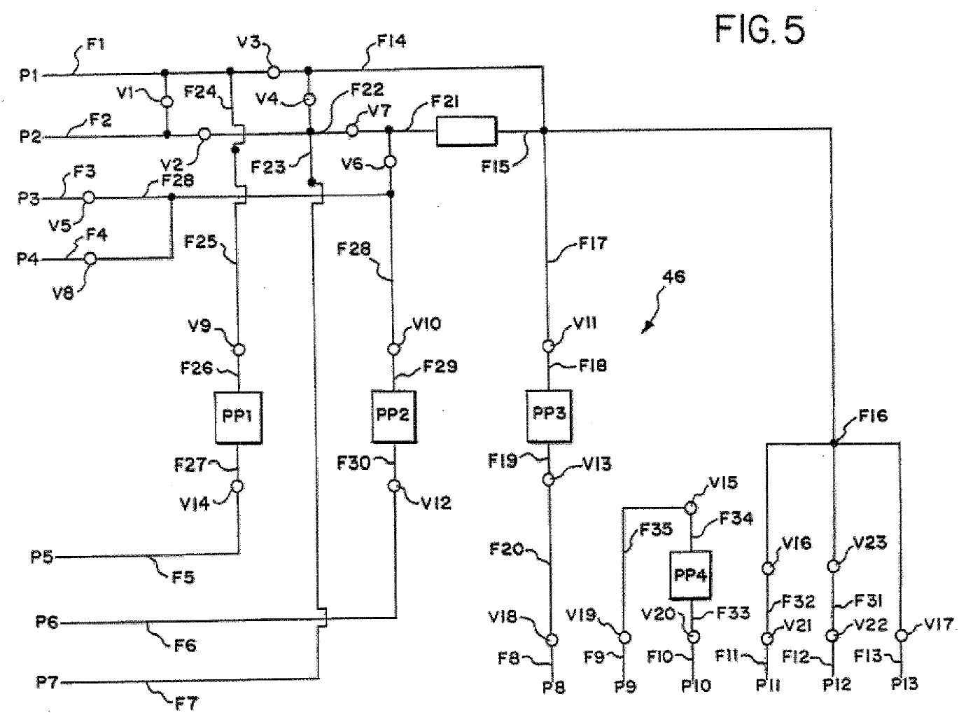

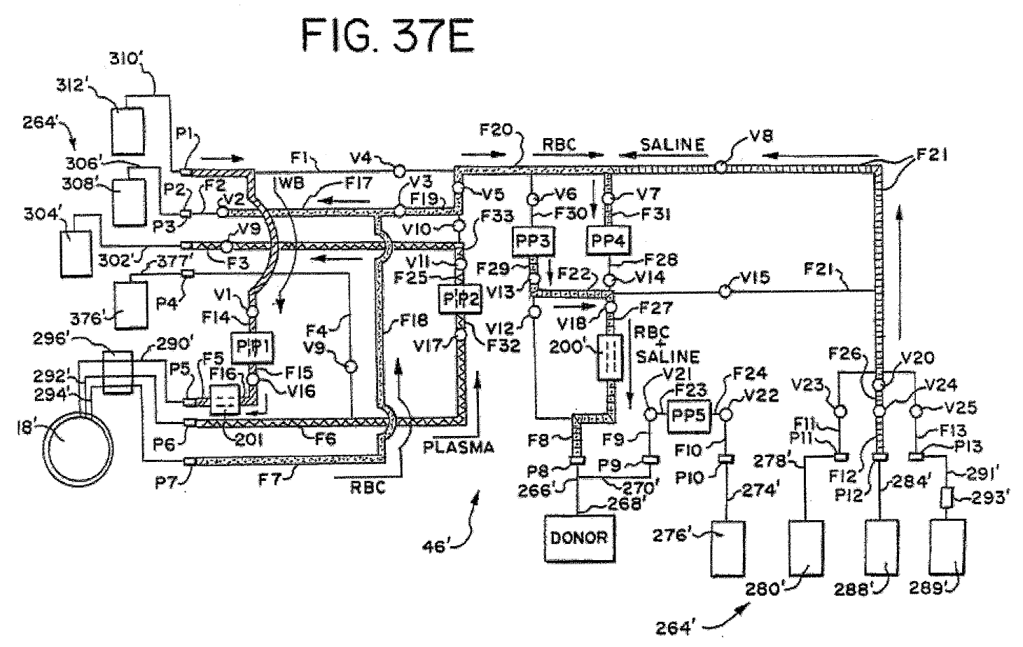

The set 12 defines a programmable blood processing circuit 46. Various configurations are possible. FIG. 5 schematically shows one representative configuration. FIG. 34 schematically shows another representative configuration, which will be described later.

Referring to FIG. 5, the circuit 46 can be programmed to perform a variety of different blood processing procedures in which, e.g., red blood cells are collected, or plasma is collected, or both plasma and red blood cells are collected, or the buffy coat is collected.

The circuit 46 includes several pump stations PP(N), which are interconnected by a pattern of fluid flow paths F(N) through an array of in-line valves V(N). The circuit is coupled to the remainder of the blood processing set by ports P(N).

The circuit 46 includes a programmable network of flow paths, comprising eleven universal ports P1 to P8 and P11 to P13 and three universal pump stations PP1, PP2, and PP3. By selective operation of the in-line valves V1 to V14, V16 to V18, and V21 to 23, any of the universal port P1 to P8 and P11 to P13 can be placed in flow communication with any universal pump station PP1, PP2, and PP3. By selective operation of the universal valves, fluid flow can be directed through any universal pump station in a forward direction or reverse direction between two valves, or an in-out direction through a single valve.

In the illustrated example, the circuit also includes an isolated flow path comprising two ports P9 and P10 and one pump station PP4. The flow path is termed “isolated,” because it cannot be placed into direct flow communication with any other flow path in the circuit 46 without exterior tubing. By selective operation of the in-line valves V15, V19, and V20, fluid flow can be directed through the pump station in a forward direction or reverse direction between two valves, or an in-out direction through a single valve.

The circuit 46 can be programmed to assigned dedicated pumping functions to the various pump stations. For example, in one example, the universal pump station PP3 can serve as a general purpose, donor interface pump, regardless of the particular blood procedure performed, to either draw blood from the donor or return blood to the donor through the port P8. In this arrangement, the pump station PP4 can serve as a dedicated anticoagulant pump, to draw anticoagulant from a source through the universal port P10 and to meter anticoagulant into the blood through the universal port P9.

In this arrangement, the universal pump station PP1 can serve, regardless of the particular blood processing procedure performed, as a dedicated in-process whole blood pump, to convey whole blood into the blood separator 18′. This dedicated function frees the donor interface pump PP3 from the added function of supplying whole blood to the blood separator 18′. Thus, the in-process whole blood pump PP1 can maintain a continuous supply of blood to the blood separator 18′, while the donor interface pump PP3 is simultaneously used to draw and return blood to the donor through the single phlebotomy needle. Processing time is thereby minimized.

In this arrangement, the universal pump station PP2 can serve, regardless of the particular blood processing procedure performed, as a plasma pump, to convey plasma from the blood separator 18′. The ability to dedicate separate pumping functions provides a continuous flow of blood into and out of the separator, as well as to and from the donor.

The circuit 46 can be programmed, depending upon the objectives of the particular blood processing procedure, to retain all or some of the plasma for storage or fractionation purposes, or to return all or some of the plasma to the donor. The circuit 46 can be further programmed, depending upon the objectives of the particular blood processing procedure, to retain all or some of the red blood cells for storage, or to return all or some of the red blood cells to the donor. The circuit 46 can also be programmed, depending upon the objectives of the particular blood processing procedure, to retain all or some of the buffy coat for storage, or to return all or some of the buffy coat to the donor.

### A. The Cassette

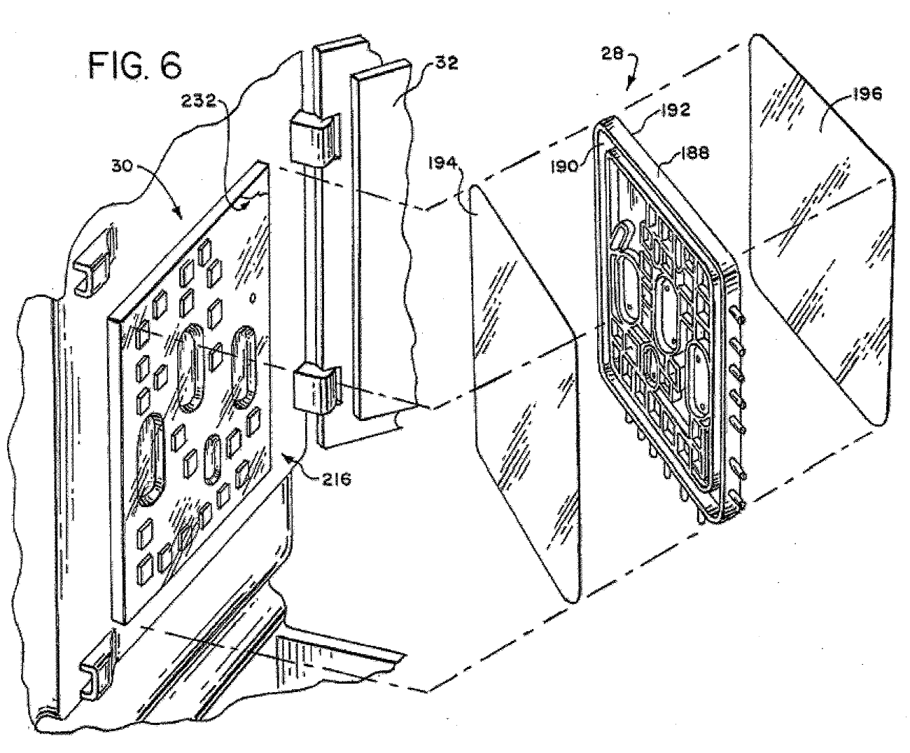

In one example, the programmable fluid circuit 46 is implemented by use of a fluid pressure actuated cassette 28 (see FIG. 6). The cassette 28 provides a centralized, programmable, integrated platform for all the pumping and valving functions required for a given blood processing procedure. In the illustrated example, the fluid pressure comprises positive and negative pneumatic pressure. Other types of fluid pressure can be used.

As FIG. 6 shows, the cassette 28 interacts with a pneumatic actuated pump and valve station 30, which is mounted in the lid 40 of the case 36 (see FIG. 1). The cassette 28 is, in use, mounted in the pump and valve station 30. The pump and valve station 30 apply positive and negative pneumatic pressure upon the cassette 28 to direct liquid flow through the circuit. Further details will be provided later.

The cassette 28 can take various forms. As illustrated (see FIG. 6), the cassette 28 comprises an injection molded body or cassette body 188 having a front side 190 and a back side 192. For the purposes of description, the front side 190 is the side of the cassette 28 that, when the cassette 28 is mounted in the pump and valve station 30, faces away from the operator. First and second flexible diaphragms 194 and 196 overlay both the front side 190 and the back side 192 of the cassette 28, respectively.

The cassette body 188 is advantageously made of a rigid medical grade plastic material. The flexible diaphragms 194 and 196 are made of a flexible material, for example, sheets of medical grade plastic. The flexible diaphragms 194 and 196 are sealed about their peripheries to the peripheral edges of the front and back sides of the cassette body 188. Interior regions of the flexible diaphragms 194 and 196 can also be sealed to interior regions of the cassette body 188.

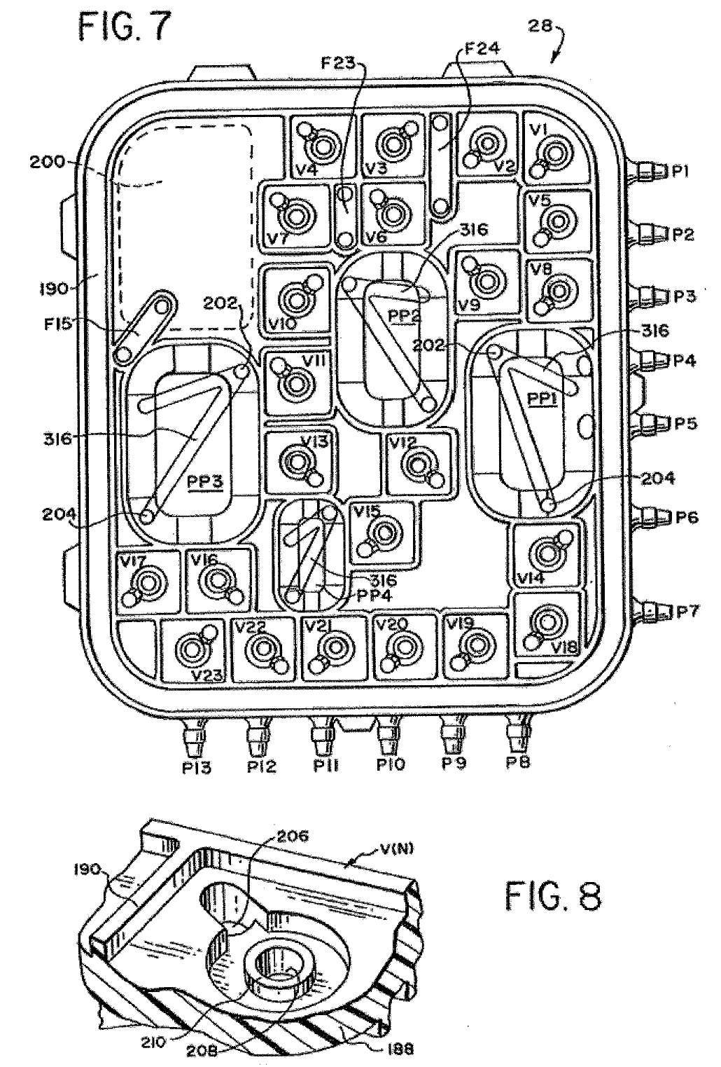

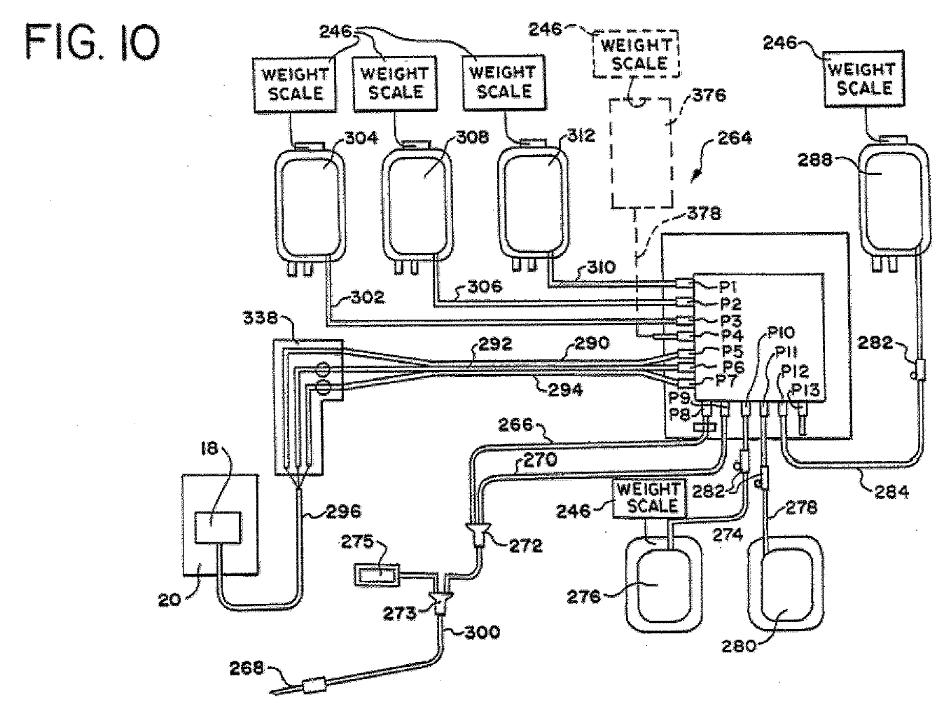

The cassette body 188 has an array of interior cavities formed on both the front and back sides 190 and 192 (see FIGS. 7 and 9). The interior cavities define the valve stations and flow paths shown schematically in FIG. 5. An additional interior cavity is provided in the back side of the cassette 28 to form a station that holds a filter material 200. In the illustrated example, the filter material 200 comprises an overmolded mesh filter construction. The filter material 200 is intended, during use, to remove clots and cellular aggregations that can form during blood processing.

The pump stations PP1 to PP4 are formed as wells that are open on the front side 190 of the cassette body 188. Upstanding edges peripherally surround the open wells of the pump stations. The pump wells are closed on the back side 192 of the cassette body 188, except for a spaced pair of through holes or ports 202 and 204 for each pump station. The ports 202 and 204 extend through to the back side 192 of the cassette body 188. As will become apparent, either port 202 or 204 can serve its associated pump station as an inlet or an outlet, or both inlet and outlet.

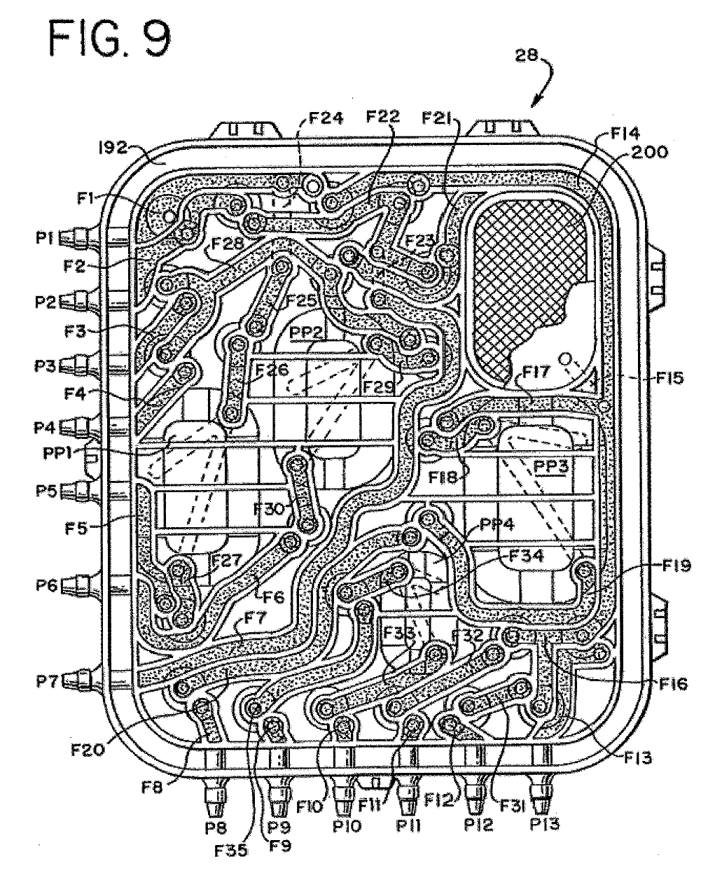

The in-line valves V1 to V23 are likewise formed as wells that are open on the front side 190 of the cassette 28. FIG. 8 shows a typical valve V(N). Upstanding edges peripherally surround the open wells of the valves on the front side 190 of the cassette body 188. The valves are closed on the back side 192 of the cassette 28, except that each valve includes a first and second through hole and/or port 206 and 208, respectively. The first port 206 communicates with a selected liquid path on the back side 192 of the cassette body 188. The second port 208 communicates with another selected liquid path on the back side 192 of the cassette body 188.

In each valve, a valve seat 210 extends about the second port 208. The valve seat 210 is recessed below the surface of the recessed valve well, such that the second port 208 is essentially flush with the surrounding surface of the recessed valve well, and the valve seat 210 extends below the surface of the valve well.

The first flexible diaphragm 194 overlying the front side 190 of the cassette 28 rests against the upstanding peripheral edges surrounding the pump stations and valves. With the application of positive force uniformly against this side of the cassette body 188, the first flexible diaphragm 194 seats against the upstanding edges. The positive force forms peripheral seals about the pump stations and valves. This, in turn, isolates the pumps and valves from each other and the rest of the system. The pump and valve station 30 applies positive force to the front side 190 of the cassette body 188 for this purpose.

Further localized application of positive and negative fluid pressures upon the regions of the first flexible diaphragm 194 overlying these peripherally sealed areas serve to flex the diaphragm regions in these peripherally sealed areas. These localized applications of positive and negative fluid pressures on these diaphragm regions overlying the pump stations serve to expel liquid out of the pump stations (with application of positive pressure) and draw liquid into the pump stations (with application of negative pressure).

In the illustrated example, the bottom of each pump station PP1 to PP4 includes a recessed race 316 (see FIG. 7). The recessed race 316 extends between the ports 202 and 204, and also includes a dogleg extending at an angle from the top port 202. The recessed race 316 provides better liquid flow continuity between the ports 202 and 204, particularly when the diaphragm region is forced by positive pressure against the bottom of the pump station. The recessed race 316 also prevents the diaphragm region from trapping air within the pump station. Air within the pump station is forced into the recessed race 316, where it can be readily venting through the top port 202 out of the pump station, even if the diaphragm region is bottomed out in the station.

Likewise, localized applications of positive and negative fluid pressure on the diaphragm regions overlying the valves will serve to seat (with application of positive pressure) and unseat (with application of negative pressure) these diaphragm regions against the valve seats, thereby closing and opening the associated valve port. The flexible diaphragm is responsive to an applied negative pressure for flexure out of the valve seat 210 to open the respective port. The flexible diaphragm is responsive to an applied positive pressure for flexure into the valve seat 210 to close and seal the respective port. When so flexed, the flexible diaphragm forms within the recessed valve seat 210 a peripheral seal about the second port 208.

In operation, the pump and valve station 30 applies localized positive and negative fluid pressures to these regions of the first flexible diaphragm 194 (e.g., the front diaphragm 194) for opening and closing the valve ports.

The liquid paths F1 to F35 are formed as elongated channels that are open on the back side 192 of the cassette body 188, except for the liquid paths F15, F23, and F24 are formed as elongated channels that are open on the front side 190 of the cassette body 188. The liquid paths are shaded in FIG. 9 to facilitate their viewing. Upstanding edges peripherally surround the open channels on the front and back sides 190 and 192 of the cassette body 188.

The liquid paths F1 to F35 (except for liquid paths F15, F23, and F24) are closed on the front side 190 of the cassette body 188, except where the channels cross over valve station ports or pump station ports. Likewise, the liquid paths F15, F23, and F24 are closed on the back side 192 of the cassette body 188, except where the channels cross over in-line ports communicating with certain channels on the back side 192 of the cassette 28.

The flexible diaphragms 194 and 196 overlying the front and back sides 190 and 192 of the cassette body 188 rest against the upstanding peripheral edges surrounding the liquid paths F1 to F35. With the application of positive force uniformly against the front and back sides 190 and 192 of the cassette body 188, the flexible diaphragms 194 and 196 seat against the upstanding edges. This forms peripheral seals along the liquid paths F1 to F35. In operation, the pump and valve station 30 applies positive force to the flexible diaphragms 194 and 196 for this purpose.

The universal ports P1 to P13 extend out along two side edges of the cassette body 188. The cassette 28 is vertically mounted for use in the pump and valve station 30 (see FIG. 2). In this orientation, the universal ports P8 to P13 face downward, and the universal ports P1 to P7 are vertically stacked one above the other and face inward.

As FIG. 2 shows, the universal ports P8 to P13, by facing downward, are oriented with container support trays 212 formed in the base 38, as will be described later. The universal ports P1 to P7, facing inward, are oriented with the centrifuge station 20 and a container weigh station 214, as will also be described in greater detail later. The orientation of the universal ports P5 to P7 (which serve the processing chamber 18) below the universal ports P1 to P4 keeps air from entering the processing chamber 18.

This ordered orientation of the ports provides a centralized, compact unit aligned with the operative regions of the case 36.

### B. The Universal Set

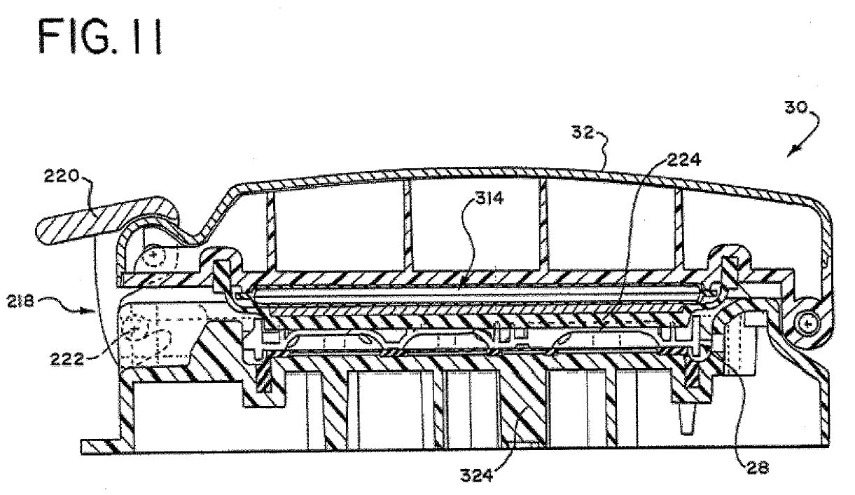

FIG. 10 schematically shows a universal set 264, which, by selective programming of the blood processing circuit 46 implemented by the cassette 28, is capable of performing several different blood processing procedures.

The universal set 264 includes a donor tube 266, which is attached (through y-connectors 272 and 273) to tubing 300 having an attached phlebotomy needle 268. The donor tube 266 is coupled to the port P8 of the cassette 28.

A container 275 for collecting an in-line sample of blood drawn through the tubing 300 is also attached through the y-connector 273.

An anticoagulant tube 270 is coupled to the phlebotomy needle 268 via the y-connector 272. The anticoagulant tube 270 is coupled to cassette port P9. A container 276 holding anticoagulant is coupled via a tube 274 to the universal port P10. The anticoagulant tube 270 carries an external, manually operated in-line clamp 282 of conventional construction.

A container 280 holding a red blood cell additive solution is coupled via a tube 278 to the cassette port P3. The tube 278 also carries an external, manually operated in-line clamp 282.

A container 288 holding saline is coupled via a tube 284 to the universal port P12.

FIG. 10 shows the fluid holding containers 276, 280, and 288 as being integrally attached during manufacture of the set 264. Alternatively, all or some of the containers 276, 280, and 288 can be supplied separate from the set 264. The containers 276, 280, and 288 may be coupled by conventional spike connectors, or the set 264 may be configured to accommodate the attachment of the separate container or containers at the time of use through a suitable sterile connection, to thereby maintain a sterile, closed blood processing environment. Alternatively, the tubes 274, 278, and 284 can carry an in-line sterilizing filter and a conventional spike connector for insertion into a container port at time of use, to thereby maintain a sterile, closed blood processing environment.

The set 264 further includes tubes 290, 292, 294, which extend to an umbilicus 296. When installed in the processing station, the umbilicus 296 links the processing chamber 18 (e.g., rotating processing chamber) with the cassette 28 without need for rotating seals. Further details of this construction will be provided later.

The tubes 290, 292, and 294 are coupled, respectively, to the cassette ports P5, P6, and P7. The tube 290 conveys whole blood into the processing chamber 18. The tube 292 conveys plasma from the processing chamber 18. The tube 294 conveys red blood cells from processing chamber 18.

A plasma collection container 304 is coupled by a tube 302 to the cassette port P3. The collection container 304 is intended, in use, to serve as a reservoir for plasma during processing.

A red blood cell collection container 308 is coupled by a tube 306 to the cassette port P2. The collection container 308 is intended, in use, to receive a first unit of red blood cells for storage.

A whole blood reservoir 312 is coupled by a tube 310 to the universal port P1. The collection container 312 is intended, in use, to serve as a reservoir for whole blood during processing. It can also serve to receive a second unit of red blood cells for storage.

As shown in FIG. 10, no tubing is coupled to the utility universal port P13 and universal port P4 (e.g., the buffy port).

### C. The Pump and Valve Station

The pump and valve station 30 includes a cassette holder 216. A door 32 is hinged to move with respect to the cassette holder 216 between the opened position, exposing the cassette holder 216 (shown in FIG. 6) and the closed position, covering the cassette holder 216 (shown in FIG. 3). The door 32 also includes an over center latch 218 with a latch handle 220. When the door 32 is closed, the over center latch 218 swings into engagement with a latch pin 222.

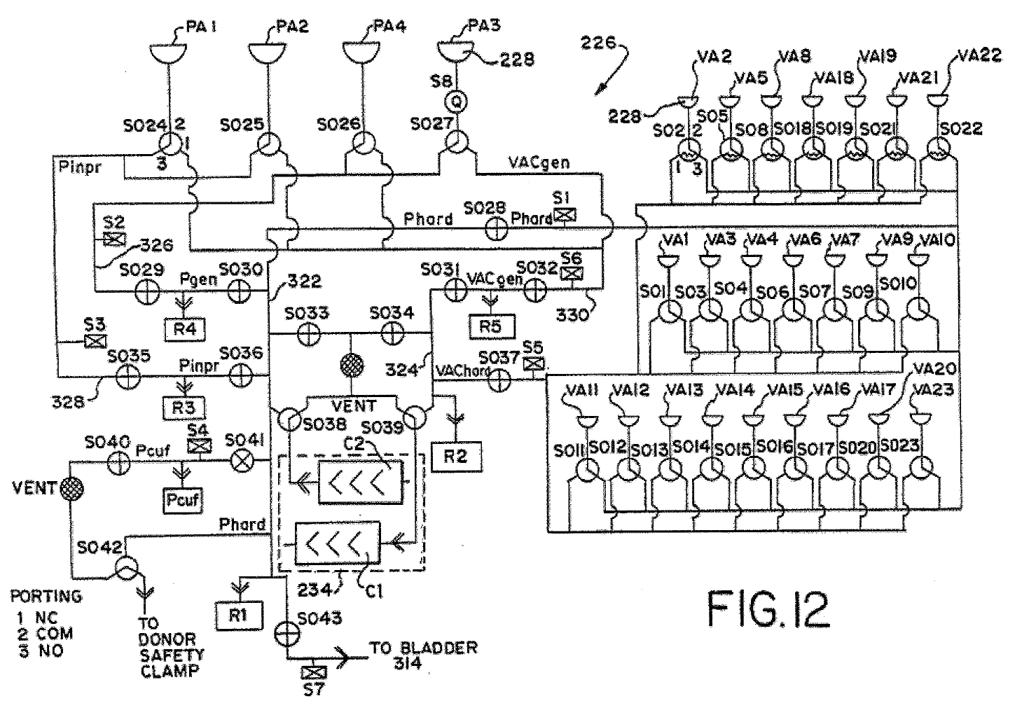

As FIG. 11 shows, the inside face of the door 32 carries an elastomeric gasket 224. The gasket 224 contacts the back side 192 of the cassette 28 when the door 32 is closed. An inflatable bladder 314 underlies the gasket 224.

With the door 32 opened (see FIG. 2), the operator can place the cassette 28 into the cassette holder 216. Closing the door 32 and securing the over center latch 218 brings the gasket 224 into facing contact with the second flexible diaphragm 196 on the back side 192 of the cassette 28. Inflating the inflatable bladder 314 presses the gasket 224 into intimate, sealing engagement against the second flexible diaphragm 196. The cassette 28 is thereby secured in a tight, sealing fit within the cassette holder 216.

The inflation of the inflatable bladder 314 also fully loads the over center latch 218 against the latch pin 222 with a force that cannot be overcome by normal manual force against the latch handle 220. The door 32 is securely locked and cannot be opened when the inflatable bladder 314 is inflated. In this construction, there is no need for an auxiliary lock-out device or sensor to assure against opening of the door 32 during blood processing.

The pump and valve station 30 also includes a manifold assembly 226 located in the cassette holder 216. The manifold assembly 226 comprises a molded or machined plastic or metal body. The front side of the first flexible diaphragm 194 is held in intimate engagement against the manifold assembly 226 when the door 32 is closed and the inflatable bladder 314 inflated.

The manifold assembly 226 is coupled to a pneumatic pressure source 234, which supplies positive and negative air pressure. The pneumatic pressure source 234 is carried inside the lid 40 behind the manifold assembly 226.

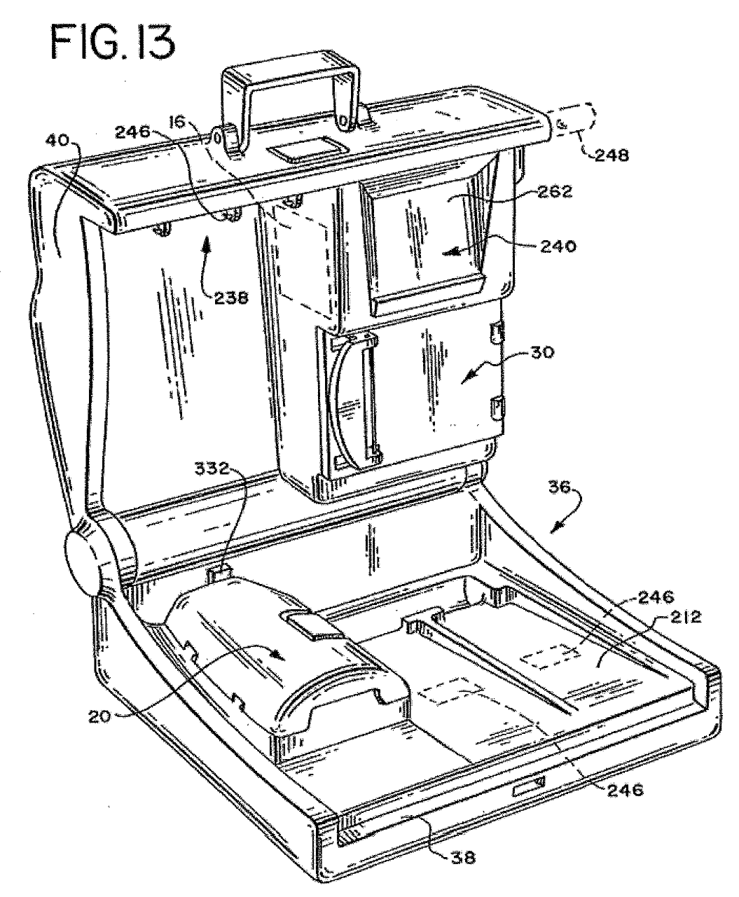

In the illustrated example, the pneumatic pressure source 234 comprises two compressors C1 and C2. However, one or several dual-head compressors could be used as well. As FIG. 12 shows, one compressor C1 supplies negative pressure through the manifold assembly 226 to the cassette 28. The other compressor C2 supplies positive pressure through the manifold assembly 226 to the cassette 28.

As FIG. 12 shows, the manifold assembly 226 contains four pump actuators PA1 to PA4 and twenty-three valve actuators VA1 to VA23. The pump actuators PA1 to PA4 and the valve actuators VA1 to VA23 are mutually oriented to form a mirror image of the pump stations PP1 to PP4 and the in-line valves V1 to V23 on the front side 190 of the cassette 28.

As FIG. 12 also shows, each actuator PA1 to PA4 and VA1 to VA23 includes a port 228. The port 228 conveys positive or negative pneumatic pressures from the source in a sequence governed by the controller 16. These positive and negative pressure pulses flex the first flexible diaphragm 194 to operate the pump chambers PP1 to PP4 and in-line valves V1 to V23 in the cassette 28. This, in turn, moves blood and processing liquid through the cassette 28.

In the illustrated example, the cassette holder 216 includes a membrane, an integral elastomeric membrane or splash guard membrane 232 (see FIG. 6) stretched across the manifold assembly 226. The membrane 232 serves as the interface between the manifold assembly 226 and the first flexible diaphragm 194 of the cassette 28, when fitted into the cassette holder 216. The membrane 232 may include one or more small through holes (not shown) in the regions overlying the pump and in-line valves PA1 to PA4 and V1 to V23. The holes are sized to convey pneumatic fluid pressure from the manifold assembly 226 to the first flexible diaphragm 194 (e.g., a cassette diaphragm). Still, the holes are small enough to retard the passage of liquid. The membrane 232 forms a flexible splash guard across the exposed face of the manifold assembly 226.

The membrane 232 substantially keeps liquid out of the pump and valve actuators PA1 to PA4 and VA1 to VA23, should the first flexible diaphragm 194 leak. The membrane 232 also serves as a filter to keep particulate matter out of the pump and valve actuators of the manifold assembly 226. The membrane 232 can be periodically wiped clean when cassettes 28 are exchanged.

The manifold assembly 226 includes an array of solenoid actuated pneumatic valves, which are coupled in-line with the pump and valve actuators PA1 to PA4 and VA1 to VA23. The manifold assembly 226, under the control of the controller 16, selectively distributes the different pressure and vacuum levels to the pump and valve actuators PA(N) and VA(N). These levels of pressure and vacuum are systematically applied to the cassette 28, to route blood and processing liquids.

Under the control of the controller 16, the manifold assembly 226 also distributes pressure levels to the inflatable bladder 314 (e.g., door bladder) (already described), as well as to a donor pressure cuff (not shown) and to a donor line occluder 320.

As FIG. 1 shows, the donor line occluder 320 is located in the case 36, immediately below the pump and valve station 30, in alignment with the ports P8 and P9 of the cassette 28. The donor tube 266, coupled to the port P8, passes through the occluder 320. The anticoagulant tube 270, coupled to the port P9, also passes through the occluder 320. The occluder 320 is a spring loaded, normally closed pinch valve, between which the tubes 266 and 270 pass. Pneumatic pressure from the manifold assembly 226 is supplied to a bladder (not shown) through a solenoid valve. The bladder, when expanded with pneumatic pressure, opens the pinch valve, to thereby open the tubes 266 and 270. In the absence of pneumatic pressure, the solenoid valve closes and the bladder vents to atmosphere. The spring loaded pinch valve of the occluder 320 closes, thereby closing the tubes 266 and 270.

The manifold assembly 226 maintains several different pressure and vacuum conditions, under the control of the controller 16. In the illustrated example, the following multiple pressure and vacuum conditions are maintained:

(i) Phard, or Hard Pressure, and Pinpr, or In-Process Pressure are the highest pressures maintained in the manifold assembly 226. Phard is applied for the in-line valves V1 to V23. Pinpr is applied to drive the expression of liquid from the in-process pump PP1 and the plasma pump PP2. A typical pressure level for Phard and Pinpr in the context of an exemplary example is 500 mmHg.

(ii) Pgen, or General Pressure, is applied to drive the expression of liquid from the donor interface pump PP3 and the anticoagulant pump PP4. A typical pressure level for Pgen in the context of an exemplary example is 150 mmHg.

(iii) Pcuff, or Cuff Pressure, is supplied to the donor pressure cuff. A typical pressure level for Pcuff in the context of an exemplary example is 80 mmHg.

(iv) Vhard, or Hard Vacuum, is the deepest vacuum applied in the manifold assembly 226. Vhard is applied to open the in-line valves V1 to V23. A typical vacuum level for Vhard in the context of an exemplary example is −350 mmHg.

(v) Vgen, or General Vacuum, is applied to drive the draw function of each of the four pumps PP1 to PP4. A typical pressure level for Vgen in the context of an exemplary example is −300 mmHg.

(vi) Pdoor, or Door Pressure, is applied to the inflatable bladder 314 to seal the cassette 28 into the cassette holder 216. A typical pressure level for Pdoor in the context of an exemplary example is 700 mmHg.

For each pressure and vacuum level, a variation of plus or minus 20 mmHg, for example, is tolerated.

Pinpr is used to operate the in-process pump PP1, to pump blood into the processing chamber 18. The magnitude of Pinpr is sufficient to overcome the pressure within the processing chamber 18, which may be approximately 300 mmHg.

Similarly, Pinpr is used for the plasma pump PP2, since it may have similar pressure capabilities in the event that plasma needs to be pumped backwards into the processing chamber 18, e.g., during a spill condition, as will be described later.

Pinpr and Phard are operated at the highest pressure to ensure that upstream and downstream valves used in conjunction with pumping are not forced opened by the pressures applied to operate the pumps. The cascaded, interconnectable design of the fluid paths F1 to F35 through the cassette 28 requires Pinpr-Phard to be the highest pressure applied. By the same token, Vgen is required to be less extreme than Vhard, to ensure that pumps PP1 to PP4 do not overwhelm upstream and downstream the in-line valves V1 to V23.

Pgen is used to drive the donor interface pump PP3 and can be maintained at a lower pressure, as can the AC pump PP4.

A main hard pressure line 322 and a main vacuum line 324 distribute Phard and Vhard in the manifold assembly 226. The pneumatic pressure source 234 run continuously to supply Phard to the hard pressure line 322 and Vhard to the main vacuum line 324 (e.g., hard vacuum line).

A pressure sensor S1 monitors Phard in the hard pressure line 322. The sensor S1 controls a solenoid SO38. The solenoid SO38 is normally closed. The sensor S1 opens the solenoid SO38 to build Phard up to its maximum set value. Solenoid SO38 is closed as long as Phard is within its specified pressure range and is opened when Phard falls below its minimum acceptable value.

Similarly, a pressure sensor S5 in the main vacuum line 324 (e.g., hard vacuum line) monitors Vhard. The sensor S5 controls a solenoid SO39. The solenoid SO39 is normally closed. The sensor S5 opens the solenoid SO39 to build Vhard up to its maximum value. Solenoid SO39 is closed as long as Vhard is within its specified pressure range and is opened when Vhard falls outside its specified range.

A general pressure line 326 branches from the hard pressure line 322. A sensor S2 in the general pressure line 326 monitors Pgen. The sensor S2 controls a solenoid SO30. The solenoid SO30 is normally closed. The sensor S2 opens the solenoid SO30 to refresh Pgen from the hard pressure line 322, up to the maximum value of Pgen. Solenoid SO30 is closed as long as Pgen is within its specified pressure range and is opened when Pgen falls outside its specified range.

An in-process pressure line 328 also branches from the hard pressure line 322. A sensor S3 in the in-process pressure line 328 monitors Pinpr. The sensor S3 controls a solenoid SO36. The solenoid SO36 is normally closed. The sensor S3 opens the solenoid SO36 to refresh Pinpr from the hard pressure line 322, up to the maximum value of Pinpr. Solenoid SO36 is closed as long as Pinpr is within its specified pressure range and is opened when Pinpr falls outside its specified range.

A general vacuum line 330 branches from the main vacuum line 324 (e.g., hard vacuum line). A sensor S6 monitors Vgen in the general vacuum line 330. The sensor S6 controls a solenoid SO31. The solenoid SO31 is normally closed. The sensor S6 opens the solenoid SO31 to refresh Vgen from the main vacuum line 324 (e.g., hard vacuum line), up to the maximum value of Vgen. The solenoid SO31 is closed as long as Vgen is within its specified range and is opened when Vgen falls outside its specified range.

In-line reservoirs R1 to R5 are provided in the hard pressure line 322, the in-process pressure line 328, the general pressure line 326, the main vacuum line 324 (e.g., hard vacuum line), and the general vacuum line 330. The reservoirs R1 to R5 assure that the constant pressure and vacuum adjustments as above described are smooth and predictable.

The solenoids SO33 and SO34 provide a vent for the pressures and vacuums, respectively, upon procedure completion. Since pumping and valving will continually consume pressure and vacuum, the solenoids SO33 and SO34 are normally closed. The solenoids SO33 and SO34 are opened to vent the manifold assembly upon the completion of a blood processing procedure.

The solenoids SO28, SO29, SO35, SO37 and SO32 provide the capability to isolate the reservoirs R1 to R5 from the air lines that supply vacuum and pressure to the manifold assembly 226. This provides for much quicker pressure/vacuum decay feedback, so that testing of cassette/manifold assembly seal integrity can be accomplished. These solenoids SO28, SO29, SO35, SO37, and SO32 are normally opened, so that pressure cannot be built in the manifold assembly 226 without a command to close the solenoids SO28, SO29, SO35, SO37, and SO32, and, further, so that the system pressures and vacuums can vent in an error mode or with loss of power.

The solenoids SO1 to SO23 provide Phard or Vhard to drive the valve actuators VA1 to V23. In the unpowered state, these solenoids are normally opened to keep all the in-line V1 to V23 closed.

The solenoids SO24 and SO25 provide Pinpr and Vgen to drive the in-process and plasma pumps PP1 and PP2. In the unpowered state, these solenoids are opened to keep both pumps PP1 and PP2 closed.

The solenoids SO26 and SO27 provide Pgen and Vgen to drive the donor interface and AC pumps PP3 and PP4. In the unpowered state, these solenoids are opened to keep both pumps PP3 and PP4 closed.

The solenoid SO43 provides isolation of the inflatable bladder 314 (e.g., door bladder) from the hard pressure line 322 during the procedure. The solenoid SO43 is normally opened and is closed when Pdoor is reached. A sensor S7 monitors Pdoor and signals when the bladder pressure falls below Pdoor. The solenoid SO43 is opened in the unpowered state to ensure the inflatable bladder 314 venting, as the cassette 28 cannot be removed from the holder while the inflatable bladder 314 (e.g., inflatable bladder) is pressurized.

The solenoid SO42 provides Phard to open the safety occluder valve 320. Any error modes that might endanger the donor will relax (vent) the solenoid SO42 to close the occluder 320 and isolate the donor. Similarly, any loss of power will relax the solenoid SO42 and isolate the donor.

The sensor S4 monitors Pcuff and communicates with solenoid SO41 (for increases in pressure) and solenoid SO40 (for venting) to maintain the donor cuff within its specified ranges during the procedure. The solenoid SO40 is normally open so that the cuff line will vent in the event of system error or loss of power. The solenoid SO41 is normally closed to isolate the donor from any Phard in the event of power loss or system error.

FIG. 12 shows a sensor S8 in the pneumatic line serving the donor interface pump actuator PA3. The sensor S8 is a bi-directional mass air flow sensor, which can monitor air flow to the donor interface pump actuator PA3 to detect occlusions in the donor line. Alternatively, as will be described in greater detail later, electrical field variations can be sensed by an electrode carried within the donor interface pump chamber PP3, or any or all other pump chambers PP1, PP2, or PP4, to detect occlusions, as well as to permit calculation of flow rates and the detection of air.

Various alternative examples are possible. For example, the pressure and vacuum available to the four pumping chambers could be modified to include more or less distinct levels or different groupings of “shared” pressure and vacuum levels. As another example, Vhard could be removed from access to the solenoids SO2, SO5, SO8, SO18, SO19, SO21, SO22 since the restoring springs will return the cassette valves to a closed position upon removal of a vacuum. Furthermore, the vents shown as grouped together could be isolated or joined in numerous combinations.

It should also be appreciated that any of the solenoids used in “normally open” mode could be re-routed pneumatically to be realized as “normally closed”. Similarly, any of the “normally closed” solenoids could be realized as “normally open.”

As an alternative example, the hard pressure reservoir R1 could be removed if Pdoor and Phard were set to identical magnitudes. In this arrangement, the inflatable bladder 314 (e.g., door bladder) could serve as the hard pressure reservoir. The pressure sensor S7 and the solenoid SO43 would also be removed in this arrangement.

### III. Other Process Control Components of the System

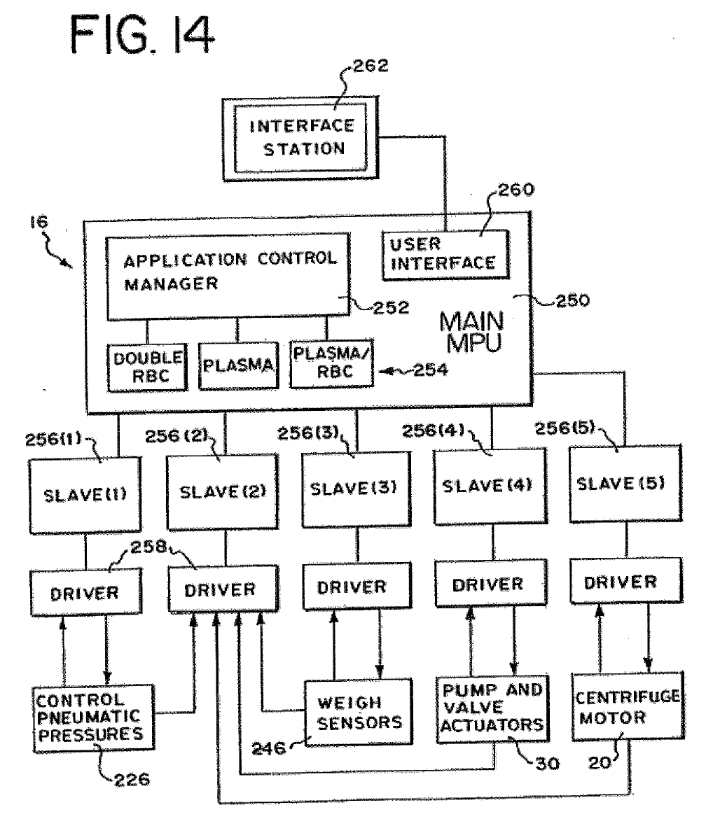

As FIG. 13 best shows, the case 36 contains other components compactly arranged to aid blood processing. In addition to the centrifuge station 20 and pump and valve station 30, already described, the case 36 includes a weigh station 238, an operator interface station 240, and one or more trays 212 or hangers 248 for containers. The arrangement of these components in the case 36 can vary. In the illustrated example, the weigh station 238, the controller 16, and the operator interface station 240, like the pump and valve station 30, are located in the lid 40 of the case 36. The holding trays 212 are located in the base 38 of the case 36, adjacent the centrifuge station 20.

### A. Container Support Components

The weigh station 238 comprises a series of container hangers/weigh sensors 246 arranged along the top of the lid 40. In use (see FIG. 2), containers 304, 308, 312 are suspended on the hangers/weigh sensors 246.

The containers receive blood components separated during processing, as will be described in greater detail later. The weigh sensors 246 provide output reflecting weight changes over time. This output is conveyed to the controller 16. The controller 16 processes the incremental weight changes to derive fluid processing volumes and flow rates. The controller generates signals to control processing events based, in part, upon the derived processing volumes. Further details of the operation of the controller to control processing events will be provided later.

The holding trays 212 comprise molded recesses in the base 38. The trays 212 accommodate the containers 276 and 280 (see FIG. 2). In the illustrated example, an additional swing-out hanger 248 is also provided on the side of the lid 40. The hanger 248 (see FIG. 2) supports the container 288 during processing. In the illustrated example, the trays 212 and hanger 248 also include weigh sensors 246.

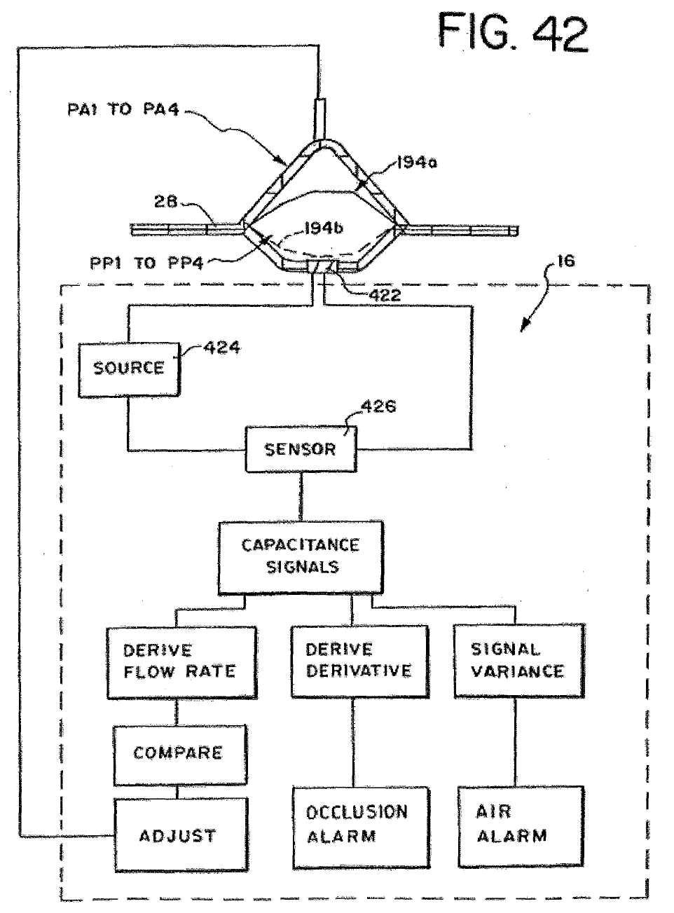

The weigh sensors 246 can be variously constructed. In the example shown in FIG. 40, the scale includes a force sensor 404 incorporated into a housing 400, to which a hanger 402 is attached. A top surface 420 of the hanger 402 engages a spring 406 on the force sensor 404. Another spring 418 is compressed as a load, carried by the hanger 402, is applied. The spring 418 resists load movement of the hanger 402, until the load exceeds a predetermined weight (e.g., 2 kg.). At that time, the hanger 402 bottoms out on mechanical stops 408 in the housing 400, thereby providing over load protection.

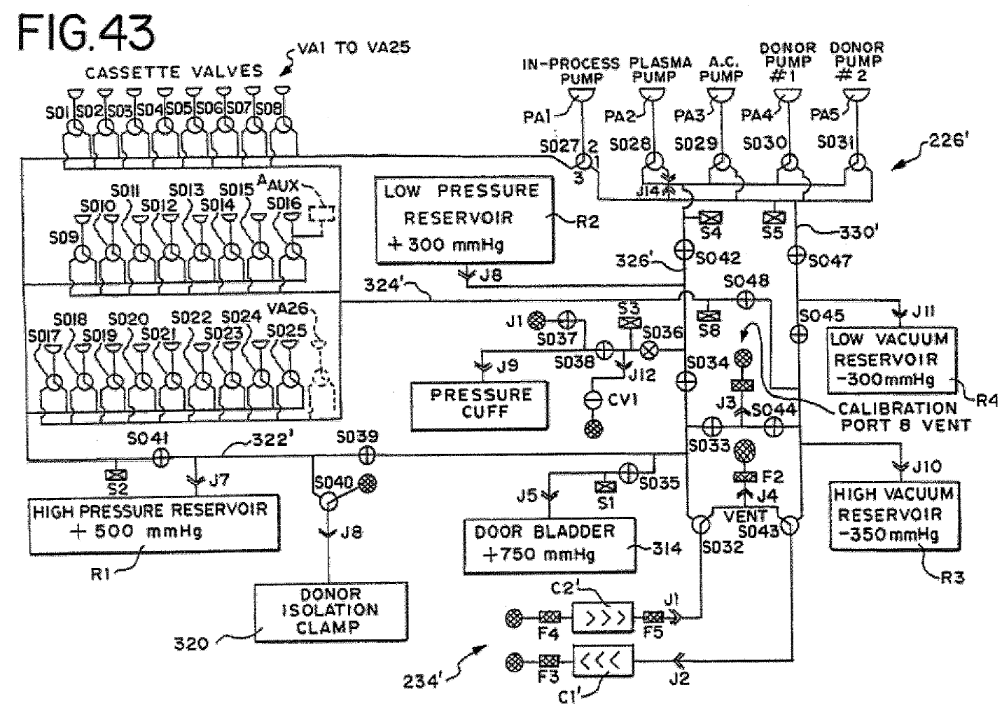

In the example shown in FIG. 41, a supported beam 410 transfers force applied by a hanger 416 to a force sensor 412 through a spring 414. This design virtually eliminates friction from the weight sensing system. The magnitude of the load carried by the beam is linear in behavior, and the weight sensing system can be readily calibrated to ascertain an actual load applied to the hanger 416.

### B. The Controller and Operator Interface Station

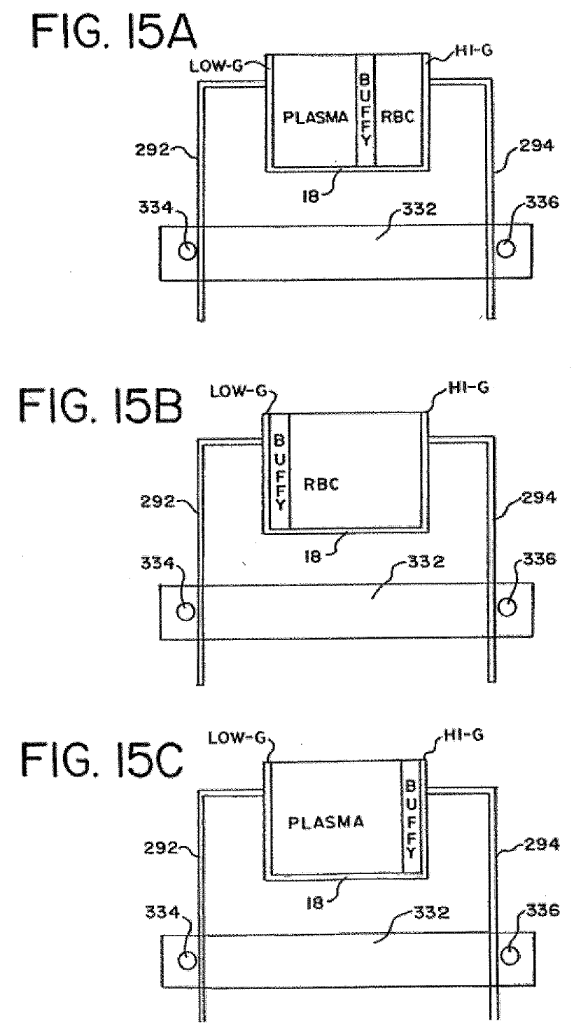

The controller 16 carries out process control and monitoring functions for the system 10. As FIG. 14 shows schematically, the controller 16 comprises a main processing unit (MPU) 250, which can comprise, e.g., a Pentium™ type microprocessor made by Intel Corporation, although other types of conventional microprocessors can be used. The MPU 250 is mounted inside the lid 40 of the case 36 (as FIG. 13 shows).

In one example, the MPU 250 employs conventional real time multi-tasking to allocate MPU cycles to processing tasks. A periodic timer interrupt (for example, every 5 milliseconds) preempts the executing task and schedules another that is in a ready state for execution. If a reschedule is requested, the highest priority task in the ready state is scheduled. Otherwise, the next task on the list in the ready state is scheduled.

As FIG. 14 shows, the MPU 250 includes an application control manager 252. The application control manager 252 administers the activation of a library of at least one control application 254. Each control application 254 prescribes procedures for carrying out given functional tasks using the centrifuge station 20 and the pump and valve station 30 in a predetermined way. In the illustrated example, the control applications 254 reside as process software in EPROM's in the MPU 250.

The number of control applications 254 can vary. In the illustrated example, the control applications 254 include at least one clinical procedure application. The procedure application contains the steps to carry out one prescribed clinical processing procedure. For the sake of example in the illustrated example, the control application 254 includes three procedure applications: (1) a double unit red blood cell collection procedure; (2) a plasma collection procedure; and (3) a plasma/red blood cell collection procedure. The details of these procedures will be described later. Of course, additional procedure applications can be included.

As FIG. 14 shows, several slave processing units communicate with the application control manager 252. While the number of slave processing units can vary, the illustrated example shows five slave processing units 256(1) to 256(5). The slave processing units 256(1) to 256(5), in turn, communicates with low level peripheral controllers 258 for controlling the pneumatic pressures within the manifold assembly 226, the weigh sensors 246, the pump and valve actuators PA1 to PA4 and VA1 to VA23 in the pump and valve station 30, the motor for the centrifuge station 20, the interface sensing station 332, and other functional hardware of the system.

The MPU 250 contains in EPROM's the commands for the peripheral controllers 258, which are downloaded to the appropriate slave processing unit 256(1) to 256(5) at start-up. The application control manager 252 also downloads to the appropriate slave processing unit 256(1) to 256(5) the operating parameters prescribed by the control application 254 (e.g., activated application).

With this downloaded information, the slave processing units 256(1) to 256(5) proceed to generate device commands for the peripheral controllers 258, causing the hardware to operate in a specified way to carry out the procedure. The peripheral controllers 258 return current hardware status information to the appropriate slave processing unit 256(1) to 256(5), which, in turn, generate the commands necessary to maintain the operating parameters ordered by the application control manager 252.

In the illustrated example, one slave processing unit 256(2) performs the function of an environmental manager. The slave processing unit 256(2) receives redundant current hardware status information and reports to the MPU 250 should a slave unit malfunction and fail to maintain the desired operating conditions.

As FIG. 14 shows, the MPU 250 also includes an interactive user interface 260, which allows the operator to view and comprehend information regarding the operation of the system 10. The interactive user interface 260 is coupled to the operator interface station 240. The interactive user interface 260 allows the operator to use the operator interface station 240 to select the control applications 254 residing in the application control manager 252, as well as to change certain functions and performance criteria of the system 10.

As FIG. 13 shows, the operator interface station 240 includes an interface screen 262 carried in the lid 40. The interface screen 262 displays information for viewing by the operator in alpha-numeric format and as graphical images. In the illustrated example, the interface screen 262 also serves as an input device. It receives input from the operator by conventional touch activation.

### C. On-Line Monitoring of Pump Flows

### 1. Gravimetric Monitoring

Using the weigh scales 246, either upstream or downstream of the pumps, the controller 16 can continuously determine the actual volume of fluid that is moved per pump stroke and correct for any deviations from commanded flow. The controller 16 can also diagnose exceptional situations, such as leaks and obstructions in the fluid path. This measure of monitoring and control is desirable in an automated apheresis application, where anticoagulant has to be accurately metered with the whole blood as it is drawn from the donor, and where product quality (e.g., hematocrit, plasma purity) is influenced by the accuracy of the pump flow rates.

The pumps PP1 to PP4 in the cassette 28 each provides a relatively-constant nominal stroke volume, or SV. The flow rate for a given pump can therefore be expressed as follows:

$$Q = \frac{S V}{( {T}_{Pump} + {T}_{Fill} + {T}_{Idle} )} \qquad ( 1 )$$

where:

Q is the flow rate of the pump.

T_{Pump} is the time the fluid is moved out of the pump chamber.

T_{Fill} is the time the pump is filled with fluid.

T_{Idle} is the time when the pump is idle, that is, when no fluid movement occurs.

The SV can be affected by the interaction of the pump with attached downstream and upstream fluid circuits. This is analogous, in electrical circuit theory, to the interaction of a non-ideal current source with the input impedance of the load it sees. Because of this, the actual SV can be different than the nominal SV.

The actual fluid flow in volume per unit of time Q_{Actual} can therefore be expressed as follows:

$${Q}_{Actual} = k \times \frac{S {V}_{Ideal}}{{T}_{Pump} + {T}_{Fill} + {T}_{Idle}} \qquad ( 2 )$$

where:

Q_{Actual} is the actual fluid flow in volume per unit of time.

SV_{Ideal} is the theoretical stroke volume, based upon the geometry of the pump chamber. k is a correction factor that accounts for the interactions between the pump and the upstream and downstream pressures.

The actual flow rate can be ascertained gravimetrically, using the upstream or downstream weigh scales 246, based upon the following relationship:

$${Q}_{Actual} = \frac{Δ Wt}{ρ \times Δ T} \qquad ( 3 )$$

where:

ΔWt is the change in weight of fluid as detected by the upstream or downstream weigh scale 246 during the time period ΔT.

ρ is the density of fluid.

ΔT is the time period where the change in weight ΔWt is detected in the weigh scale 246.

The following expression is derived by combining Equations (2) and (3):

$$k = ( {T}_{Pump} + {T}_{Fill} + {T}_{Idle} ) \times \frac{Δ Wt}{( S {V}_{Ideal} \times ρ \times Δ T )} \qquad ( 4 )$$

The controller 16 computes k according to Equation (4) and then adjusts T_{Idle} so that the desired flow rate is achieved, as follows:

$${T}_{Idle} = ( k \times \frac{S {V}_{Ideal}}{{Q}_{Desired}} ) - {T}_{Pump} - {T}_{Fill} \qquad ( 5 )$$

The controller 16 updates the values for k and T_{Idle} frequently to adjust the flow rates.

Alternatively, the controller 16 can change T_{Pump} and/or T_{Fill} and/or T_{Idle} to adjust the flow rates.

In this arrangement, one or more of the time interval components T_{Pump}, or T_{Fill}, or T_{Idle} is adjusted to a new magnitude to achieve Q_{Desired}, according to the following relationship:

$${T}_{n ( Adjusted )} = k ( \frac{S {V}_{Ideal}}{{Q}_{Desired}} ) - {T}_{n ( NotAdjusted )}$$

where:

T_{n(Adjusted)} is the magnitude of the time interval component or components after adjustment to achieve the desired flow rate Q_{Desired}.

T_{n(NotAdjusted)} is the magnitude of the value of the other time interval component or components of T_{Stroke} that are not adjusted. The adjusted stroke interval after adjustment to achieve the desired flow rate Q_{Desired} is the sum of T_{n(Adjusted)} and T_{n(NotAdjusted)}.

The controller 16 also applies the correction factor k as a diagnostics tool to determine abnormal operating conditions. For example, if k differs significantly from its nominal value, the fluid path may have either a leak or an obstruction. Similarly, if computed value of k is of a polarity different from what was expected, then the direction of the pump may be reversed.

With the weigh scales 246, the controller 16 can perform on-line diagnostics even if the pumps are not moving fluid. For example, if the weigh scales 246 detect changes in weight when no flow is expected, then a leaky valve or a leak in the set 264 may be present.

In computing k and T_{Idle} and/or T_{Pump} and/or T_{Fill}, the controller 16 may rely upon multiple measurements of ΔWt and/or ΔT. A variety of averaging or recursive techniques (e.g., recursive least mean squares, Kalman filtering, etc.) may be used to decrease the error associated with the estimation schemes.

The above described monitoring technique is applicable for use for other constant stroke volume pumps, e.g. peristaltic pumps, etc.

### 2. Electrical Monitoring

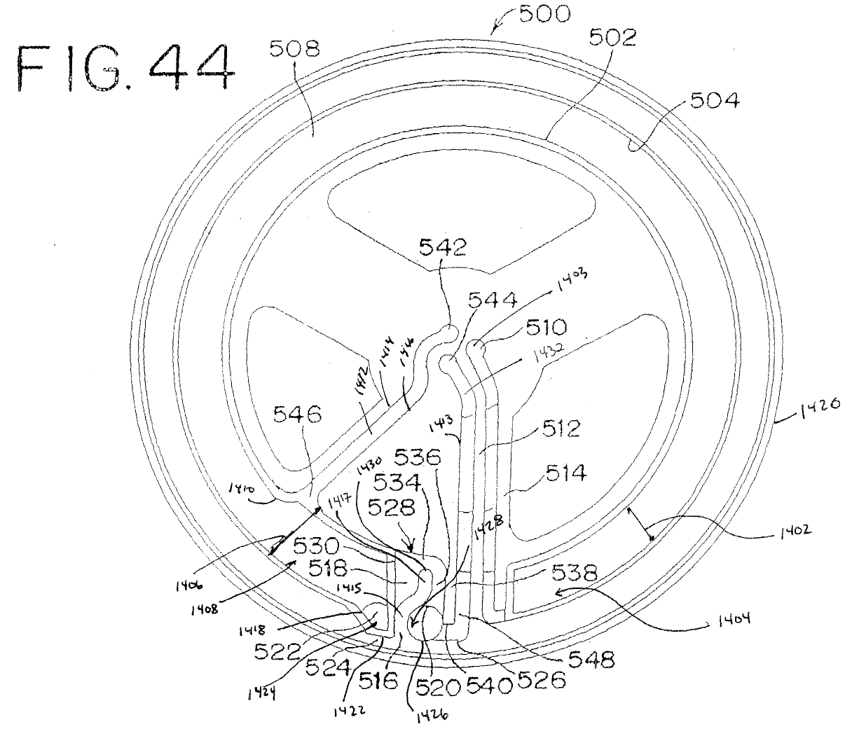

In an alternative arrangement (see FIG. 42), the controller 16 includes a metal electrode or electrode 422 located in the chamber of each pump station PP1 to PP4 on the cassette 28. The electrode(s) 422 is coupled to a current source 424. The passage of current through each of the electrode(s) 422 creates an electrical field within the respective pump chamber PP1 to PP4.

Cyclic deflection of the first flexible diaphragm 194 to draw fluid into and expel fluid from the pump chamber PP1 to PP4 changes the electrical field, resulting in a change in total capacitance of the circuit through the electrode 422. Capacitance increases as fluid is drawn into the pump chamber PP1 to PP4, and capacitance decreases as fluid is expelled from the pump chamber PP1 to PP4.

The controller 16 includes a capacitive sensor 426 (e.g., a QProx™ E2S sensor from Quantum Research Group Ltd. of Hamble, England) coupled to each of the electrode(s) 422. The capacitive sensor 426 registers changes in capacitance for the electrode 422 in each pump chamber PP1 to PP4. The capacitance signal for one of the electrodes 422 has a high signal magnitude when the pump chamber is filled with liquid (a diaphragm position 194a), has a low signal magnitude signal when the pump chamber is empty of fluid (a diaphragm position 194b), and has a range of intermediate signal magnitudes when the diaphragm occupies positions between the diaphragm positions 194a and 194b.

At the outset of a blood processing procedure, the controller 16 calibrates the difference between the high and low signal magnitudes for each sensor to the maximum stroke volume SV of the respective pump chamber. The controller 16 then relates the difference between sensed maximum and minimum signal values during subsequent draw and expel cycles to fluid volume drawn and expelled through the pump chamber. The controller 16 sums the fluid volumes pumped over a sample time period to yield an actual flow rate.

The controller 16 compares the actual flow rate to a desired flow rate. If a deviance exists, the controller 16 varies pneumatic pressure pulses delivered to the actuator PA1 to PA4, to adjust T_{Idle} and/or Tₚᵤₘₚ and/or T_{Fill} to minimize the deviance.

The controller 16 also operates to detect abnormal operating conditions based upon the variations in the electric field and to generate an alarm output. In the illustrated example, the controller 16 monitors for an increase in the magnitude of the low signal magnitude over time. The increase in magnitude reflects the presence of air inside a pump chamber.

In the illustrated example, the controller 16 also generates a derivative of the signal output of the capacitive sensor 426. Changes in the derivative, or the absence of a derivative, reflects a partial or complete occlusion of flow through the pump chamber PP1 to PP4. The derivative itself also varies in a distinct fashion depending upon whether the occlusion occurs at the inlet or outlet of the pump chamber PP1 to PP4.

### IV. The Blood Processing Procedures

### A. Double RBC Collection Procedure

### No Plasma Collection

During this procedure, whole blood from a donor is centrifugally processed to yield up to two units (approximately 500 ml) of red blood cells for collection. All plasma constituent is returned to the donor. This procedure will, in shorthand, be called the double red blood cell collection procedure.

Prior to undertaking the double red blood cell collection procedure, as well as any blood collection procedure, the controller 16 operates the manifold assembly 226 to conduct an appropriate integrity check of the cassette 28, to determine whether there are any leaks in the cassette 28. Once the cassette integrity check is complete and no leaks are found, the controller 16 begins the desired blood collection procedure.

The double red blood cell collection procedure includes a pre-collection cycle, a collection cycle, a post-collection cycle, and a storage preparation cycle. During the pre-collection cycle, the set 264 is primed to vent air prior to venipuncture. During the collection cycle, whole blood drawn from the donor is processed to collect two units of red blood cells, while returning plasma to the donor. During the post-collection cycle, excess plasma is returned to the donor, and the set is flushed with saline. During the storage preparation cycle, a red blood cell storage solution is added.

### 1. The Pre-Collection Cycle

### a. Anticoagulant Prime 1

In a first phase of the pre-collection cycle (AC Prime 1), the tubing 300 leading to the phlebotomy needle 268 is clamped closed (see FIG. 10). The blood processing circuit 46 is programmed (through the selective application of pressure to the valves and pump stations of the cassette) to operate the donor interface pump PP3, drawing anticoagulant through the anticoagulant tube 270 and up the donor tube 266 through the y-connector 272 (i.e., in through the in-line valve V13 and out through the in-line valve V11). The circuit is further programmed to convey air residing in the anticoagulant tube 270, the donor tube 266, and the cassette and into the in-process container 312. This phase continues until an air detector 298 along the donor tube 266 detects liquid, confirming the pumping function of the donor interface pump PP3.

### b. Anticoagulant Prime 2

In a second phase of the pre-collection cycle (AC Prime 2), the circuit is programmed to operate the anticoagulant pump PP4 to convey anticoagulant into the in-process container 312. Weight changes in the in-process container 312. AC Prime 2 is terminated when the anticoagulant pump PP4 conveys a predetermined volume of anticoagulant (e.g., 10 g) into the in-process container 312, confirming its pumping function.

### c. Saline Prime 1

In a third phase of the pre-collection cycle (Saline Prime 1), the processing chamber 18 remains stationary. The circuit is programmed to operate the in-process pump station PP1 to draw saline from the saline container 288 through the in-process pump PP1. This creates a reverse flow of saline through the stationary processing chamber 18 toward the in-process container 312. In this sequence saline is drawn through the processing chamber 18 from the saline container 288 into the in-process pump PP1 through the in-line valve V14. The saline is expelled from the pump station PP1 toward the in-process container 312 through valve V9. Weight changes in the saline container 288 are monitored. This phase is terminated upon registering a predetermined weight change in the saline container 288, which indicates conveyance of a saline volume sufficient to initially fill about one half of the processing chamber 18 (e.g., about 60 g).

### d. Saline Prime 2

With the processing chamber 18 about half full of priming saline, a fourth phase of the pre-collection cycle (Saline Prime 2). The processing chamber 18 is rotated at a low rate (e.g., about 300 RPM), while the circuit continues to operate in the same fashion as in Saline Prime 1. Additional saline is drawn into the pump station PP1 through the in-line valve V14 and expelled out of the pump station PP1 through valve V9 and into the in-process container 312. Weight changes in the in-process container 312 are monitored. This phase is terminated upon registering a predetermined weight change in the in-process container 312, which indicates the conveyance of an additional volume of saline sufficient to substantially fill the processing chamber 18 (e.g., about 80 g).

### e. Saline Prime 3

In a fifth phase of the pre-collection cycle (Saline Prime 3), the circuit is programmed to first operate the in-process pump station PP1 to convey saline from the in-process container 312 through all outlet ports of the separation device and back into the saline container 288 through the plasma pump station PP2. This completes the priming of the processing chamber 18 and the in-process pump station PP1 (pumping in through valve V9 and out through the in-line valve V14), as well as primes the plasma pump station PP2, with the in-line valves V7, V6, V10, and V12 opened to allow passive flow of saline. During this time, the rate at which the processing chamber 18 is rotated is successively ramped between zero and 300 RPM. Weight changes in the in-process container 312 are monitored. When a predetermined initial volume of saline is conveyed in this manner, the circuit is programmed to close in-line valve V7, open the in-line valves V9 and V14, and to commence pumping saline to the saline container 288 through the plasma pump PP2, in through the in-line valve V12 and out through the in-line valve V10, allowing saline to passively flow through the in-process pump PP1. Saline in returned in this manner from the in-process container 312 to the saline container 288 until weight sensing indicated that a preestablished minimum volume of saline occupies the in-process container 312.

### f. Vent Donor Line

In a sixth phase of the pre-collection cycle (Vent Donor Line), the circuit is programmed to purge air from the venipuncture needle, prior to venipuncture, by operating the donor interface pump PP3 to pump anticoagulant through anticoagulant pump PP4 and into the in-process container 312.

### g. Venipuncture

In a seventh phase of the pre-collection cycle (Venipuncture), the circuit is programmed to close all the in-line valves V1 to V23, so that venipuncture can be accomplished.

The programming of the circuit during the phases of the pre-collection cycle is summarized in the following table.

TABLE
Programming of Blood Processing Circuit During Pre-Collection Cycle
(Double Red Blood Cell Collection Procedure)

| | | | | | | Vent | |
|---|---|---|---|---|---|---|---|
| | AC | AC | Saline | Saline | Saline | Donor | |
| Phase | Prime 1 | Prime 2 | Prime 1 | Prime 2 | Prime 3 | Line | Venipuncture |
| V1 | | | | | | | |
| V2 | | | | | | | |
| V3 | ∘ | ∘ | | | | ∘ | |
| V4 | | | ∘ | | | | |
| V5 | | | | | | | |
| V6 | | | | | ∘ | | |
| V7 | | | | | ∘ | | |
| V8 | | | | | | | |
| V9 | | | ∘/ | ∘/ | ∘/ | | |
| | | | Pump | Pump | Pump In | | |
| | | | Out | Out | (Stage 1) | | |
| | | | | | ∘ | | |
| | | | | | (Stage 2) | | |
| V10 | | | | | ∘ | | |
| | | | | | (Stage 1) | | |
| | | | | | ∘/ | | |
| | | | | | Pump | | |
| | | | | | Out | | |
| | | | | | (Stage 2) | | |
| V11 | ∘/ | ∘ | | | | ∘/ | |
| | Pump | | | | | Pump In | |
| | Out | | | | | | |
| V12 | | | | | ∘ | | |
| | | | | | (Stage 1) | | |
| | | | | | ∘/ | | |
| | | | | | Pump In | | |
| | | | | | (Stage 2) | | |
| V13 | ∘/ | ∘ | | | | ∘/ | |
| | Pump In | | | | | Pump | |
| | | | | | | Out | |
| V14 | | | ∘/ | ∘/ | ∘/ | | |
| | | | Pump In | Pump In | Pump | | |
| | | | | | Out | | |
| | | | | | (Stage 1) | | |
| | | | | | ∘ | | |
| | | | | | (Stage 2) | | |
| V15 | ∘ | ∘/ | | | | ∘ | |
| | | Pump In | | | | | |
| | | Pump | | | | | |
| | | Out | | | | | |
| V16 | | | | | | | |
| V17 | | | | | | | |
| V18 | ∘ | ∘ | | | | ∘ | |
| V19 | ∘ | ∘ | | | | ∘ | |
| V20 | ∘ | ∘/ | | | | ∘ | |
| | | Pump | | | | | |
| | | Out | | | | | |
| | | Pump In | | | | | |
| V21 | | | | | | | |
| V22 | | | ∘ | ∘ | ∘ | | |
| V23 | | | ∘ | ∘ | ∘ | | |
| PP1 | ▪ | ▪ | □ | □ | □ | ▪ | ▪ |
| | | | | | (Stage 1) | | |
| PP2 | ▪ | ▪ | ▪ | ▪ | □ | ▪ | ▪ |
| | | | | | (Stage 2) | | |
| PP3 | □ | ▪ | ▪ | ▪ | ▪ | □ | ▪ |
| PP4 | ▪ | □ | ▪ | ▪ | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### 2. The Collection Cycle

### a. Blood Prime 1

With venipuncture, the tubing 300 leading to the phlebotomy needle 268 is opened. In a first phase of the collection cycle (Blood Prime 1), the blood processing circuit 46 is programmed (through the selective application of pressure to the valves and pump stations of the cassette) to operate the donor interface pump PP3 (i.e., in through the in-line valve V13 and out through the in-line valve V11) and the anticoagulant pump PP4 (i.e., in through the in-line valve V20 and out through the in-line valve V15) to draw anticoagulated blood through the donor tube 266 into the in-process container 312. This phase continues until an incremental volume of anticoagulated whole blood enters the in-process container 312, as monitored by the weigh sensor.

### b. Blood Prime 2

In a next phase (Blood Prime 2), the blood processing circuit 46 is programmed to operate the in-process pump station PP1 to draw anticoagulated blood from the in-process container 312 through the separation device. During this phase, saline displaced by the blood is returned to the donor. This phase primes the separation device with anticoagulated whole blood. This phase continues until an incremental volume of anticoagulated whole blood leaves the in-process container 312, as monitored by the weigh sensor.

### c. Blood Separation while Drawing Whole Blood or without Drawing Whole Blood

In a next phase of the blood collection cycle (Blood Separation While Drawing Whole Blood), the blood processing circuit 46 is programmed to operate the donor interface pump station PP3 (i.e., in through the in-line valve V13 and out through the in-line valve V11); the anticoagulant pump PP4 (i.e., in through valve V20 and out through the in-line valve V15); the in-process pump PP1 (i.e., in through the in-line valve V9 and out through the in-line valve V14); and the plasma pump PP2 (i.e., in through the in-line valve V12 and out through the in-line valve V10). This arrangement draws anticoagulated blood into the in-process container 312, while conveying the blood from the in-process container 312 into the processing chamber 18 for separation. This arrangement also removes plasma from the processing chamber 18 into the plasma container 304, while removing red blood cells from the processing chamber 18 into the red blood cell container 308. This phase continues until an incremental volume of plasma is collected in the plasma collection container 304 (as monitored by the weigh sensor) or until a targeted volume of red blood cells is collected in the red blood cell collection container (as monitored by the weigh sensor).

If the volume of whole blood in the in-process container 312 reaches a predetermined maximum threshold before the targeted volume of either plasma or red blood cells is collected, the circuit is programmed for another phase (Blood Separation Without Drawing Whole Blood), to terminate operation of the donor interface pump station PP3 (while also closing the in-line valves V13, V11, V18, and V3) to terminate collection of whole blood in the in-process container 312, while still continuing blood separation. If the volume of whole blood reaches a predetermined minimum threshold in the in-process container 312 during blood separation, but before the targeted volume of either plasma or red blood cells is collected, the circuit is programmed to return to the Blood Separation While Drawing Whole Blood Phase, to thereby allow whole blood to enter the in-process container 312. The circuit is programmed to toggle between the Blood Separation While Drawing Whole Blood Phase and the Blood Separation Without Drawing Whole Blood Phase according to the high and low volume thresholds for the in-process container 312, until the requisite volume of plasma has been collected, or until the target volume of red blood cells has been collected, whichever occurs first.

### d. Return Plasma and Saline

If the targeted volume of red blood cells has not been collected, the next phase of the blood collection cycle (Return Plasma With Separation) programs the blood processing circuit 46 to operate the donor interface pump station PP3 (i.e., in through in-line valve V11 and out through in-line valve V13); the in-process pump PP1 (i.e., in through valve V9 and out through in-line valve V14); and the plasma pump PP2 (i.e., in through in-line valve V12 and out through the in-line valve V10). This arrangement conveys anticoagulated whole blood from the in-process container 312 into the processing chamber 18 for separation, while removing plasma into the plasma container 304 and red blood cells into the red blood cell container 308. This arrangement also conveys plasma from the plasma container 304 to the donor, while also mixing saline from the container 288 in-line with the returned plasma. The in-line mixing of saline with plasma raises the saline temperature and improves donor comfort. This phase continues until the plasma container 304 is empty, as monitored by the weigh sensor.

If the volume of whole blood in the in-process container 312 reaches a specified low threshold before the plasma container 304 empties, the circuit is programmed to enter another phase (Return Plasma Without Separation), to terminate operation of the in-process pump station PP1 (while also closing the in-line valves V9, V10, V12, and V14) to terminate blood separation. The phase continues until the plasma container 304 empties.

### e. Fill Donor Line

Upon emptying the plasma container 304, the circuit is programmed to enter a phase (Fill Donor Line), to operate the donor interface pump station PP3 (i.e., in through the in-line valve V11 and out through the in-line valve V13) to draw whole blood from the in-process container 312 to fill the donor tube 266, thereby purging plasma (mixed with saline) in preparation for another draw whole blood cycle.

The circuit is then programmed to conduct another Blood Separation While Drawing Whole Blood Phase, to refill the in-process container 312. The circuit is programmed in successive Blood Separation and Return Plasma Phases until the weigh sensor indicates that a desired volume of red blood cells have been collected in the red blood cell collection container 308. When the targeted volume of red blood cells has not been collected, the post-collection cycle commences.

The programming of the circuit during the phases of the collection cycle is summarized in the following table.

TABLE
Programming of Blood Processing Circuit During The Collection Cycle
(Double Red Blood Cell Collection Procedure)

| | | | Blood Separation | | |
|---|---|---|---|---|---|
| | | | While Drawing | Return Plasma/ | |
| | | | Whole Blood | With Separation | Fill |
| | Blood | Blood | (Without Drawing | (Without | Donor |
| Phase | Prime 1 | Prime 2 | Whole Blood) | Separation) | Line |
| V1 | | | | | ∘ |
| V2 | | | ∘ | ∘ | |
| | | | | () | |
| V3 | ∘ | | ∘ | | |
| | | | () | | |
| V4 | | | | | |
| V5 | | | ∘ | ∘ | |
| V6 | | | | ∘/ | |
| | | | | Alternates With | |
| | | | | V23 | |
| V7 | | ∘ | | | ∘ |
| V8 | | | | | |
| V9 | | ∘/ | ∘/ | ∘/ | |
| | | Pump | Pump In | Pump In | |
| | | In | | () | |
| V10 | | | ∘/ | ∘/ | |
| | | | Pump Out | Pump Out | |
| | | | | () | |
| V11 | ∘/ | ∘ | ∘/ | ∘/ | ∘/ |
| | Pump | | Pump Out | Pump In | Pump |
| | Out | | () | | In |
| V12 | | | ∘/ | ∘/ | |
| | | | Pump In | Pump In | |
| | | | | () | |
| V13 | ∘/ | ∘ | ∘/ | ∘/ | ∘/ |
| | Pump | | Pump In | Pump Out | Pump |
| | In | | () | | Out |
| V14 | | ∘/ | ∘/ | ∘/ | |
| | | Pump | Pump Out | Pump Out | |
| | | Out | | () | |
| V15 | ∘/ | | ∘/ | | |
| | Pump | | Pump Out | | |
| | Out | | () | | |
| V16 | | | | | |
| V17 | | | | | |
| V18 | ∘ | ∘ | ∘ | ∘ | ∘ |
| | | | () | | |
| V19 | ∘ | | ∘ | | |
| | | | () | | |
| V20 | ∘/ | | ∘/ | | |
| | Pump | | Pump In | | |
| | Out | | () | | |
| V21 | | | | | |
| V22 | | | | ∘ | |
| V23 | | | | ∘/ | |
| | | | | Alternates With | |
| | | | | V6 | |
| PP1 | ▪ | □ | □ | □ | ▪ |
| | | | | (▪) | |
| PP2 | ▪ | ▪ | □ | □ | ▪ |
| | | | | (▪) | |
| PP3 | □ | ▪ | □ | □ | □ |
| | | | (▪) | | |
| PP4 | □ | ▪ | □ | ▪ | ▪ |
| | | | (▪) | | |

Caption:
∘ denotes an open valve;
 denotes a closed valve;
∘/ denotes a valve opening and closing during a pumping sequence;
▪ denotes an idle pump station (not in use); and
□ denotes a pump station in use.

### 3. The Post-Collection Cycle

Once the targeted volume of red blood cells has been collected (as monitored by the weigh sensor), the circuit is programmed to carry out the phases of the post-collection cycle.

### a. Return Excess Plasma

In a first phase of the post-collection cycle (Excess Plasma Return), the circuit is programmed to terminate the supply and removal of blood to and from the processing chamber 18, while operating the donor interface pump station PP3 (i.e., in through in-line valve V11 and out through the in-line valve V13) to convey plasma remaining in the plasma container 304 to the donor. The circuit is also programmed in this phase to mix saline from the container 288 in-line with the returned plasma. This phase continues until the plasma container 304 is empty, as monitored by the weigh sensor.

### b. Saline Purge

In the next phase of the post-collection cycle (Saline Purge), the circuit is programmed to operate the donor interface pump station PP3 (i.e., in through in-line valve V13 and out through in-line valve V11) to convey saline from the container 288 through the separation device, to displace the blood contents of the separation device into the in-process container 312, in preparation for their return to the donor. This phase reduces the loss of donor blood. This phase continues until a predetermined volume of saline is pumped through the separation device, as monitored by the weigh sensor.

### c. Final Return to Donor

In the next phase of the post-collection cycle (Final Return), the circuit is programmed to operate the donor interface pump station PP3 (i.e., in through the in-line valve V11 and out through the in-line valve V13) to convey the blood contents of the in-process container 312 to the donor. Saline is intermittently mixed with the blood contents. This phase continues until the in-process container 312 is empty, as monitored by the weigh sensor.

### d. Fluid Replacement

In the next phase (Fluid Replacement), the circuit is programmed to operate the donor interface pump station PP3 (i.e., in through the in-line valve V11 and out through the in-line valve V13) to convey the saline to the donor. This phase continues until a prescribed replacement volume amount is infused, as monitored by the weigh sensor.

### e. Empty In-Process Container

In the next phase of the post-collection cycle (Empty In-Process Container), the circuit is programmed to operate the donor interface pump station PP3 (i.e., in through the in-line valve V11 and out through the in-line valve V13) to convey all remaining contents of the in-process container 312 to the donor, in preparation for splitting the contents of the red blood cell container 308 for storage in both containers 308 and 312. This phase continues until a zero volume reading for the in-process container 312 occurs, as monitored by the weigh sensor, and air is detected at the air detector.

At this phase, the circuit is programmed to close all valves and idle all pump stations, so that the phlebotomy needle 268 can be removed from the donor.

The programming of the circuit during the phases of the post-collection cycle is summarized in the following table.

TABLE
Programming of Blood Processing Circuit During The Post-Collection
Cycle (Double Red Blood Cell Collection Procedure)

| | Excess | | | | Empty In- |
|---|---|---|---|---|---|
| | Plasma | Saline | | Fluid | Process |
| Phase | Return | Purge | Final Return | Replacement | Container |
| V1 | | | ∘ | | ∘ |
| V2 | | | | | |
| V3 | | | | | |
| V4 | | ∘ | | | |
| V5 | ∘ | | | | |
| V6 | ∘/ | | | | |
| | Alternates | | | | |
| | With V23 | | | | |
| V7 | | | ∘/ | | ∘ |
| | | | Alternates With | | |
| | | | V23 | | |
| V8 | | | | | |
| V9 | ∘ | ∘ | | | |
| V10 | | | | | |
| V11 | ∘/ | ∘/ | ∘/ | ∘/ | ∘/ |
| | Pump In | Pump In/ | Pump In | Pump In | Pump In |
| | | Pump Out | | | |
| V12 | | | | | |
| V13 | ∘/ | | ∘/ | ∘/ | ∘/ |
| | Pump Out | | Pump Out | Pump Out | Pump Out |
| V14 | | ∘ | | | |
| V15 | | | | | |
| V16 | | | | | |
| V17 | | | | | |
| V18 | ∘ | | ∘ | ∘ | ∘ |
| V19 | | | | | |
| V20 | | | | | |
| V21 | | | | | |
| V22 | ∘ | ∘ | ∘ | ∘ | |
| V23 | ∘/ | ∘ | ∘/ | ∘ | |
| | Alternates | | Alternates With | | |
| | With V6 | | V7 | | |
| PP1 | ▪ | ▪ | ▪ | ▪ | ▪ |
| PP2 | ▪ | ▪ | ▪ | ▪ | ▪ |
| PP3 | □ | □ | □ | □ | □ |
| PP4 | ▪ | ▪ | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### 4. The Storage Preparation Cycle

### a. Split RBC

In the first phase of the storage preparation cycle (Split RBC), the circuit is programmed to operate the donor interface pump station PP3 to transfer half of the contents of the red blood cell collection container 308 into the in-process container 312. The volume pumped is monitored by the weigh sensors for the containers 308 and 312.

### b. Add RBC Preservative

In the next phases of the storage preparation cycle (Add Storage Solution to the In-Process Container and Add Storage Solution to the Red Blood Cell Collection Container), the circuit is programmed to operate the donor interface pump station PP3 to transfer a desired volume of red blood cell storage solution from the container 280 first into the in-process container 312 and then into the red blood cell collection container 308. The transfer of the desired volume is monitored by the weigh scale.

### c. End Procedure

In the next and final phase (End Procedure), the circuit is programmed to close all valves and idle all pump stations, so that the red blood cell containers 308 and 312 can be separated and removed for storage. The remainder of the disposable set can now be removed and discarded.

The programming of the circuit during the phases of the storage preparation cycle is summarized in the following table.

TABLE
Programming of Blood Processing Circuit During The Storage
Preparation Cycle (Double Red Blood Cell Collection Procedure)

| | Split RBC | | Add Storage | |
|---|---|---|---|---|
| | Between RBC | Add Storage | Solution | |
| | Collection And | Solution To In- | To RBC | End Procedure |
| | In-Process | Process | Collection | (Remove Veni- |
| Phase | Containers | Container | Container | puncture) |
| V1 | | | | |
| V2 | ∘ | | ∘ | |
| V3 | ∘/ | ∘ | | |
| | Alternates With | | | |
| | V11 And V4 | | | |
| V4 | ∘/ | | ∘ | |
| | Alternates With | | | |
| | V11 and V3 | | | |
| V5 | | | | |
| V6 | | | | |
| V7 | | | | |
| V8 | | | | |
| V9 | | | | |
| V10 | | | | |
| V11 | ∘/ | ∘/ | ∘/ | |
| | Pump In/ | Pump In/ | Pump In/ | |
| | Pump Out | Pump Out | Pump Out | |
| V12 | | | | |
| V13 | | | | |
| V14 | | | | |
| V15 | | | | |
| V16 | | ∘ | ∘ | |
| V17 | | | | |
| V18 | | | | |
| V19 | | | | |
| V20 | | | | |
| V21 | | ∘ | ∘ | |
| V22 | | | | |
| V23 | | | | |
| PP1 | ▪ | ▪ | ▪ | ▪ |
| PP2 | ▪ | ▪ | ▪ | ▪ |
| PP3 | □ | □ | □ | ▪ |
| PP4 | ▪ | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### B. Plasma Collection

### No Red Blood Cell Collection

During this procedure, whole blood from a donor is centrifugally processed to yield up to 880 ml of plasma for collection. All red blood cells are returned to the donor. This procedure will, in shorthand, be called the plasma collection procedure.

Programming of the blood processing circuit 46 (through the selective application of pressure to the valves and pump stations of the cassette) makes it possible to use the same universal set 264 as in the double red blood cell collection procedure.

The procedure includes a pre-collection cycle, a collection cycle, and a post-collection cycle.

During the pre-collection cycle, the set 264 is primed to vent air prior to venipuncture. During the collection cycle, whole blood drawn from the donor is processed to collect plasma, while returning red blood cells to the donor. During the post-collection cycle, excess plasma is returned to the donor, and the set is flushed with saline.

### 1. The Pre-Collection Cycle

### a. Anticoagulant Prime

In the pre-collection cycle for the plasma collection (no red blood cells) procedure, the cassette is programmed to carry out AC Prime 1 and AC Prime 2 Phases that are identical to the AC Prime 1 and AC Prime 2 Phases of the double red blood cell collection procedure.

### b. Saline Prime/Vent Donor Line/Venipuncture

In the pre-collection cycle for the plasma collection (no red blood cell) procedure, the cassette is programmed to carry out Saline Prime 1, Saline Prime 2, Saline Prime 3, Vent Donor Line, and Venipuncture Phases that are identical to the Saline Prime 1, Saline Prime 2, Saline Prime 3, Vent Donor Line, and Venipuncture Phases of the double red blood cell collection procedure.

The programming of the circuit during the phases of the pre-collection cycle is summarized in the following table.

TABLE
Programming of Blood Processing Circuit During Pre-Collection Cycle
(Plasma Collection Procedure)

| | | | | | | Vent | |
|---|---|---|---|---|---|---|---|
| | AC | AC | Saline | Saline | Saline | Donor | Veni- |
| Phase | Prime 1 | Prime 2 | Prime 1 | Prime 2 | Prime 3 | Line | puncture |
| V1 | | | | | | | |
| V2 | | | | | | | |
| V3 | ∘ | ∘ | | | | ∘ | |
| V4 | | | ∘ | | | | |
| V5 | | | | | | | |
| V6 | | | | | ∘ | | |
| V7 | | | | | ∘ | | |
| V8 | | | | | | | |
| V9 | | | ∘/ | ∘/ | ∘/ | | |
| | | | Pump | Pump | Pump In | | |
| | | | Out | Out | (Stage 1) | | |
| | | | | | ∘ | | |
| | | | | | (Stage 2) | | |
| V10 | | | | | ∘ | | |
| | | | | | (Stage 1) | | |
| | | | | | ∘/ | | |
| | | | | | Pump | | |
| | | | | | Out | | |
| | | | | | (Stage 2) | | |
| V11 | ∘/ | ∘ | | | | ∘/ | |
| | Pump | | | | | Pump In | |
| | Out | | | | | | |
| V12 | | | | | ∘ | | |
| | | | | | (Stage 1) | | |
| | | | | | ∘/ | | |
| | | | | | Pump In | | |
| | | | | | (Stage 2) | | |
| V13 | ∘/ | ∘ | | | | ∘/ | |
| | Pump In | | | | | Pump | |
| | | | | | | Out | |
| V14 | | | ∘/ | ∘/ | ∘/ | | |
| | | | Pump In | Pump In | Pump | | |
| | | | | | Out | | |
| | | | | | (Stage 1) | | |
| | | | | | ∘ | | |
| | | | | | (Stage 2) | | |
| V15 | ∘ | ∘/ | | | | ∘ | |
| | | Pump In | | | | | |
| | | Pump | | | | | |
| | | Out | | | | | |
| V16 | | | | | | | |
| V17 | | | | | | | |
| V18 | ∘ | ∘ | | | | ∘ | |
| V19 | ∘ | ∘ | | | | ∘ | |
| V20 | ∘ | ∘/ | | | | ∘ | |
| | | Pump | | | | | |
| | | Out | | | | | |
| | | Pump In | | | | | |
| V21 | | | | | | | |
| V22 | | | ∘ | ∘ | ∘ | | |
| V23 | | | ∘ | ∘ | ∘ | | |
| PP1 | ▪ | ▪ | □ | □ | □ | ▪ | ▪ |
| | | | | | (Stage 1) | | |
| PP2 | ▪ | ▪ | ▪ | ▪ | □ | ▪ | ▪ |
| | | | | | (Stage 2) | | |
| PP3 | □ | ▪ | ▪ | ▪ | ▪ | □ | ▪ |
| PP4 | ▪ | □ | ▪ | ▪ | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### 2. The Collection Cycle

### a. Blood Prime 1

With venipuncture, the tubing 300 leading to the phlebotomy needle 268 is opened. In a first phase of the collection cycle (Blood Prime 1), the blood processing circuit 46 is programmed to operate the donor interface pump PP3 (i.e., in through the in-line valve V13 and out through the in-line valve V11) and the anticoagulant pump PP4 (i.e., in through the in-line valve V20 and out through the in-line valve V15) to draw anticoagulated blood through the donor tube 266 into the in-process container 312, in the same fashion as the Blood Prime 1 Phase of the double red blood cell collection procedure, as already described.

### b. Blood Prime 2

In a next phase (Blood Prime 2), the blood processing circuit 46 is programmed to operate the in-process pump station PP1 to draw anticoagulated blood from the in-process container 312 through the separation device, in the same fashion as the Blood Prime 2 Phase for the double red blood cell collection procedure, as already described. During this phase, saline displaced by the blood is returned to the donor.

### c. Blood Separation while Drawing Whole Blood or without Drawing Whole Blood

In a next phase of the blood collection cycle (Blood Separation While Drawing Whole Blood), the blood processing circuit 46 is programmed to operate the donor interface pump station PP3 (i.e., in through the in-line valve V13 and out through the in-line valve V11); the anticoagulant pump PP4 (i.e., in through valve V20 and out through the in-line valve V15); the in-process pump PP1 (i.e., in through the in-line valve V9 and out through the in-line valve V14); and the plasma pump PP2 (i.e., in through the in-line valve V12 and out through the in-line valve V10), in the same fashion as the Blood Separation While Drawing Whole Blood Phase for the double red blood cell collection procedure, as already described. This arrangement draws anticoagulated blood into the in-process container 312, while conveying the blood from the in-process container 312 into the processing chamber 18 for separation. This arrangement also removes plasma from the processing chamber 18 into the plasma container 304, while removing red blood cells from the processing chamber 18 into the red blood cell container 308. This phase continues until the targeted volume of plasma is collected in the plasma collection container 304 (as monitored by the weigh sensor) or until a targeted volume of red blood cells is collected in the red blood cell collection container (as monitored by the weigh sensor).

As in the double red blood cell collection procedure, if the volume of whole blood in the in-process container 312 reaches a predetermined maximum threshold before the targeted volume of either plasma or red blood cells is collected, the circuit is programmed to enter another phase (Blood Separation Without Drawing Whole Blood), to terminate operation of the donor interface pump station PP3 (while also closing the in-line valves V13, V11, V18, and V3) to terminate collection of whole blood in the in-process container 312, while still continuing blood separation. If the volume of whole blood reaches a predetermined minimum threshold in the in-process container 312 during blood separation, but before the targeted volume of either plasma or red blood cells is collected, the circuit is programmed to return to the Blood Separation While Drawing Whole Blood Phase, to thereby refill the in-process container 312. The circuit is programmed to toggle between the Blood Separation Phases while drawing whole blood and without drawing whole blood, according to the high and low volume thresholds for the in-process container 312, until the requisite volume of plasma has been collected, or until the target volume of red blood cells has been collected, whichever occurs first.

### d. Return Red Blood Cells/Saline

If the targeted volume of plasma has not been collected, the next phase of the blood collection cycle (Return Red Blood Cells With Separation) programs the blood processing circuit 46 to operate the donor interface pump station PP3 (i.e., in through the in-line valve V11 and out through the in-line valve V13); the in-process pump PP1 (i.e., in through the in-line valve V9 and out through the in-line valve V14); and the plasma pump PP2 (i.e., in through the in-line valve V12 and out through the in-line valve V10). This arrangement conveys anticoagulated whole blood from the in-process container 312 into the processing chamber 18 for separation, while removing plasma into the plasma container 304 and red blood cells into the red blood cell container 308. This arrangement also conveys red blood cells from the red blood cell container 308 to the donor, while also mixing saline from the container 288 in-line with the returned red blood cells. The in-line mixing of saline with the red blood cells raises the saline temperature and improves donor comfort. The in-line mixing of saline with the red blood cells also lowers the hematocrit of the red blood cells being returned to the donor, thereby allowing a larger gauge (i.e., smaller diameter) phlebotomy needle to be used, to further improve donor comfort. This phase continues until the red blood cell container 308 is empty, as monitored by the weigh sensor.

If the volume of whole blood in the in-process container 312 reaches a specified low threshold before the red blood cell container 308 empties, the circuit is programmed to enter another phase (Red Blood Cell Return Without Separation), to terminate operation of the in-process pump station PP1 (while also closing the in-line valves V9, V10, V12, and V14) to terminate blood separation. The phase continues until the red blood cell container 308 empties.

### e. Fill Donor Line

Upon emptying the red blood cell container 308, the circuit is programmed to enter another phase (Fill Donor Line), to operate the donor interface pump station PP3 (i.e., in through the in-line valve V11 and out through the in-line valve V13) to draw whole blood from the in-process container 312 to fill the donor tube 266, thereby purging red blood cells (mixed with saline) in preparation for another draw whole blood cycle.

The circuit is then programmed to conduct another Blood Separation While Drawing Whole Blood Phase, to refill the in-process container 312. The circuit is programmed to conduct successive draw whole blood and return red blood cells/saline cycles, as described, until the weigh sensor indicates that a desired volume of plasma has been collected in the plasma collection container 304. When the targeted volume of plasma has been collected, the post-collection cycle commences.

The programming of the circuit during the phases of the collection cycle is summarized in the following table.

TABLE
Programming of Blood Processing Circuit During The Collection Cycle
(Plasma Collection Procedure)

| | | | Blood Separation | Return Red Blood | |
|---|---|---|---|---|---|
| | | | While Drawing | Cells/Saline With | |
| | | | Whole Blood | Separation | Fill |
| | Blood | Blood | (Without Drawing | (Without | Donor |
| Phase | Prime 1 | Prime 2 | Whole Blood) | Separation) | Line |
| V1 | | | | | ∘ |
| V2 | | | ∘ | ∘ | |
| V3 | ∘ | | ∘ | | |
| | | | () | | |
| V4 | | | | | |
| V5 | | | ∘ | ∘ | |
| | | | | () | |
| V6 | | | | | |
| V7 | | ∘ | | ∘/ | ∘ |
| | | | | Alternates With | |
| | | | | V23 | |
| V8 | | | | | |
| V9 | | ∘/ | ∘/ | ∘/ | |
| | | Pump | Pump In | Pump In | |
| | | In | | () | |
| V10 | | | ∘/ | ∘/ | |
| | | | Pump Out | Pump Out | |
| | | | | () | |
| V11 | ∘/ | ∘ | ∘/ | ∘/ | ∘/ |
| | Pump | | Pump Out | Pump In | Pump |
| | Out | | () | | In |
| V12 | | | ∘/ | ∘/ | |
| | | | Pump In | Pump In | |
| | | | | () | |
| V13 | ∘/ | ∘ | ∘/ | ∘/ | ∘/ |
| | Pump | | Pump In | Pump Out | Pump |
| | In | | () | | Out |
| V14 | | ∘/ | ∘/ | ∘/ | |
| | | Pump | Pump Out | Pump Out | |
| | | Out | | () | |
| V15 | ∘/ | | ∘/ | | |
| | Pump | | Pump Out | | |
| | Out | | () | | |
| V16 | | | | | |
| V17 | | | | | |
| V18 | ∘ | ∘ | ∘ | ∘ | ∘ |
| | | | () | | |
| V19 | ∘ | | ∘ | | |
| | | | () | | |
| V20 | ∘/ | | ∘/ | | |
| | Pump | | Pump In | | |
| | Out | | () | | |
| V21 | | | | | |
| V22 | | | | ∘ | |
| V23 | | | | ∘/ | |
| | | | | Alternates With | |
| | | | | V7 | |
| PP1 | ▪ | □ | □ | □ | ▪ |
| | | | | (▪) | |
| PP2 | ▪ | ▪ | □ | □ | ▪ |
| | | | | (▪) | |
| PP3 | □ | ▪ | □ | □ | □ |
| | | | (▪) | | |
| PP4 | □ | ▪ | □ | ▪ | ▪ |
| | | | (▪) | | |

Caption:
∘ denotes an open valve;
 denotes a closed valve;
∘/ denotes a valve opening and closing during a pumping sequence;
▪ denotes an idle pump station (not in use); and
□ denotes a pump station in use.

### 3. The Post-Collection Cycle

Once the targeted volume of plasma has been collected (as monitored by the weigh sensor), the circuit is programmed to carry out the phases of the post-collection cycle.

### a. Remove Plasma Collection Container

In a first phase of the post-collection cycle (Remove Plasma Collection Container), the circuit is programmed to close all valves and disable all pump stations to allow separation of the plasma collection container 304 from the set 264.

### b. Return Red Blood Cells

In the second phase of the post-collection cycle (Return Red Blood Cells), the circuit is programmed to operate the donor interface pump station PP3 (i.e., in through the in-line valve V11 and out through the in-line valve V13) to convey red blood cells remaining in the red blood cell collection container 308 to the donor. The circuit is also programmed in this phase to mix saline from the container 288 in-line with the returned red blood cells. This phase continues until the red blood cell container 308 is empty, as monitored by the weigh sensor.

### c. Saline Purge

In the next phase of the post-collection cycle (Saline Purge), the circuit is programmed to operate the donor interface pump station PP3 (i.e., in through the in-line valve V13 and out through the in-line valve V11) to convey saline from the container 288 through the separation device, to displace the blood contents of the separation device into the in-process container 312, in preparation for their return to the donor. This phase reduces the loss of donor blood. This phase continues until a predetermined volume of saline is pumped through the separation device, as monitored by the weigh sensor.

### d. Final Return to Donor

In the next phase of the post-collection cycle (Final Return), the circuit is programmed to operate the donor interface pump station PP3 (i.e., in through the in-line valve V11 and out through the in-line valve V13) to convey the blood contents of the in-process container 312 to the donor. Saline is intermittently mixed with the blood contents. This phase continues until the in-process container 312 is empty, as monitored by the weigh sensor.

### e. Fluid Replacement

In the next phase (Fluid Replacement), the circuit is programmed to operate the donor interface pump station PP3 (i.e., in through the in-line valve V11 and out through the in-line valve V13) to convey the saline to the donor. This phase continues until a prescribed replacement volume amount is infused, as monitored by the weigh sensor.

### f. End Procedure

In the final phase (End Procedure), the circuit is programmed to close all valves and idle all pump stations, so that venipuncture can be terminated, and the plasma container can be separated and removed for storage. The remaining parts of the disposable set can be removed and discarded.

The programming of the circuit during the phases of the post-collection cycle is summarized in the following table.

TABLE
Programming of Blood Processing Circuit During The Post-Collection
Cycle (Plasma Collection Procedure)

| | Remove | | | | | |
|---|---|---|---|---|---|---|
| | Plasma | | | | Fluid | End |
| | Collection | Return | Saline | Final | Replace- | Proce- |
| Phase | Container | RBC | Purge | Return | ment | dure |
| V1 | | | | ∘ | | |
| V2 | | ∘ | | | | |
| V3 | | | | | | |
| V4 | | | ∘ | | | |
| V5 | | | | | | |
| V6 | | | | | | |
| V7 | | ∘/ | | ∘/ | | |
| | | Alternates | | Alternates | | |
| | | With V23 | | With V23 | | |
| V8 | | | | | | |
| V9 | | ∘ | ∘ | | | |
| V10 | | | | | | |
| V11 | | ∘/ | ∘/ | ∘/ | ∘/ | |
| | | Pump In | Pump | Pump In | Pump | |
| | | | In/ | | In | |
| | | | Pump | | | |
| | | | Out | | | |
| V12 | | | | | | |
| V13 | | ∘/ | | ∘/ | ∘/ | |
| | | Pump Out | | Pump Out | Pump | |
| | | | | | Out | |
| V14 | | | ∘ | | | |
| V15 | | | | | | |
| V16 | | | | | | |
| V17 | | | | | | |
| V18 | ∘ | ∘ | | ∘ | ∘ | |
| V19 | | | | | | |
| V20 | | | | | | |
| V21 | | | | | | |
| V22 | | ∘ | ∘ | ∘ | ∘ | |
| V23 | | ∘/ | ∘ | ∘/ | ∘ | |
| | | Alternates | | Alternates | | |
| | | With V6 | | With V7 | | |
| PP1 | ▪ | ▪ | ▪ | ▪ | ▪ | ▪ |
| PP2 | ▪ | ▪ | ▪ | ▪ | ▪ | ▪ |
| PP3 | ▪ | □ | □ | □ | □ | ▪ |
| PP4 | ▪ | ▪ | ▪ | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### C. Red Blood Cell and Plasma Collection

During this procedure, whole blood from a donor is centrifugally processed to collect up to about 550 ml of plasma and up to about 250 ml of red blood cells. This procedure will, in shorthand, be called the red blood cell/plasma collection procedure.

The portion of the red blood cells not retained for collection are periodically returned to the donor during blood separation. Plasma collected in excess of the 550 ml target and red blood cells collected in excess of the 250 ml target are also returned to the donor at the end of the procedure.

Programming of the blood processing circuit 46 (through the selective application of pressure to the valves and pump stations of the cassette) makes it possible to use the same universal set 264 used to carry out the double red blood cell collection or the plasma collection procedure.

The procedure includes a pre-collection cycle, a collection cycle, and a post-collection cycle, and a storage preparation cycle.

During the pre-collection cycle, the set 264 is primed to vent air prior to venipuncture. During the collection cycle, whole blood drawn from the donor is processed to collect plasma and red blood cells, while returning a portion of the red blood cells to the donor. During the post-collection cycle, excess plasma and red blood cells are returned to the donor, and the set is flushed with saline. During the storage preparation cycle, a red blood cell storage solution is added to the collected red blood cells.

### 1 The Pre-Collection Cycle

### a. Anticoagulant Prime

In the pre-collection cycle for the red blood cell/plasma collection procedure, the cassette is programmed to carry out AC Prime 1 and AC Prime 2 Phases that are identical to the AC Prime 1 and AC Prime 2 Phases of the double red blood cell collection procedure.

### b. Saline Prime/Vent Donor Line/Venipuncture

In the pre-collection cycle for the red blood cell/plasma collection procedure, the cassette is programmed to carry out Saline Prime 1, Saline Prime 2, Saline Prime 3, Vent Donor Line, and Venipuncture Phases that are identical to the Saline Prime 1, Saline Prime 2, Saline Prime 3, Vent Donor Line, and Venipuncture Phases of the double red blood cell collection procedure.

The programming of the circuit during the phases of the pre-collection cycle is summarized in the following table.

TABLE
Programming of Blood Processing Circuit During Pre-Collection Cycle
(Red Blood Cell/Plasma Collection Procedure)

| | | | | | | Vent | |
|---|---|---|---|---|---|---|---|
| | AC | AC | Saline | Saline | Saline | Donor | |
| Phase | Prime 1 | Prime 2 | Prime 1 | Prime 2 | Prime 3 | Line | Venipuncture |
| V1 | | | | | | | |
| V2 | | | | | | | |
| V3 | ∘ | ∘ | | | | ∘ | |
| V4 | | | ∘ | | | | |
| V5 | | | | | | | |
| V6 | | | | | ∘ | | |
| V7 | | | | | ∘ | | |
| V8 | | | | | | | |
| V9 | | | ∘/ | ∘/ | ∘/ | | |
| | | | Pump | Pump | Pump In | | |
| | | | Out | Out | (Stage 1) | | |
| | | | | | ∘ | | |
| | | | | | (Stage 2) | | |
| V10 | | | | | ∘ | | |
| | | | | | (Stage 1) | | |
| | | | | | ∘/ | | |
| | | | | | Pump | | |
| | | | | | Out | | |
| | | | | | (Stage 2) | | |
| V11 | ∘/ | ∘ | | | | ∘/ | |
| | Pump | | | | | Pump In | |
| | Out | | | | | | |
| V12 | | | | | ∘ | | |
| | | | | | (Stage 1) | | |
| | | | | | ∘/ | | |
| | | | | | Pump In | | |
| | | | | | (Stage 2) | | |
| V13 | ∘/ | ∘ | | | | ∘/ | |
| | Pump In | | | | | Pump | |
| | | | | | | Out | |
| V14 | | | ∘/ | ∘/ | ∘/ | | |
| | | | Pump In | Pump In | Pump | | |
| | | | | | Out | | |
| | | | | | (Stage 1) | | |
| | | | | | ∘ | | |
| | | | | | (Stage 2) | | |
| V15 | ∘ | ∘/ | | | | ∘ | |
| | | Pump In | | | | | |
| | | Pump | | | | | |
| | | Out | | | | | |
| V16 | | | | | | | |
| V17 | | | | | | | |
| V18 | ∘ | ∘ | | | | ∘ | |
| V19 | ∘ | ∘ | | | | ∘ | |
| V20 | ∘ | ∘/ | | | | ∘ | |
| | | Pump | | | | | |
| | | Out | | | | | |
| | | Pump In | | | | | |
| V21 | | | | | | | |
| V22 | | | ∘ | ∘ | ∘ | | |
| V23 | | | ∘ | ∘ | ∘ | | |
| PP1 | ▪ | ▪ | □ | □ | □ | ▪ | ▪ |
| | | | | | (Stage 1) | | |
| PP2 | ▪ | ▪ | ▪ | ▪ | □ | ▪ | ▪ |
| | | | | | (Stage 2) | | |
| PP3 | □ | ▪ | ▪ | ▪ | ▪ | □ | ▪ |
| PP4 | ▪ | □ | ▪ | ▪ | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### 2. The Collection Cycle

### a. Blood Prime

With venipuncture, the tubing 300 leading to the phlebotomy needle 268 is opened. The collection cycle of the red blood cell/plasma collection procedure programs the circuit to carry out Blood Prime 1 and Blood Prime 2 Phases that are identical to the Blood Prime 1 and Blood Prime 2 Phases of the Double Red Blood Cell Collection Procedure, already described.

### b. Blood Separation while Drawing Whole Blood or without Drawing Whole Blood

In the blood collection cycle for the red blood cell/plasma collection procedure, the circuit is programmed to conduct a Blood Separation While Drawing Whole Blood Phase, in the same fashion that the Blood Separation While Drawing Whole Blood Phase is conducted for the double red blood cell collection procedure. This arrangement draws anticoagulated blood into the in-process container 312, while conveying the blood from the in-process container 312 into the processing chamber 18 for separation. This arrangement also removes plasma from the processing chamber 18 into the plasma container 304, while removing red blood cells from the processing chamber 18 into the red blood cell container 308. This phase continues until the desired maximum volumes of plasma and red blood cells have been collected in the plasma and red blood cell collection containers 304 and 308 (as monitored by the weigh sensor).

As in the double red blood cell collection procedure and the plasma collection procedure, if the volume of whole blood in the in-process container 312 reaches a predetermined maximum threshold before the targeted volume of either plasma or red blood cells is collected, the circuit is programmed to enter a phase (Blood Separation Without Whole Blood Draw) to terminate operation of the donor interface pump station PP3 (while also closing the in-line valves V13, V11, V18, and V3) to terminate collection of whole blood in the in-process container 312, while still continuing blood separation. If the volume of whole blood reaches a predetermined minimum threshold in the in-process container 312 during blood separation, but before the targeted volume of either plasma or red blood cells is collected, the circuit is programmed to return to the Blood Separation With Whole Blood Draw, to thereby refill the in-process container 312. The circuit is programmed to toggle between the Blood Separation cycle with whole blood draw and without whole blood draw according to the high and low volume thresholds for the in-process container 312, until the requisite maximum volumes of plasma and red blood cells have been collected.

### c. Return Red Blood Cells and Saline

If the targeted volume of plasma has not been collected, and red blood cells collected in the red blood cell container 308 exceed a predetermined maximum threshold, the next phase of the blood collection cycle (Return Red Blood Cells With Separation) programs the blood processing circuit 46 to operate the donor interface pump station PP3 (i.e., in through the in-line valve V11 and out through the in-line valve V13); the in-process pump PP1 (i.e., in through the in-line valve V9 and out through the in-line valve V14); and the plasma pump PP2 (i.e., in through in-line valve V12 and out through the in-line valve V10). This arrangement continues to convey anticoagulated whole blood from the in-process container 312 into the processing chamber 18 for separation, while removing plasma into the plasma container 304 and red blood cells into the red blood cell container 308. This arrangement also conveys all or a portion of the red blood cells collected in the red blood cell container 308 to the donor. This arrangement also mixes saline from the container 288 in-line with the returned red blood cells. The in-line mixing of saline with the red blood cells raises the saline temperature and improves donor comfort. The in-line mixing of saline with the red blood cells also lowers the hematocrit of the red blood cells being returned to the donor, thereby allowing a larger gauge (i.e., smaller diameter) phlebotomy needle to be used, to further improve donor comfort.

This phase can continue until the red blood cell container 308 is empty, as monitored by the weigh sensor, thereby corresponding to the Return Red Blood Cells With Separation Phase of the plasma collection procedure. More advantageously, however, the processor determines how much additional plasma needs to be collected to meet the plasma target volume. From this, the processor derives the incremental red blood cell volume associated with the incremental plasma volume. In this arrangement, the processor returns a partial volume of red blood cells to the donor, so that, upon collection of the next incremental red blood cell volume, the total volume of red blood cells in the container 308 will be at or slightly over the targeted red blood cell collection volume.

If the volume of whole blood in the in-process container 312 reaches a specified low threshold before return of the desired volume of red blood cells, the circuit is programmed to enter a phase (Return Red Blood Cells Without Separation), to terminate operation of the in-process pump station PP1 (while also closing the in-line valves V9, V10, V12, and V14) to terminate blood separation. This phase corresponds to the Return Red Blood Cells Without Separation Phase of the plasma collection procedure.

### d. Fill Donor Line

Upon returning the desired volume of red blood cells from the container 308, the circuit is programmed to enter a phase (Fill Donor Line), to operate the donor interface pump station PP3 (i.e., in through the in-line valve V11 and out through the in-line valve V13) to draw whole blood from the in-process container 312 to fill the donor tube 266, thereby purging red blood cells (mixed with saline) in preparation for another draw whole blood cycle.

The circuit is then programmed to conduct another Blood Separation While Drawing Whole Blood Phase, to refill the in-process container 312. If required, the circuit is capable of performing successive draw whole blood and return red blood cells cycles, until the weigh sensors indicate that volumes of red blood cells and plasma collected in the containers 304 and 308 are at or somewhat greater than the targeted values. The post-collection cycle then commences.

The programming of the circuit during the phases of the collection cycle is summarized in the following table.

TABLE
Programming of Blood Processing Circuit During The Collection Cycle
(Red Blood Cell/Plasma Collection Procedure)

| | | | Blood Separation | Return Red Blood | |
|---|---|---|---|---|---|
| | | | While Drawing | Cells/Saline With | |
| | | | Whole Blood | Separation | Fill |
| | Blood | Blood | (Without Drawing | (Without | Donor |
| Phase | Prime 1 | Prime 2 | Whole Blood) | Separation) | Line |
| V1 | | | | | ∘ |
| V2 | | | ∘ | ∘ | |
| V3 | ∘ | | ∘ | | |
| | | | () | | |
| V4 | | | | | |
| V5 | | | ∘ | ∘ | |
| | | | | () | |
| V6 | | | | | |
| V7 | | ∘ | | ∘/ | ∘ |
| | | | | Alternates With | |
| | | | | V23 | |
| V8 | | | | | |
| V9 | | ∘/ | ∘/ | ∘/ | |
| | | Pump | Pump In | Pump In | |
| | | In | | () | |
| V10 | | | ∘/ | ∘/ | |
| | | | Pump Out | Pump Out | |
| | | | | () | |
| V11 | ∘/ | ∘ | ∘/ | ∘/ | ∘/ |
| | Pump | | Pump Out | Pump In | Pump |
| | Out | | () | | In |
| V12 | | | ∘/ | ∘/ | |
| | | | Pump In | Pump In | |
| | | | | () | |
| V13 | ∘/ | ∘ | ∘/ | ∘/ | ∘/ |
| | Pump | | Pump In | Pump Out | Pump |
| | In | | () | | Out |
| V14 | | ∘/ | ∘/ | ∘/ | |
| | | Pump | Pump Out | Pump Out | |
| | | Out | | () | |
| V15 | ∘/ | | ∘/ | | |
| | Pump | | Pump Out | | |
| | Out | | () | | |
| V16 | | | | | |
| V17 | | | | | |
| V18 | ∘ | ∘ | ∘ | ∘ | ∘ |
| | | | () | | |
| V19 | ∘ | | ∘ | | |
| | | | () | | |
| V20 | ∘/ | | ∘/ | | |
| | Pump | | Pump In | | |
| | Out | | () | | |
| V21 | | | | | |
| V22 | | | | ∘ | |
| V23 | | | | ∘/ | |
| | | | | Alternates With | |
| | | | | V7 | |
| PP1 | ▪ | □ | □ | □ | ▪ |
| | | | | (▪) | |
| PP2 | ▪ | ▪ | □ | □ | ▪ |
| | | | | (▪) | |
| PP3 | □ | ▪ | □ | □ | □ |
| | | | (▪) | | |
| PP4 | □ | ▪ | □ | ▪ | ▪ |
| | | | (▪) | | |

Caption:
∘ denotes an open valve;
 denotes a closed valve;
∘/ denotes a valve opening and closing during a pumping sequence;
▪ denotes an idle pump station (not in use); and
□ denotes a pump station in use.

### 3. The Post-Collection Cycle

Once the targeted maximum volumes of plasma and red blood cells have been collected (as monitored by the weigh sensor), the circuit is programmed to carry out the phases of the post-collection cycle.

### a. Return Excess Plasma

If the volume of plasma collected in the plasma collection container 304 is over the targeted volume, a phase of the post-collection cycle (Excess Plasma Return) is entered, during which the circuit is programmed to terminate the supply and removal of blood to and from the processing chamber 18, while operating the donor interface pump station PP3 (i.e., in through the in-line valve V11 and out through the in-line valve V13) to convey plasma in the plasma container 304 to the donor. The circuit is also programmed in this phase to mix saline from the container 288 in-line with the returned plasma. This phase continues until the volume of plasma in the plasma collection container 304 is at the targeted value, as monitored by the weigh sensor.

### b. Return Excess Red Blood Cells

If the volume of red blood cells collected in the red blood cell collection container 308 is also over the targeted volume, a phase of the post-collection cycle (Excess RBC Return) is entered, during which the circuit is programmed to operate the donor interface pump station PP3 (i.e., in through the in-line valve V11 and out through the in-line valve V13) to convey red blood cells remaining in the red blood cell collection container 308 to the donor. The circuit is also programmed in this phase to mix saline from the container 288 in-line with the returned red blood cells. This phase continues until the volume of red blood cells in the container 308 equals the targeted value, as monitored by the weigh sensor.

### c. Saline Purge

When the volumes of red blood cells and plasma collected in the containers 308 and 304 equal the targeted values, the next phase of the post-collection cycle (Saline Purge) is entered, during which the circuit is programmed to operate the donor interface pump station PP3 (i.e., in through the in-line valve V13 and out through the in-line valve V11) to convey saline from the container 288 through the separation device, to displace the blood contents of the separation device into the in-process container 312, in preparation for their return to the donor. This phase reduces the loss of donor blood. This phase continues until a predetermined volume of saline is pumped through the separation device, as monitored by the weigh sensor.

### d. Final Return to Donor

In the next phase of the post-collection cycle (Final Return), the circuit is programmed to operate the donor interface pump station PP3 (i.e., in through the in-line valve V11 and out through the in-line valve V13) to convey the blood contents of the in-process container 312 to the donor. Saline is intermittently mixed with the blood contents. This phase continues until the in-process container 312 is empty, as monitored by the weigh sensor.

### e. Fluid Replacement

In the next phase (Fluid Replacement), the circuit is programmed to operate the donor interface pump station PP3 (i.e., in through the in-line valve V11 and out through the in-line valve V13) to convey the saline to the donor. This phase continues until a prescribed replacement volume amount is infused, as monitored by the weigh sensor.

### f. End Venipuncture

In the next phase (End Venipuncture), the circuit is programmed to close all valves and idle all pump stations, so that venipuncture can be terminated.

The programming of the circuit during the phases of the post-collection cycle is summarized in the following table.

TABLE
Programming of Blood Processing Circuit During The Post-Collection Cycle
(Red Blood Cell/Plasma Collection Procedure)

| | Excess | Excess | | | | |
|---|---|---|---|---|---|---|
| | Plasma | RBC | | | Fluid | End |
| Phase | Return | Return | Saline Purge | Final Return | Replacement | Venipuncture |
| V1 | | | | ∘ | | |
| V2 | | ∘ | | | | |
| V3 | | | | | | |
| V4 | | | ∘ | | | |
| V5 | ∘ | | | | | |
| V6 | ∘/ | | | | | |
| | Alternates | | | | | |
| | With V23 | | | | | |
| V7 | | ∘/ | | ∘/ | | |
| | | Alternates | | Alternates | | |
| | | With V23 | | With V23 | | |
| V8 | | | | | | |
| V9 | ∘ | ∘ | ∘ | | | |
| V10 | | | | | | |
| V11 | ∘/ | ∘/ | ∘/ | ∘/ | ∘/ | |
| | Pump In | Pump In | Pump | Pump In | Pump In | |
| | | | In/ | | | |
| | | | Pump | | | |
| | | | Out | | | |
| V12 | | | | | | |
| V13 | ∘/ | ∘/ | | ∘/ | ∘/ | |
| | Pump Out | Pump Out | | Pump Out | Pump Out | |
| V14 | | | ∘ | | | |
| V15 | | | | | | |
| V16 | | | | | | |
| V17 | | | | | | |
| V18 | ∘ | ∘ | | ∘ | ∘ | |
| V19 | | | | | | |
| V20 | | | | | | |
| V21 | | | | | | |
| V22 | ∘ | ∘ | ∘ | ∘ | ∘ | |
| V23 | ∘/ | ∘/ | ∘ | ∘/ | ∘ | |
| | Alternates | Alternates | | Alternates | | |
| | With V6 | With V7 | | With V7 | | |
| PP1 | ▪ | ▪ | ▪ | ▪ | ▪ | ▪ |
| PP2 | ▪ | ▪ | ▪ | ▪ | ▪ | ▪ |
| PP3 | □ | □ | □ | □ | □ | ▪ |
| PP4 | ▪ | ▪ | ▪ | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### 4. The Storage Preparation Cycle

### a. RBC Preservative Prime

In the first phase of the storage preparation cycle (Prime Storage Solution), the circuit is programmed to operate the donor interface pump station PP3 to transfer a desired volume of red blood cell storage solution from the container 280 into the in-process container 312. The transfer of the desired volume is monitored by the weigh scale.

### b. Transfer Storage Solution

In the next phase (Transfer Storage Solution), the circuit is programmed to operate the donor interface pump station PP3 to transfer a desired volume of red blood cell storage solution from the in-process container 312 into the red blood cell collection container 308. The transfer of the desired volume is monitored by the weigh scale.

### c. End Procedure

In the next and final phase (End Procedure), the circuit is programmed to close all valves and idle all pump stations, so that the plasma and red blood cell storage containers 304 and 308 can be separated and removed for storage. The remainder of the disposable set can now be removed and discarded.

The programming of the circuit during the phases of the storage preparation cycle is summarized in the following table.

TABLE
Programming of Blood Processing Circuit During The Storage
Preparation Cycle (Double Red Blood Cell Collection Procedure)

| Phase | Prime Storage Solution | Transfer Storage Solution | End Procedure |
|---|---|---|---|
| V1 | | | |
| V2 | | ∘ | |
| V3 | ∘ | | |
| V4 | | ∘ | |
| V5 | | | |
| V6 | | | |
| V7 | | | |
| V8 | | | |
| V9 | | | |
| V10 | | | |
| V11 | ∘/ | ∘/ | |
| | Pump In/ | Pump In/ | |
| | Pump Out | Pump Out | |
| V12 | | | |
| V13 | | | |
| V14 | | | |
| V15 | | | |
| V16 | ∘ | ∘ | |
| V17 | | | |
| V18 | | | |
| V19 | | | |
| V20 | | | |
| V21 | ∘ | ∘ | |
| V22 | | | |
| V23 | | | |
| PP1 | ▪ | ▪ | ▪ |
| PP2 | ▪ | ▪ | ▪ |
| PP3 | □ | □ | ▪ |
| PP4 | ▪ | ▪ | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

### V. Interface Control

### A. Underspill and Overspill Detection

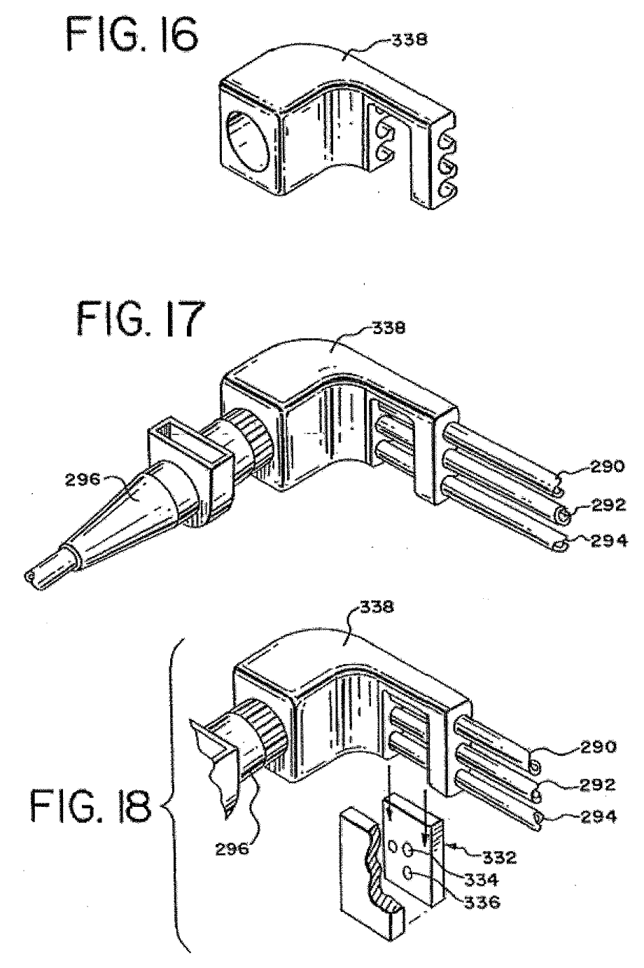

In any of the above-described procedures, the centrifugal forces present within the processing chamber 18 separate whole blood into a region of packed red blood cells and a region of plasma (see FIG. 15A). The centrifugal forces cause the region of packed red blood cells to congregate along the outside or high-G wall of the chamber, while the region of plasma is transported to the inside or low-G wall of the chamber.

An intermediate region forms an interface between the red blood cell region and the plasma region. Intermediate density cellular blood species like platelets and leukocytes populate the interface, arranged according to density, with the platelets closer to the plasma layer than the leukocytes. The interface is also called the “buffy coat,” because of its cloudy color, compared to the straw color of the plasma region and the red color of the red blood cell region.

It is desirable to monitor the location of the buffy coat, either to keep the buffy coat materials out of the plasma or out of the red blood cells, depending on the procedure, or to collect the cellular contents of the buffy coat. The system includes a sensing station 332 includes first and second optical sensors 334 and 336 for this purpose.

In the illustrated example of FIG. 13, the sensing station 332 is located a short distance outside the centrifuge station 20. This arrangement minimizes the fluid volume of components leaving the chamber before monitoring by the sensing station 332.

The first optical sensor 334 in the station 332 optically monitors the passage of blood components through the tube 292 (e.g., the plasma collection tube). The second optical sensor 336 in the station 332 optically monitors the passage of blood components through the tube 294 (e.g., red blood cell collection tube).

The tubes 292 and 294 are made from plastic (e.g. polyvinylchloride) material that is transparent to the optical energy used for sensing, at least in the region where the tubes 292 and 294 are to be placed into association with the sensing station 332.

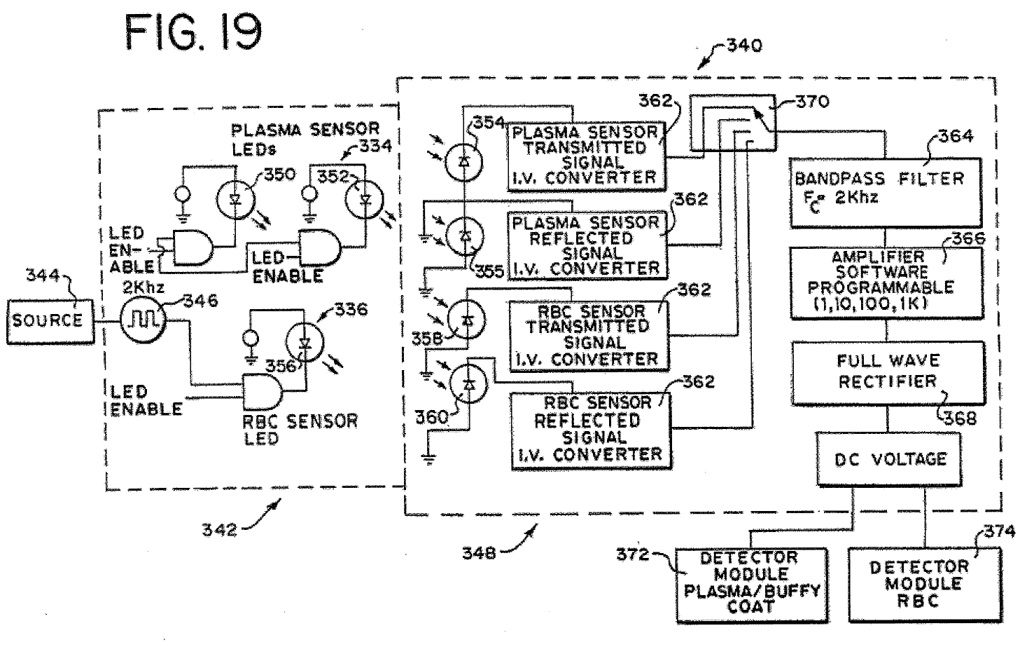

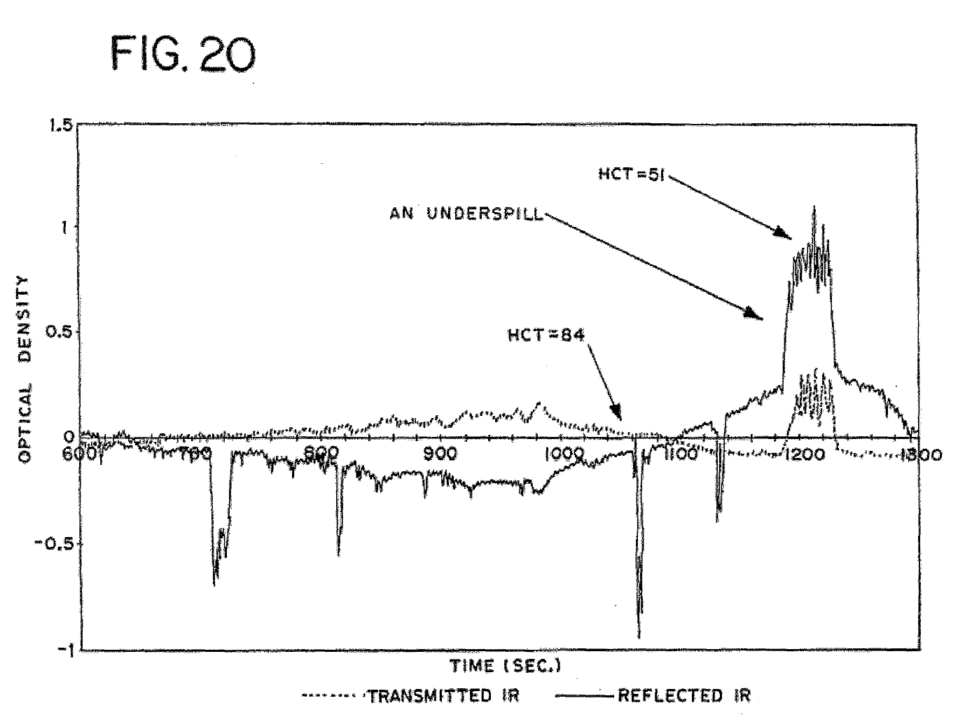

In the illustrated example, the set 264 includes a fixture 338 (see FIGS. 16 to 18) to hold the tubes 292 and 294 in viewing alignment with its respective optical sensor 334 and 336. The fixture 338 gathers the tubes 292 and 294 in a compact, organized, side-by-side array, to be placed and removed as a group in association with the optical sensors 334 and 336, which are also arranged in a compact, side-by-side relationship within the station 332.

In the illustrated example, the fixture 338 also holds the tube 290, which conveys whole blood into the centrifuge station 20, even though no associated sensor is provided. The fixture 338 serves to gather and hold all the tubes 290, 292, and 294 that are coupled to the umbilicus 296 in a compact and easily handled bundle.

The fixture 338 can be an integral part of the umbilicus 296, formed, e.g., by over molding. Alternatively, the fixture 338 can be a separately fabricated part, which snap fits about the tubes 290, 292, and 294 for use.

In the illustrated example (as FIG. 2 shows), the containers 304, 308, and 312 coupled to the cassette 28 are suspended during use above the centrifugation station 20. In this arrangement, the fixture 338 directs the tubes 290, 292, and 294 through an abrupt, ninety degree bend immediately beyond the end of the umbilicus 296 to the cassette 28. The bend imposed by the fixture 338 directs the tubes 290, 292, and 294 in tandem away from the area immediately beneath the containers 304, 308, and 312, thereby preventing clutter in this area. The presence of the fixture 338 to support and guide the tubes 290, 292, and 294 through the bend also reduces the risk of kinking or entanglement.

The first optical sensor 334 is capable of detecting the presence of optically targeted cellular species or components in the tube 292 (e.g., the plasma collection tube). The components that are optically targeted for detection vary depending upon the procedure.

For a plasma collection procedure, the first optical sensor 334 detects the presence of platelets in the tube 292 (e.g., the plasma collection tube), so that control measures can be initiated to move the interface between the plasma and platelet cell layer back into the processing chamber 18. This provides a plasma product that can be essentially platelet-free or at least in which the number of platelets is minimized.

For a red blood cell-only collection procedure, the first optical sensor 334 detects the interface between the buffy coat and the red blood cell layer, so that control measures can be initiated to move this interface back into the processing chamber 18. This maximizes the red blood cell yield.

For a buffy coat collection procedure (which will be described later), the first optical sensor 334 detects when the leading edge of the buffy coat (i.e., the plasma/platelet interface) begins to exit the processing chamber 18, as well as detects when the trailing edge of the buffy coat (i.e., the buffy coat/red blood cell interface) has completely exited the processing chamber 18.

The presence of these cellular components in the plasma, as detected by the first optical sensor 334, indicates that the interface is close enough to the low-G wall of the processing chamber 18 to allow all or some of these components to be swept into the plasma collection line (see FIG. 15B). This condition will also be called an “overspill.”

The second optical sensor 336 is capable of detecting the hematocrit of the red blood cells in the tube 294 (e.g., red blood cell collection tube). The decrease of red blood hematocrit below a set minimum level during processing indicates that the interface is close enough to the high-G wall of the processing chamber 18 to allow plasma to enter the tube 294 (e.g., red blood cell collection) (see FIG. 15C). This condition will also be called an “underspill.”

### B. The Sensing Circuit

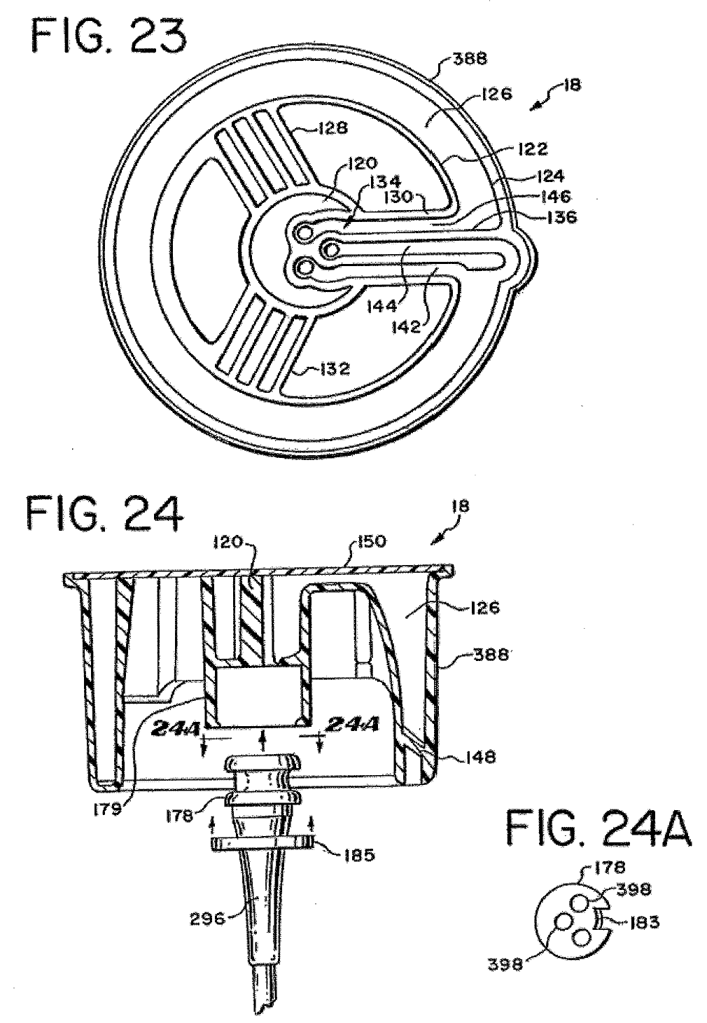

The sensing station 332 includes a sensing circuit 340 (see FIG. 19), of which the first optical sensor 334 and second optical sensor 336 form a part.

The first optical sensor 334 includes a green light emitting diode (LED) 350, a red LED 352, and first and second photodiodes 354 and 355. The first photodiode 354 measures transmitted light, and the second photodiode 355 measures reflected light.

The second optical sensor 336 includes one red LED 356 and third and fourth photodiodes 358 and 360. The third photodiode 358 measures transmitted light, and the fourth photodiode 360 measures reflected light.

The sensing circuit 340 further includes an LED driver component 342. The LED driver component 342 includes a constant current source 344, coupled to the LEDs 350, 352, and 356 of the optical sensors 334 and 336. The constant current source 344 supplies a constant current to each of the LEDs 350, 352, and 356, independent of temperature and the power supply voltage levels. The constant current source 344 thereby provides a constant output intensity for each of the LEDs 350, 352, and 356.

The LED driver component 342 includes a modulator 346. The modulator 346 modulates the constant current at a prescribed frequency. The modulator 346 removes the effects of ambient light and electromagnetic interference (EMI) from the optically sensed reading, as will be described in greater detail later.

The sensing circuit 340 also includes a receiver circuit 348 coupled to the photodiodes 354, 355, 358, and 360. The receiver circuit 348 includes, for each photodiode 354, 355, 358, and 360, a dedicated current-to-voltage (I-V) converter 362. The remainder of the receiver circuit 348 includes a bandpass filter 364, a programmable amplifier 366, and a full wave rectifier 368. These components 364, 366, and 368 are shared, e.g., using a multiplexer.

Ambient light typically contains frequency components less than 1000 Hz, and EMI typically contains frequency components above 2 Khz. With this in mind, the modulator 346 modulates the current at a frequency below the EMI frequency components, e.g., at about 2 Khz. The bandpass filter 364 has a center frequency of about the same value, i.e., about 2 Khz. The sensing circuit 340 eliminates frequency components above and below the ambient light source and EMI components from the sensed measurement. In this way, the sensing circuit 340 is not sensitive to ambient lighting conditions and EMI.

More particularly, transmitted or reflected light from the tube 292 or 294 containing the fluid to be measured is incident on the first and second photodiodes 354 and 355 (for the tube 292) or the third and fourth photodiodes 358 and 360 (for the tube 294). Each photodiode produces a photocurrent proportional to the received light intensity. This current is converted to a voltage. The voltage is fed, via a multiplexer 370, to the bandpass filter 364. The bandpass filter 364 has a center frequency at the carrier frequency of the modulated source light (i.e., 2 Khz in the illustrated example).

The sinusoidal output of the bandpass filter 364 is sent to the programmable amplifier 366 (e.g., variable gain amplifier). The gain of the amplifier is preprogrammed in preestablished steps, e.g., X1, X10, X100, and X1000. This provides the amplifier with the capability to respond to a large dynamic range.

The sinusoidal output of the programmable amplifier 366 is sent to the full wave rectifier 368, which transforms the sinusoidal output to a DC output voltage proportional to the transmitted light energy.

The controller 16 generates timing pulses for the sensing circuit 340. The timing pulses comprise, for each LED, (i) a modulation square wave at the desired modulation frequency (i.e., 2 Khz in the illustrated example), (ii) an enable signal, (iii) two sensor select bits (which select the sensor output to feed to the bandpass filter 364), and (iv) two bits for the receiver circuit gain selection (for the programmable amplifier 366).

The controller 16 conditions the LED driver component 342 to operate each LED in an ON state and an OFF state.

In the ON state, the LED enable is set HIGH, and the LED is illuminated for a set time interval, e.g., 100 ms. During the first 83.3 ms of the ON state, the finite rise time for the incident photodiode and the receiver circuit 348 are allowed to stabilize. During the final 16.7 ms of the ON state, the output of the sensing circuit 340 is sampled at twice the modulation rate (i.e., 4 Khz in the illustrated example). The sampling interval is selected to comprise one complete cycle of 60 Hz, allowing the main frequency to be filtered from the measurement. The 4 Khz sampling frequency allows the 2 Khz ripple to be captured for later removal from the measurement.

During the OFF state, the LED is left dark for 100 ms. The LED baseline due to ambient light and electromagnetic interference is recorded during the final 16.7 ms.

### 1. The First Sensor

### Platelet/RBC Differentiation

In general, cell free (“free”) plasma has a straw color. As the concentration of platelets in the plasma increases, the clarity of the plasma decreases. The plasma looks “cloudy.” As the concentration of red blood cells in the plasma increases, the plasma color turns from straw to red.

The sensing circuit 340 includes a detection/differentiation module 372, which analyzes sensed attenuations of light at two different wavelengths from the first optical sensor 334 (using the transmitted light sensing the first photodiode 354). The different wavelengths are selected to possess generally the same optical attenuation for platelets, but significantly different optical attenuations for red blood cells.

In the illustrated example, the first optical sensor 334 includes the green LED 350 (e.g., emitter) of light at a first wavelength (λ₁), which, in the illustrated example, is green light (570 nm and 571 nm). The first optical sensor 334 also includes the red LED 352 (e.g., emitter) of light at a second wavelength (λ₂), which, in the illustrated example, is red light (645 nm to 660 nm).

The optical attenuation for platelets at the first wavelength (εₚₗₐₜₑₗₑₜₛ_{^{λ}}₁) and the optical attenuation for platelets at the second wavelength (εₚₗₐₜₑₗₑₜₛ_{^{λ}}₂) are generally the same. Thus, changes in attenuation over time, as affected by increases or decreases in platelet concentration, will be similar.

However, the optical attenuation for hemoglobin at the first wavelength (ε_{Hb}_{^{λ}}₁) is about ten times greater than the optical attenuation for hemoglobin at the second wavelength (ε_{Hb}_{^{λ}}₂). Thus, changes in attenuation over time, as affected by the presence of red blood cells, will not be similar.

The tube 292, through which plasma is to be sensed, is transparent to light at the first and second wavelengths. The tube 292 conveys the plasma flow past the LEDs 350 and 352 (e.g., emitters).

The first photodiode 354 receives light emitted by the LEDs 350 and 352 (e.g., through the tube 292. The first photodiode 354 generates signals proportional to intensities of received light. The intensities vary with optical attenuation caused by the presence of platelets and/or red blood cells.

The detection/differentiation module 372 is coupled to the first photodiode 354 to analyze the signals to derive intensities of the received light at the first and second wavelengths. The detection/differentiation module 372 compares changes of the intensities of the first and second wavelengths over time. When the intensities of the first and second wavelengths change over time in substantially the same manner, the detection/differentiation module 372 generates an output representing presence of platelets in the plasma flow. When the intensities of the first and second wavelengths change over time in a substantially different manner, the detection/differentiation module 372 generates an output representing presence of red blood cells in the plasma flow. The outputs therefore differentiate between changes in intensity attributable to changes in platelet concentration in the plasma flow and changes in intensity attributable to changes in red blood cell concentration in the plasma flow.

There are various ways to implement the detection/differentiation module 372. In one example, the detection/differentiation module 372 considers that the attenuation of a beam of monochromatic light of wavelength λ by a plasma solution can be described by the modified Lambert-Beer law, as follows:

I=I_{O}e^{-[(ε}^{_{Hb}}^{^{λ}}^{C}^{^{Hb}}^{H+ε}^{ₚₗₐₜₑₗₑₜₛ}^{^{λ}}^{ε}^{ₚₗₐₜₑₗₑₜₛ}^{)d+G}^{ₚₗₐₜₑₗₑₜₛ}^{^{λ}}^{+G}^{_{RBC}}^{^{λ}}^{]} (1)

where:

I is transmitted light intensity.

I_{O} is incident light intensity.

ε_{Hb}_{^{λ}} is the optical attenuation of hemoglobin (Hb) (gm/dl) at the applied wavelength.

εₚₗₐₜₑₗₑₜₛ_{^{λ}} is the optical attenuation of platelets at the applied wavelength.

C_{Hb} is the concentration of hemoglobin in a red blood cell, taken to be 34 gm/dl.

Cₚₗₐₜₑₗₑₜₛ is the concentration of platelets in the sample.

d is the thickness of the plasma stream through the tube 294.

G^{λ} is the path length factor at the applied wavelength, which accounts for additional photon path length in the plasma sample due to light scattering.

H is whole blood hematocrit, which is percentage of red blood cells in the sample.

G_{RBC}_{^{λ}} and Gₚₗₐₜₑₗₑₜₛ_{^{λ}} are a function of the concentration and scattering coefficients of, respectively, red blood cells and platelets at the applied wavelengths, as well as the measurement geometry.

For wavelengths in the visible and near infrared spectrum, εₚₗₐₜₑₗₑₜₛ_{^{λ}}≈0, therefore:

$$Ln ( \frac{{I}^{λ}}{{I}_{o}^{λ}} ) = Ln ( {T}^{λ} ) \approx - [ ( {ɛ}_{Hb}^{λ} {C}_{Hb} H ) d + {G}_{platelets}^{λ} + {G}_{RBC}^{λ} ] \qquad ( 2 )$$

In an overspill condition (shown in FIG. 15B), the first cellular component to be detected by the first optical sensor 334 in the tube 292 (e.g., plasma collection tube) will be platelets. Therefore, for the detection of platelets, Ln(T^{λ})≈Gₚₗₐₜₑₗₑₜₛ_{^{λ}}.

To detect the buffy coat interface between the platelet layer and the red blood cell layer, the two wavelengths (λ₁ and λ₂) are chosen based upon the criteria that (i) λ₁ and λ₂ have approximately the same path length factor (G^{λ}), and (ii) one wavelength λ₁ or λ₂ has a much greater optical attenuation for hemoglobin than the other wavelength.

Assuming the wavelengths λ₁ and λ₂ have the same G^{λ}, Equation (2) reduces to:

$$Ln ( {T}^{{λ}_{1}} ) - Ln ( {T}^{{λ}_{2}} ) \approx {Hdc}_{Hb} ( {ɛ}_{Hb}^{{λ}_{2}} - {ɛ}_{Hb}^{{λ}_{1}} ) \qquad ( 3 )$$

In one example, λ₁=660 nm (green) and λ₂=571 nm (red). The path length factor (G^{λ}) for 571 nm light is greater than for 660 nm light. Therefore the path length factors have to be modified by coefficients α and β, as follows:

G_{RBC}^{λ}^{₁}=αG_{RBC}^{λ}^{₂}

Gₚₗₐₜₑₗₑₜₛ^{λ}^{₁}=βGₚₗₐₜₑₗₑₜₛ^{λ}^{₂}

Therefore, Equation (3) can be reexpressed as follows:

$$Ln ( {T}^{{λ}_{1}} ) - Ln ( {T}^{{λ}_{2}} ) \approx {Hdc}_{Hb} ( {ɛ}_{Hb}^{{λ}_{2}} - {ɛ}_{Hb}^{{λ}_{1}} ) + ( α - 1 ) {G}_{RBC}^{{λ}_{1}} + ( β - 1 ) {G}_{platelets}^{{λ}_{2}} \qquad ( 4 )$$

In the absence of red blood cells, Equation (3) causes a false red blood cell detect with increasing platelet concentrations, as Equation (5) demonstrates:

$$Ln ( {T}^{{λ}_{1}} ) - Ln ( {T}^{{λ}_{2}} ) = ( β - 1 ) {G}_{platelets}^{{λ}_{2}} \qquad ( 5 )$$

For the detection of platelets and the interface between the platelet/red blood cell layer, Equation (4) provides a better resolution. The detection/differentiation module 372 therefore applies Equation (4). The coefficient (β−1) can be determined by empirically measuring Gₚₗₐₜₑₗₑₜₛ^{λ1} and Gₚₗₐₜₑₗₑₜₛ^{λ2} in the desired measurement geometry for different known concentrations of platelets in prepared platelet-spiked plasma.

The detection/differentiation module 372 also differentiates between intensity changes due to the presence of red blood cells in the plasma or the presence of free hemoglobin in the plasma due to hemolysis. Both circumstances will cause a decrease in the output of the first photodiode 354 (e.g., transmitted light sensing photodiode). However, the output of the second photodiode 355 (e.g., reflected light sensing photodiode) increases in the presence of red blood cells and decreases in the presence of free hemoglobin. The detection/differentiation module 372 thus senses the undesired occurrence of hemolysis during blood processing, so that the operator can be alerted and corrective action can be taken.

### 2. The Second Sensor

### Packed Red Blood Cell Measurement

In an underspill condition (shown in FIG. 15C), the hematocrit of red blood cells exiting the processing chamber 18 will dramatically decrease, e.g., from a targeted hematocrit of about 80 to a hematocrit of about 50, as plasma (and the buffy coat) mixes with the red blood cells. An underspill condition is desirable during a plasma collection procedure, as it allows the return of the buffy coat to the donor with the red blood cells. An underspill condition is not desired during a red blood cell-only collection procedure, as it jeopardizes the yield and quality of red blood cells that are collected for storage.

In either situation, the ability to sense when an underspill condition exists is desirable.

Photon wavelengths in the near infrared spectrum (NIR) (approximately 540 nm to 1000 nm) are suitable for sensing red blood cells, as their intensity can be measured after transmission through many millimeters of blood.

The sensing circuit 340 includes a red blood cell detection module 374. The red blood cell detection module 374 analyzes sensed optical transmissions of the second optical sensor 336 to discern the hematocrit and changes in the hematocrit of red blood cells exiting the processing chamber 18.

The red blood cell detection module 374 considers that the attenuation of a beam of monochromatic light of wavelength λ by blood may be described by the modified Lambert-Beer law, as follows:

I=I_{O}e^{-[(ε}^{_{Hb}}^{^{λ}}^{ε}^{_{Hb}}^{H)d+G}^{_{RBC}}^{^{λ}}^{]} (6)

where:

I is transmitted light intensity.

I_{O} is incident light intensity.

ε_{Hb}^{λ} is the extinction coefficient of hemoglobin (Hb) (gm/dl) at the applied wavelength.

C_{Hb} is the concentration of hemoglobin in a red blood cell, taken to be 34 gm/dl.

d is the distance between the light source and light detector.

G^{λ} is the path length factor at the applied wavelength, which accounts for additional photon path length in the media due to light scattering.

H is whole blood hematocrit, which is percentage of red blood cells in the sample.

G_{RBC}^{λ} is a function of the hematocrit and scattering coefficients of red blood cells at the applied wavelengths, as well as the measurement geometry.

Given Equation (6), the optical density O.D. of the sample can be expressed as follows:

Ln (I^{λ}/I_{O}^{λ})=O.D.=−[(ε_{Hb}^{λ}C_{Hb}H)d+G_{RBC}^{λ}] (7)

The optical density of the sample can further be expressed as follows:

O.D.=O.D._{Absorption}+O.D._{Scattering} (8)

where:

O.D._{Absorption} is the optical density due to absorption by red blood cells, expressed as follows:

O.D._{Absorption}=−(ε_{Hb}^{λ}C_{Hb}H)d (9)

O.D._{Scattering} is the optical density due to scattering of red blood cells, expressed as follows:

O.D._{Scattering}=−G_{RBC}^{λ} (10)

From Equation (9), O.D._{Absorption} increases linearly with hematocrit (H). For transmittance measurements in the red and NIR spectrum, G_{RBC}^{λ} is generally parabolic, reaching a maximum at a hematocrit of between 50 and 75 (depending on illumination wavelength and measurement geometry) and is zero at hematocrits of 0 and 100 (see, e.g., Steinke et al., “Diffusion Model of the Optical Absorbance of Whole Blood,” J. Opt. Soc. Am., Vol 5, No. 6, June 1988). Therefore, for light transmission measurements, the measured optical density is a nonlinear function of hematocrit.

Nevertheless, it has been discovered that G_{RBC}^{λ} for reflected light measured at a predetermined radial distance from the incident light source is observed to remain linear for the hematocrit range of at least 10 to 90. Thus, with the second optical sensor 336 so configured, the detection module can treat the optical density of the sample for the reflected light to be a linear function of hematocrit. The same relationship exists for the first optical sensor 334 with respect to the detection of red blood cells in plasma.

This arrangement relies upon maintaining straightforward measurement geometries. No mirrors or focusing lenses are required. The LED or photodiode need not be positioned at an exact angle with respect to the blood flow tube. No special optical cuvettes are required. The second optical sensor 336 can interface directly with the tube 294 (e.g., transparent tube). Similarly, the first optical sensor 334 can interface directly with the tube 292 (e.g., transparent tube).

In the illustrated example, the wavelength 805 nm is selected, as it is an isosbestic wavelength for red blood cells, meaning that light absorption by the red blood cells at this wavelength is independent of oxygen saturation. Still, other wavelengths can be selected within the NIR spectrum.

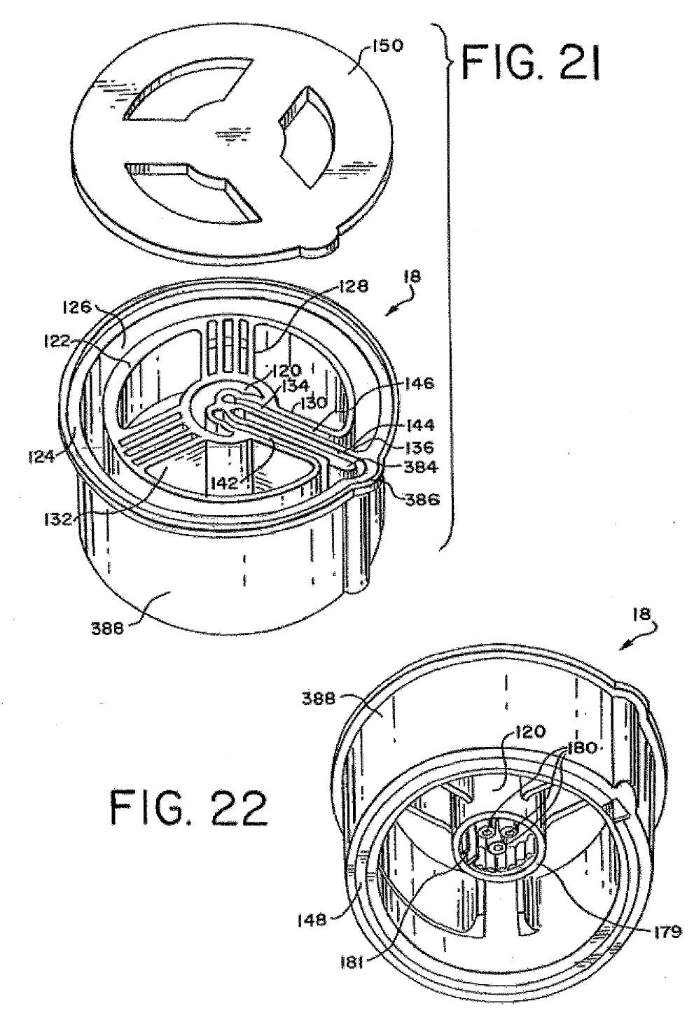

In the illustrated example, for a wavelength of 805 nm, the set distance may be 7.5 mm from the light source. The fixture 338, above described (see FIG. 18), facilitates the placement of the tube 294 in the desired relation to the light source and the reflected light detector of the second optical sensor 336. The fixture 338 also facilitates the placement of the tube 292 in the desired relation to the light source and the reflected light detector of the first optical sensor 334.

Measurements at a distance greater than 7.5 mm can be made and will show a greater sensitivity to changes in the red blood cell hematocrit. However a lower signal to noise ratio will be encountered at these greater distances. Likewise, measurements at a distance closer to the light source will show a greater signal to noise ratio, but will be less sensitive to changes in the red blood cell hematocrit. The optimal distance for a given wavelength in which a linear relationship between hematocrit and sensed intensity exists for a given hematocrit range can be empirically determined.

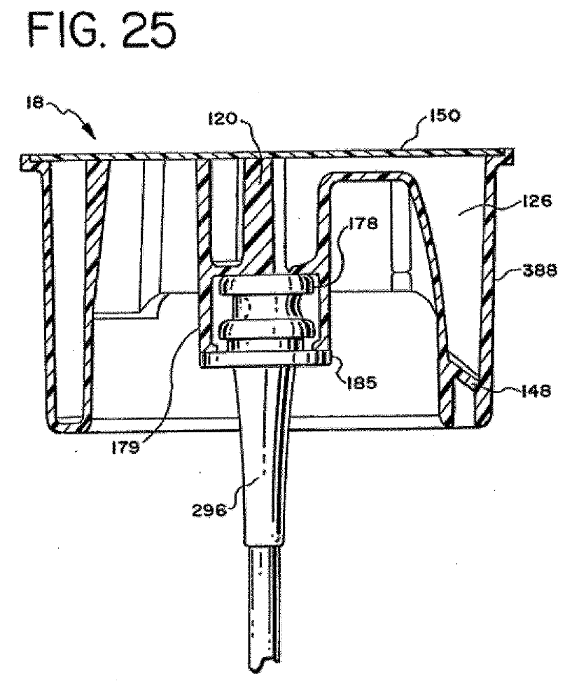

The second optical sensor 336 detects absolute differences in the mean transmitted light intensity of the signal transmitted through the red blood cells in the red blood cell collection line. The detection module analyzes these measured absolute differences in intensities, along with increases in the standard deviation of the measured intensities, to reliably signal an underspill condition, as FIG. 20 shows.

At a given absolute hematocrit, G_{RBC}^{λ} varies slightly from donor to donor, due to variations in the mean red blood cell volume and/or the refractive index difference between the plasma and red blood cells. Still, by measuring the reflected light from a sample of a given donor's blood having a known hematocrit, G_{RBC}^{λ} may be calibrated to yield, for that donor, an absolute measurement of the hematocrit of red blood cells exiting the processing chamber 18.

### C. Pre-Processing Calibration of the Sensors

The first and second optical sensors 334 and 336 are calibrated during the saline and blood prime phases of a given blood collection procedure, the details of which have already been described.

During the saline prime stage, saline is conveyed into the processing chamber 18 (e.g., blood processing chamber) and out through the tube 292 (e.g., the plasma collection tube). During this time, the processing chamber 18 is rotated in cycles between 0 RPM and 200 RPM, until air is purged from the chamber 18. The speed of rotation of the processing chamber 18 is then increased to full operational speed.

The blood prime stage follows, during which whole blood is introduced into the processing chamber 18 at the desired whole blood flow rate (Q_{WB}). The flow rate of plasma from the processing chamber 18 through the tube 292 (e.g., the plasma collection tube) is set at a fraction (e.g., 80%) of the desired plasma flow rate (Q_{P}) from the processing chamber 18, to purge saline from the chamber 18. The purge of saline continues under these conditions until the first optical sensor 334 optically senses the presence of saline in the tube 292 (e.g., plasma collection tube).

### 1. For Plasma Collection Procedures

### Induced Underspill

If the procedure to be performed collects plasma for storage (e.g., the Plasma Collection Procedure or the Red Blood Cell/Plasma Collection Procedure), an underspill condition is induced during calibration. The underspill condition is created by decreasing or stopping the flow of plasma through the tube 292 (e.g., plasma collection line). This forces the buffy coat away from the low-G side of the chamber 18 (as FIG. 15C) to assure that a flow of “clean” plasma exists in the tube 292 (e.g., the plasma collection line), free or essentially free of platelets and leukocytes. The induced underspill allows the first optical sensor 334 to be calibrated and normalized with respect to the physiologic color of the donor's plasma, taking into account the donor's background lipid level, but without the presence of platelets or leukocytes. The first optical sensor 334 thereby possesses maximum sensitivity to changes brought about by the presence of platelets or leukocytes in the buffy coat, should an overspill subsequently occur during processing.

Forcing an underspill condition also positions the interface close to the high-G wall at the outset of blood processing. This creates an initial offset condition on the high-G side of the chamber, to prolong the ultimate development of an overspill condition as blood processing proceeds.

### 2. Red Blood Cell Collection Procedures

If a procedure is to be performed in which no plasma is to be collected (e.g., the Double Unit Red Blood Cell Collection Procedure), an underspill condition is not induced during the blood purge phase. This is because, in a red blood cell only collection procedure, the first optical sensor 334 need only detect, during an overspill, the presence of red blood cells in the plasma. The first optical sensor 334 does not need to be further sensitized to detect platelets. Furthermore, in a red blood cell only collection procedure, it may be desirable to keep the interface as near the low-G wall as possible. The desired condition allows the buffy coat to be returned to the donor with the plasma and maximizes the hematocrit of the red blood cells collected.

### D. Blood Cell Collection

### 1. Plasma Collection Procedures

In procedures where plasma is collected (e.g., the Plasma Collection Procedure or the Red Blood Cell/Plasma Collection Procedure), Q_{P} is set at Q_{P(Ideal)}, which is an empirically determined plasma flow rate that allows the system to maintain a steady state collection condition, with no underspills and no overspills.

Q_{P(Ideal)} (in grams/ml) is a function of the anticoagulated whole blood inlet flow rate Q_{WB}, the anticoagulant whole blood inlet hematocrit HCT_{WB}, and the red blood cell exit hematocrit HCT_{RBC} (as estimated or measured), expressed as follows:

$${Q}_{P ( Ideal )} = ( {ρ}_{Plasma} {Q}_{WB} * \frac{( 1 - {HCT}_{\text{?}} ) \text{?} ( 1 - {HCT}_{\text{?}} ) \text{?}}{( 1 - \text{?} ) ( \text{?} {HCT}_{\text{?}} )} \\ \text{?} \text{indicates text missing or illegible when filed}$$

where:

ρ_{Plasma} is the density of plasma (in g/ml)=1.03

ρ_{WB} is the density of whole blood (in g/ml)=1.05

ρ_{RBC} is the density of red blood cells=1.08

Q_{WB} is set to the desired whole blood inlet flow rate for plasma collection, which, for a plasma only collection procedure, is generally about 70 ml/min. For a red blood cell/plasma collection procedure, Q_{WB} is set at about 50 ml/min, thereby providing packed red blood cells with a higher hematocrit than in a traditional plasma collection procedure.

The controller 16 maintains the pump settings until the desired plasma collection volume is achieved, unless an underspill condition or an overspill condition is detected.

If set Q_{P} is too high for the actual blood separation conditions, or, if due to the physiology of the donor, the buffy coat volume is larger (i.e., “thicker”) than expected, the first optical sensor 334 will detect the presence of platelets or leukocytes, or both in the plasma, indicating an overspill condition.

In response to an overspill condition caused by a high Q_{P}, the controller 16 terminates operation of the plasma collection pump PP2, while keeping set Q_{WB} unchanged. In response to an overspill condition caused by a high volume buffy coat, the controller 16 terminates operation of the plasma collection pump PP2, until an underspill condition is detected by the second optical sensor 336 (e.g., the red blood cell sensor). This serves to expel the buffy coat layer from the processing chamber 18 (e.g., separation chamber) through the tube 294 (e.g., the red blood cell tube).

To carry out the overspill response, the blood processing circuit 46 is programmed to operate the in-process pump PP1 (i.e., drawing in through the valve V9 and expelling out of the in-line valve V14), to draw whole blood from the in-process container 312 into the processing chamber 18 at the set Q_{WB}. Red blood cells exit the chamber 18 through the tube 294 for collection in the collection container 308. The flow rate of red blood cells directly depends upon the magnitude of Q_{WB}.

During this time, the blood processing circuit 46 is also programmed to cease operation of the plasma pump PP2 for a preestablished time period (e.g., 20 seconds). This forces the interface back toward the middle of the processing chamber 18 (e.g., separation chamber). After the preestablished time period, the operation of the plasma pump PP2 is resumed, but at a low flow rate (e.g., 10 ml/min) for a short time period (e.g., 10 seconds). If the spill has been corrected, clean plasma will be detected by the first optical sensor 334, and normal operation of the blood processing circuit 46 is resumed. If clean plasma is not sensed, indicating that the overspill has not been corrected, the blood processing circuit 46 repeats the above-described sequence.

The programming of the circuit to relieve an overspill condition is summarized in the following table.

TABLE
Programming of Blood Processing Circuit To Relieve An
Overspill Condition (Plasma Collection Procedures)

| | |
|---|---|
| V1 | |
| V2 | ∘ |
| V3 | |
| V4 | |
| V5 | ∘ |
| V6 | |
| V7 | |
| V8 | |
| V9 | /∘ Pump In |
| V10 | |
| V11 | |
| V12 | |
| V13 | |
| V14 | /∘ Pump Out |
| V15 | |
| V16 | |
| V17 | |
| V18 | |
| V19 | |
| V20 | |
| V21 | |
| V22 | |
| V23 | |
| PP1 | □ |
| PP2 | ▪ |
| PP3 | ▪ |
| PP4 | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

Upon correction of an overspill condition, the controller 16 returns the blood processing circuit 46 to resume normal blood processing, but applies a percent reduction factor (% RF) to the Q_{P} set at the time the overspill condition was initially sensed. The reduction factor (% RF) is a function of the time between overspills, i.e., % RF increases as the frequency of overspills increases, and vice versa.

If set Q_{P} is too low, the second optical sensor 336 will detect a decrease in the red blood cell hematocrit below a set level, which indicates an underspill condition.

In response to an underspill condition, the controller 16 resets Q_{P} close to the set Q_{WB}. As processing continues, the interface will, in time, move back toward the low-G wall. The controller 16 maintains these settings until the second optical sensor 336 detects a red blood cell hematocrit above the desired set level. At this time, the controller 16 applies a percent enlargement factor (% EF) to the Q_{P} set at the time the underspill condition was initially sensed. The enlargement factor (% EF) is a function of the time between underspills, i.e., % EF increases as the frequency of underspills increases.

Should the controller 16 be unable to correct a given under- or overspill condition after multiple attempts (e.g., three attempts), an alarm is commanded.

### 2. Red Blood Cell Only Collection Procedures

In procedures where only red blood cells and no plasma is collected (e.g., the Double Unit Red Blood Cell Collection Procedure), Q_{P} is set to no greater than Q_{P(Ideal)}, and Q_{WB} is set to the desired whole blood inlet flow rate into the processing chamber 18 for the procedure, which is generally about 50 ml/min for a double unit red blood cell collection procedure.

It may be desired during a double unit red blood cell collection procedure that overspills occur frequently. This maximizes the hematocrit of the red blood cells for collection and returns the buffy coat to the donor with the plasma. Q_{P} is increased over time if overspills occur at less than a set frequency. Likewise, Q_{P} is decreased over time if overspills occur above the set frequency. However, to avoid an undesirably high hematocrit, it may be just as desirable to operate at Q_{P(Ideal)}.

The controller 16 controls the pump settings in this way until the desired red blood cell collection volume is achieved, taking care of underspills or overspills as they occur.

The first optical sensor 334 detects an overspill by the presence of red blood cells in the plasma. In response to an overspill condition, the controller 16 terminates operation of the plasma collection pump to draw plasma from the processing chamber 18, while keeping the set Q_{WB} unchanged.

To implement the overspill response, the blood processing circuit 46 is programmed (through the selective application of pressure to the valves and pump stations) to operate the plasma pump PP2 and in-process pump PP1 in the manner set forth in the immediately preceding Table. The red blood cells detected in the tube 292 are thereby returned to the processing chamber 18, and are thereby prevented from entering the plasma collection container 304.

The interface will, in time, move back toward the high-G wall. The controller 16 maintains these settings until the second optical sensor 336 detects a decrease in the red blood cell hematocrit below a set level, which indicates an underspill condition.

In response to an underspill condition, the controller 16 increases Q_{P} until the second optical sensor 336 detects a red blood cell hematocrit above the desired set level. At this time, the controller 16 resets Q_{P} to the value at the time the most recent overspill condition was sensed.

### 3. Buffy Coat Collection

If desired, an overspill condition can be periodically induced during a given plasma collection procedure to collect the buffy coat in a buffy coat collection container 376 (see FIG. 10). As FIG. 10 shows, in the illustrated example, the buffy coat collection container 376 is coupled by tubing 378 to the buffy port P4 of the cassette 28. The buffy coat collection container 376 is suspended on a weigh scale 246, which provides output reflecting weight changes over time, from which the controller 16 derives the volume of buffy coat collected.

In this arrangement, when the induced overspill condition is detected, the blood processing circuit 46 is programmed (through the selective application of pressure to the valves and pump stations) to operate the plasma pump PP2 (i.e., drawing in through the in-line valve V12 and expelling out through the in-line valve V10), to draw plasma from the processing chamber 18 through the tubing 378, while valves V4 and V6 are closed and valve V8 is opened. The buffy coat in the tubing 378 is conveyed into the buffy coat collection container 376. The blood processing circuit 46 is also programmed during this time to operate the in-process pump PP1 (i.e., drawing in through the valve V9 and expelling out of the in-line valve V14), to draw whole blood from the in-process container 312 into the processing chamber 18 at the set Q_{WB}. Red blood cells exit the chamber 18 through the tube 294 for collection in the collection container 308.

The programming of the circuit to relieve an overspill condition by collecting the buffy coat in the buffy coat collection container 376 is summarized in the following table.

TABLE
Programming of Blood Processing Circuit To Relieve An Overspill
Condition by Collecting the Buffy Coat
(Plasma Collection Procedures)

| | |
|---|---|
| V1 | |
| V2 | |
| V3 | |
| V4 | ∘ |
| V5 | |
| V6 | |
| V7 | |
| V8 | |
| V9 | /∘ Pump In |
| V10 | /∘ Pump Out |
| V11 | |
| V12 | /∘ Pump In |
| V13 | |
| V14 | /∘ Pump Out |
| V15 | |
| V16 | |
| V17 | |
| V18 | |
| V19 | |
| V20 | |
| V21 | |
| V22 | |
| V23 | |
| PP1 | □ |
| PP2 | □ |
| PP3 | ▪ |
| PP4 | ▪ |

Caption:
∘ denotes an open valve;
 denotes a closed valve;
∘/ denotes a valve opening and closing during a pumping sequence;
▪ denotes an idle pump station (not in use); and
□ denotes a pump station in use.

After a prescribed volume of buffy coat is conveyed into the buffy coat collection container 376 (as monitored by the weigh scale 246), normal blood processing conditions are resumed. Overspill conditions causing the movement of the buffy coat into the tubing 378 can be induced at prescribed intervals during the process period, until a desired buffy coat volume is collected in the buffy coat collection container.

### VI. Another Programmable Blood Processing Circuit

### A. Circuit Schematic

As previously mentioned, various configurations for the programmable blood processing circuit 46 are possible. FIG. 5 schematically shows one representative configuration 46, the programmable features of which have been described. FIG. 34 shows another representative configuration of a blood processing circuit or circuit 46′ having comparable programmable features.

Like the circuit 46, the circuit 46′ includes several pump stations PP(N), which are interconnected by a pattern of fluid flow paths F(N) through an array of in-line valves V(N). The circuit is coupled to the remainder of the blood processing set by ports P(N).

The circuit 46′ includes a programmable network of flow paths F1 to F33. The circuit 46′ includes eleven of the universal ports P1 to P8 and P11 to P13 and four universal pump stations PP1, PP2, PP3, and PP4. By selective operation of the in-line valves V1 to V21 and V23 to V25, any of the universal port P1 to P8 and P11 to P13 can be placed in flow communication with any universal pump station PP1, PP2, PP3, and PP4. By selective operation of the universal valves, fluid flow can be directed through any universal pump station in a forward direction or reverse direction between two valves, or an in-out direction through a single valve.

In the illustrated example, the circuit 46′ also includes an isolated flow path (comprising flow paths F9, F23, F24, and F10) with two of the universal ports P9 and P10 and one in-line pump station PP5. The flow path is termed “isolated,” because it cannot be placed into direct flow communication with any other flow path in the circuit 46′ without exterior tubing. By selective operation of the in-line valves V21 and V22, fluid flow can be directed through the pump station PP5 in a forward direction or reverse direction between two valves, or an in-out direction through a single valve.

Like circuit 46, the circuit 46′ can be programmed to assigned dedicated pumping functions to the various pump stations. In one example, the universal pump stations PP3 and PP4 in tandem serve as a general purpose, donor interface pump, regardless of the particular blood procedure performed. The dual donor interface pump stations PP3 and PP4 in the circuit 46′ work in parallel. One pump station draws fluid into its pump chamber, while the other pump station expels fluid from its pump chamber. The pump station PP3 and PP4 alternate draw and expel functions.

In one arrangement, the draw cycle for the drawing pump station is timed to be longer than the expel cycle for the expelling pump station. This provides a continuous flow of fluid on the inlet side of the pump stations and a pulsatile flow in the outlet side of the pump stations. In one representative example, the draw cycle is ten seconds, and the expel cycle is one second. The expelling pump station performs its one second cycle at the beginning of the draw cycle of the drawing pump, and then rests for the remaining nine seconds of the draw cycle. The pump stations then switch draw and expel functions. This creates a continuous inlet flow and a pulsatile outlet flow. The provision of two alternating pump stations PP3 and PP4 serves to reduce overall processing time, as fluid is continuously conducted into a drawing pump station throughout the procedure.

In this arrangement, the isolated pump station PP5 of the circuit 46′ serves as a dedicated anticoagulant pump, like pump station PP4 in the circuit 46, to draw anticoagulant from a source through the universal port P10 and to meter anticoagulant into the blood through port P9.

In this arrangement, as in the circuit 46, the universal pump station PP1 serves, regardless of the particular blood processing procedure performed, as a dedicated in-process whole blood pump, to convey whole blood into the blood separator 18′. As in the circuit 46, the dedicated function of the pump station PP1 frees the donor interface pumps PP3 and PP4 from the added function of supplying whole blood to the blood separator 18′. Thus, the in-process whole blood pump PP1 can maintain a continuous supply of blood to the blood separator 18′, while the donor interface pumps PP3 and PP4 operate in tandem to simultaneously draw and return blood to the donor through the single phlebotomy needle. The circuit 46′ thus minimizes processing time.

In this arrangement, as in circuit 46, the universal pump station PP2 of the circuit 46′ serves, regardless of the particular blood processing procedure performed, as a plasma pump, to convey plasma from the blood separator 18′. As in the circuit 46, the ability to dedicate separate pumping functions in the circuit 46′ provides a continuous flow of blood into and out of the separator, as well as to and from the donor.

The circuit 46′ can be programmed to perform all the different procedures described above for the circuit 46. Depending upon the objectives of the particular blood processing procedure, the circuit 46′ can be programmed to retain all or some of the plasma for storage or fractionation purposes, or to return all or some of the plasma to the donor. The circuit 46′ can be further programmed, depending upon the objectives of the particular blood processing procedure, to retain all or some of the red blood cells for storage, or to return all or some of the red blood cells to the donor. The circuit 46′ can also be programmed, depending upon the objectives of the particular blood processing procedure, to retain all or some of the buffy coat for storage, or to return all or some of the buffy coat to the donor.

In the example illustrated in FIG. 34, the circuit 46′ forms a part of a universal set 264′, which is coupled to the universal ports P1 to P13.

More particularly, a donor tube 266′, with attached phlebotomy needle 268′ is coupled to the port P8 of the circuit 46′. An anticoagulant tube 270′, coupled to the phlebotomy needle 268′ is coupled to port P9. A container 276′ holding anticoagulant is coupled via a tube 274′ to the universal port P10.

A container 280′ holding a red blood cell additive solution is coupled via a tube 278′ to the universal port P11. A container 288′ holding saline is coupled via a tube 284′ to the universal port P12. A storage container 289′ is coupled via a tube 291′ to the universal port P13. An in-line leukocyte depletion filter or filter 293′ is carried by the tube 291′ between the universal port P13 and the storage container 289′. The containers 276′, 280′, 288′, and 289′ can be integrally attached to the ports or can be attached at the time of use through a suitable sterile connection, to thereby maintain a sterile, closed blood processing environment.

First, second and third tubes 290′, 292′, and 294′ extend to an umbilicus 296′ which is coupled to a processing chamber or blood separator 18′. The tubes 290′, 292′, and 294 are coupled, respectively, to the ports P5, P6, and P7. The first tube 290′ conveys whole blood into the processing chamber 18′ under the operation of the in-process pump station PP1. The second tube 292′ conveys plasma from the processing chamber 18′ under the operation of the plasma pump chamber PP2. The third tube 294′ conveys red blood cells from the processing chamber 18′.

A plasma collection container or collection container 304′ is coupled by a tube 302′ to the port P3. The collection container 304′ is intended, in use, to serve as a reservoir for plasma during processing.

A red blood cell collection container or collection container 308′ is coupled by a tube 306′ to the port P2. The collection container 308′ is intended, in use, to receive a unit of red blood cells for storage.

A buffy coat collection container 376′ is coupled by a tube 377′ to the port P4. The buffy coat collection container 376′ is intended, in use, to receive a volume of buffy coat for storage.

A whole blood reservoir or collection container 312′ is coupled by a tube 310′ to the universal port P1. The collection container 312′ is intended, in use, to receive whole blood during operation of the donor interface pumps PP3 and PP4, to serve as a reservoir for whole blood during processing. It can also serve to receive a second unit of red blood cells for storage.

### B. The Cassette

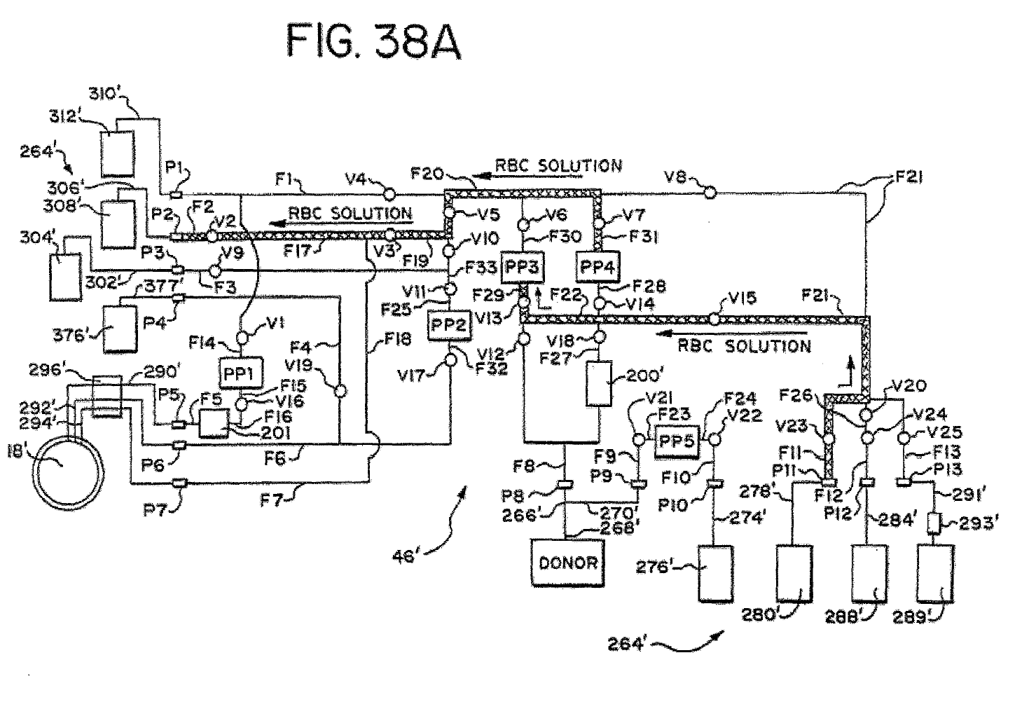

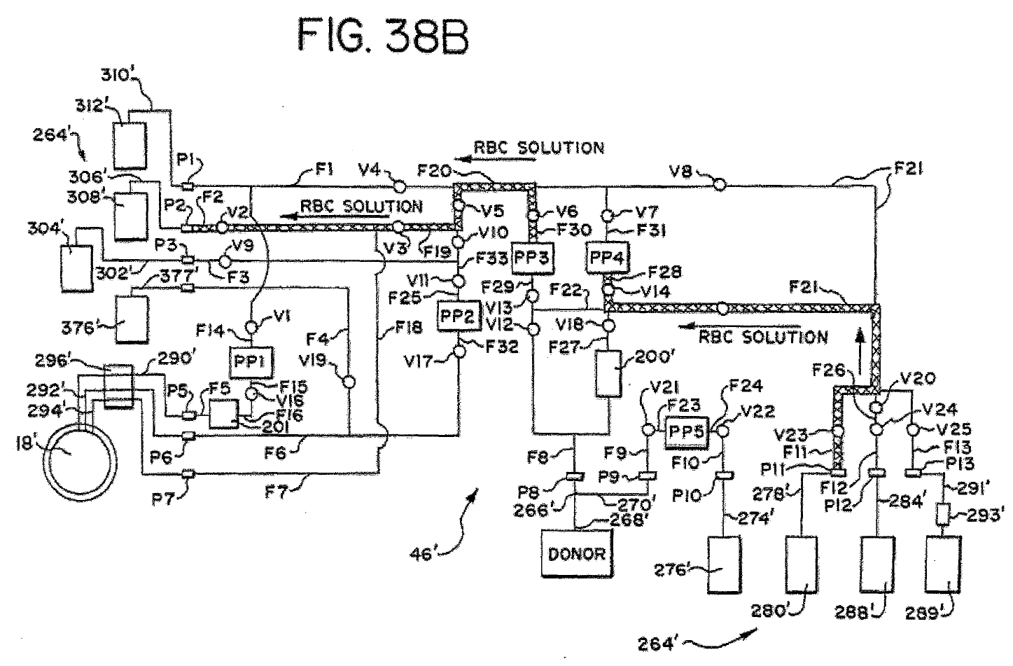

As FIGS. 35 and 36 show, the circuit 46′ (e.g., programmable fluid circuit) can be implemented as an injection molded, pneumatically controlled cassette 28′. The cassette 28′ interacts with the pneumatic pump and valve station 30, as previously described, to provide the same centralized, programmable, integrated platform as the cassette 28.

FIGS. 35 and 36 show the cassette 28′ in which the circuit 46′ (e.g., fluid circuit) (schematically shown in FIG. 34) is implemented. As previously described for the cassette 28, an array of interior wells, cavities, and channels are formed on both the front and back sides 190′ and 192′ of the cassette body 188′, to define the pump stations PP1 to PP5, the in-line valve V1 to V25, and flow paths F1 to F33 shown schematically in FIG. 34. In FIG. 36, the flow paths F1 to F33, are shaded to facilitate their viewing. First and second flexible diaphragms 194′ and 196′ overlay the front and back sides 190′ and 192′ of the cassette body 188′, resting against the upstanding peripheral edges surrounding the pump stations PP1 to PP5, the in-line valves V1 to V25, and flow paths F1 to F33. The universal ports P1 to P13 extend out along two side edges of the cassette body 188′.

The cassette 28′ is vertically mounted for use in the pump and valve station 30 in the same fashion shown in FIG. 2. In this orientation (which FIG. 36 shows), the back side 192′ faces outward, the universal ports P8 to P13 face downward, and the universal ports P1 to P7 are vertically stacked one above the other and face inward.

As previously described, localized application by the pump and valve station 30 of positive and negative fluid pressures upon the first flexible diaphragm 194′ serves to flex the diaphragm to close and open the in-line valve V1 to V25 or to expel and draw liquid out of the pump stations PP1 to PP5.

Additionally, an interior cavity 200′ is provided in the back side 192′ of the cassette body 188′. The interior cavity 200′ forms a station that holds a blood filter material to remove clots and cellular aggregations that can form during blood processing. As shown schematically in FIG. 34, the interior cavity 200′ is placed in the circuit 46′ between the port P8 and the donor interface pump stations PP3 and PP4, so that blood returned to the donor passes through the filter. Return blood flow enters the interior cavity 200′ through flow path F27 and exits the interior cavity 200′ through flow path F8. The interior cavity 200′ also serves to trap air in the flow path to and from the donor.

Another interior cavity or cavity 201′ (see FIG. 35) is also provided in the back side 192′ of the cassette body 188′. The cavity 201′ is placed in the circuit 46′ between the port P5 and the in-line valve V16 of the in-process pumping station PP1. Blood enters the cavity 201′ from flow path F16 through an opening 203′ and exits the cavity 201′ into flow path F5 through an opening 205′. The cavity 201′ serves as another air trap within the cassette body 188′ in the flow path serving the processing chamber 18′. The cavity 201′ also serves as a capacitor to dampen the pulsatile pump strokes of the in-process pump PP1 serving the processing chamber 18′ (e.g., separation chamber).

### C. Associated Pneumatic Manifold Assembly

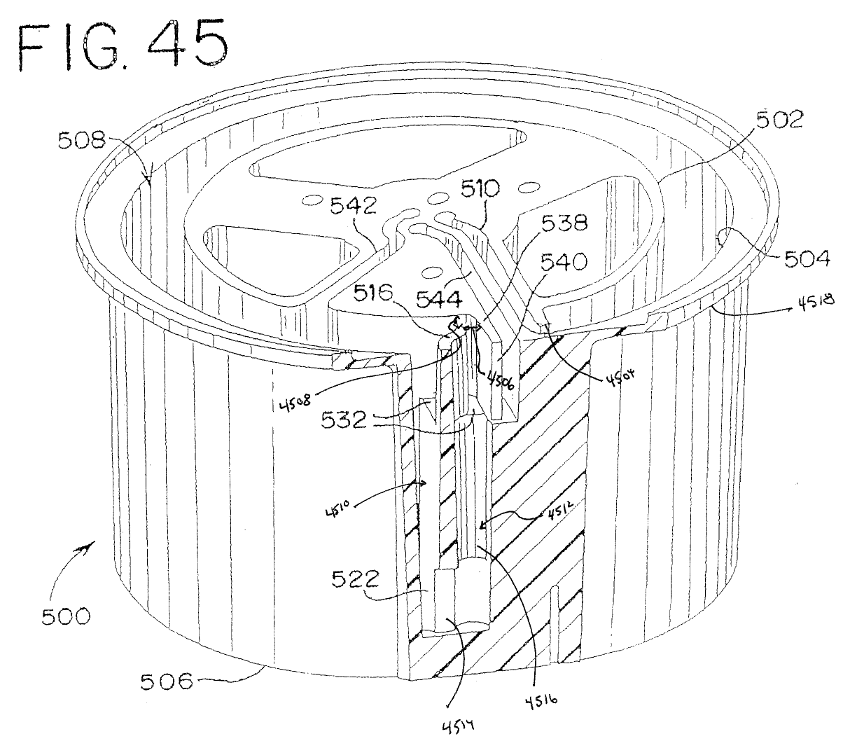

FIG. 43 shows a pneumatic manifold assembly 226′ that can be used in association with the cassette 28′, to supply positive and negative pneumatic pressures to convey fluid through the cassette 28′. The front side of the first flexible diaphragm 194′ is held in intimate engagement against the pneumatic manifold assembly 226′ when the door 32 of the pump station 20 is closed and the inflatable bladder 314 inflated. The pneumatic manifold assembly 226′, under the control of the controller 16, selectively distributes the different pressure and vacuum levels to the pump and valve actuators PA(N) and VA(N) of the cassette 28′. These levels of pressure and vacuum are systematically applied to the cassette 28′, to route blood and processing liquids. Under the control of the controller 16, the pneumatic manifold assembly 226′ also distributes pressure levels to the inflatable bladder 314 (e.g., door bladder) (already described), as well as to a donor pressure cuff (also already described) and to a donor line occluder 320 (also already described). The pneumatic manifold assembly 226′ for the cassette 28′ shown in FIG. 43 shares many attributes with the manifold assembly 226 previously described for the cassette 28, as shown in FIG. 12.

Like the manifold assembly 226, the pneumatic manifold assembly 226′ is coupled to a pneumatic pressure source 234′, which is carried inside the lid 40 behind the pneumatic manifold assembly 226′. As in manifold assembly 226, the pneumatic pressure source 234′ for the pneumatic manifold assembly 226′ comprises two compressors C1′ and C2′, although one or several dual-head compressors could be used as well. Compressor C1′ supplies negative pressure through the pneumatic manifold assembly 226′ to the cassette 28′. The other compressor C2′ supplies positive pressure through the pneumatic manifold assembly 226′ to the cassette 28′.

As FIG. 43 shows, the pneumatic manifold assembly 226′ contains five pump actuators PA1 to PA5 and twenty-five valve actuators VA1 to VA25. The pump actuators PA1 to PA5 and the valve actuators VA1 to VA25 are mutually oriented to form a mirror image of the pump stations PP1 to PP5 and the in-line valve V1 to V25 on the front side 190′ of the cassette 28′.

Like the manifold assembly 226, the pneumatic manifold assembly 226′ shown in FIG. 43 includes an array of solenoid actuated pneumatic valves, which are coupled in-line with the pump and valve actuators PA1 to PA5 and VA1 to VA25.

Like the manifold assembly 226, the pneumatic manifold assembly 226′ maintains several different pressure and vacuum conditions, under the control of the controller 16.

As previously described in connection with the manifold assembly 226, Phard, or Hard Pressure, and Pinpr, or In-Process Pressure are high positive pressures (e.g., +500 mmHg) maintained by the pneumatic manifold assembly 226′ for closing the in-line valves V1 to V25 and to drive the expression of liquid from the in-process pump PP1 and the plasma pump PP2. As before explained, the magnitude of Pinpr is sufficient to overcome a minimum pressure of approximately 300 mm Hg, which is typically present within the processing chamber 18′. Pinpr and Phard are operated at the highest pressure to ensure that upstream and downstream valves used in conjunction with pumping are not forced open by the pressures applied to operate the pumps.

Pgen, or General Pressure (+300 mmHg), is applied to drive the expression of liquid from the donor interface pumps PP3 and PP4 and the anticoagulant pump PP5.

Vhard, or Hard Vacuum (−350 mmHg), is the deepest vacuum applied in the pneumatic manifold assembly 226′ to open the in-line valves V1 to V25. Vgen, or General Vacuum (−300 mmHg), is applied to drive the draw function of each of the pumps PP1 to PP5. Vgen is required to be less extreme than Vhard, to ensure that pumps PP1 to PP5 do not overwhelm upstream and downstream in-line valves V1 to V25.

A main hard pressure line 322′ and a main vacuum line 324′ distribute Phard and Vhard in the pneumatic manifold assembly 226′. The pneumatic pressure source 234′ run continuously to supply Phard to the hard pressure line 322′ and Vhard to the main vacuum line 324′ (e.g., hard vacuum line). A pressure sensor S2 monitors Phard in the hard pressure line 322′. The sensor S2 opens and closes the solenoid SO32 to build Phard up to its maximum set value.

Similarly, a pressure sensor S8 in the main vacuum line 324′ (e.g., hard vacuum line) monitors Vhard. The sensor S8 controls a solenoid SO43 to maintain Vhard as its maximum value.

A general pressure line 326′ branches from the hard pressure line 322′. A sensor S4 in the general pressure line 326′ monitors Pgen. The sensor S4 controls a solenoid SO34 to maintain Pgen within its specified pressure range.

A general vacuum line 330′ branches from the main vacuum line 324′ (e.g., hard vacuum line). A sensor S5 monitors Vgen in the general vacuum line 330′. The sensor S5 controls a solenoid SO45 to keep Vgen within its specified vacuum range.

In-line reservoirs R1 to R4 are provided in the hard pressure line 322′, the general pressure line 326′, the main vacuum line 324′ (e.g., hard vacuum line), and the general vacuum line 330′. The reservoirs R1 to R4 assure that the constant pressure and vacuum adjustments as above described are smooth and predictable.

The solenoids SO32 and SO43 provide a vent for the pressures and vacuums, respectively, upon procedure completion.

The solenoids SO41, SO42, SO47, and SO48 provide the capability to isolate the reservoirs R1 to R4 from the air lines that supply vacuum and pressure to the pump and valve actuators. This provides for much quicker pressure/vacuum decay feedback, so that testing of cassette/manifold assembly seal integrity can be accomplished.

The solenoids SO1 to SO25 provide Phard or Vhard to drive the valve actuators VA1 to V25. The solenoids SO27 and SO28 provide Pinpr and Vgen to drive the in-process and plasma pumps PP1 and PP2. The solenoids SO30 and SO31 provide Pgen and Vgen to drive the donor interface pumps PP3 and PP4. The solenoid SO29 provides Pgen and Vgen to drive the AC pump PP5.

The solenoid SO35 provides isolation of the inflatable bladder 314 (e.g., door bladder) from the hard pressure line 322′ during the procedure. A sensor S1 monitors Pdoor and control the solenoid SO35 to keep the pressure within its specified range.

The solenoid SO40 provides Phard to open the safety occluder valve 320. Any error modes that might endanger the donor will relax (vent) the solenoid SO40 to close the occluder 320 and isolate the donor. Similarly, any loss of power will relax the solenoid SO40 and isolate the donor.

The sensor S3 monitors Pcuff and communicates with solenoid SO36 (for increases in pressure) and solenoid SO37 (for venting) to maintain the donor cuff within its specified ranges during the procedure.

As before explained, any solenoid can be operated in “normally open” mode or can be re-routed pneumatically to be operated in a “normally closed” mode, and vice versa.

### D. Exemplary Pumping Functions

Based upon the foregoing description of the programming of the fluid circuit 46 implemented by the cassette 28, one can likewise program the circuit 46′ (e.g., fluid circuit) implemented by the cassette 28′ to perform all the various blood process functions already described. Certain pumping functions for the circuit 46′, common to various blood processing procedures, will be described by way of example.

### 1. Whole Blood Flow to the In-Process Container

In a first phase of a given blood collection cycle, the circuit 46′ (e.g., blood processing circuit) is programmed (through the selective application of pressure to the valves and pump stations of the cassette 28′) to jointly operate the donor interface pumps PP3 and PP4 to transfer anticoagulated whole blood into the collection container 312′ (e.g., the in-process container) prior to separation.

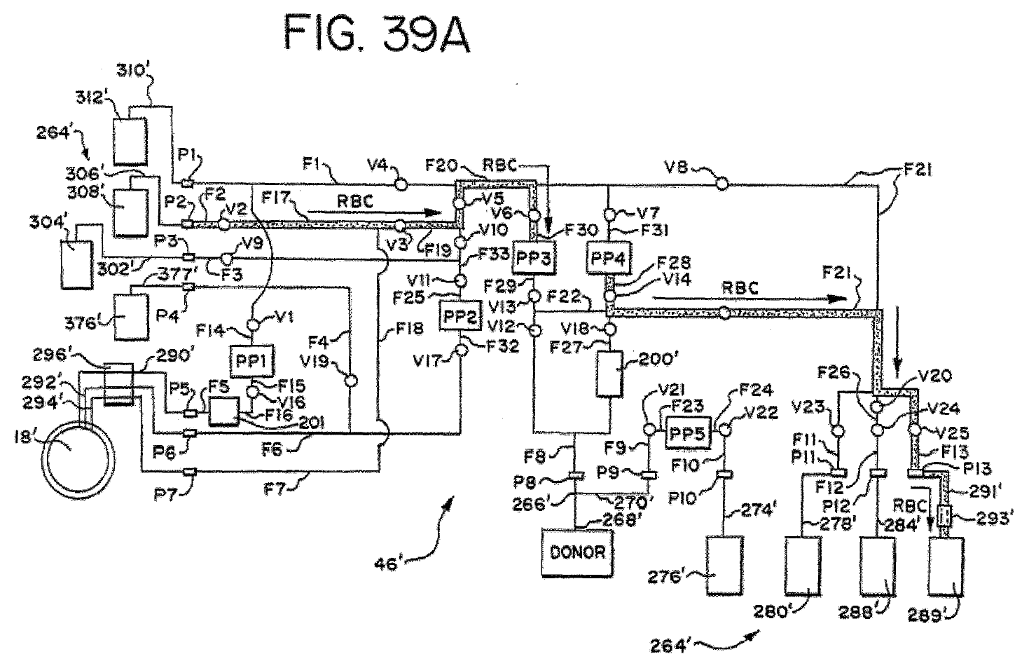

In a first phase (see FIG. 37A), the pump PP3 is operated in a ten second draw cycle (i.e., in through the in-line valves V12 and V13, with the in-line valves V6, V14, V18, and V15 closed) in tandem with the anticoagulant pump PP5 (i.e., in through valve V22 and out through valve V21) to draw anticoagulated blood through the anticoagulant tube 270′ into the pump PP3. At the same time, the donor interface pump PP4 is operated in a one second expel cycle to expel (out through valve V7) anticoagulated blood from its chamber into the collection container 312′ (e.g., in-process container) through flow paths F20 and F1 (through opened valve V4).

At the end of the draw cycle for pump PP3 (see FIG. 37B), the circuit 46′ (e.g., blood processing circuit) is programmed to operate the donor interface pump PP4 in a ten second draw cycle (i.e., in through the in-line valves V12 and V14, with the in-line valves V13 and V18 closed) in tandem with the anticoagulant pump PP5 to draw anticoagulated blood through the anticoagulant tube 270′ into the pump PP4. At the same time, the donor interface pump PP3 is operated in a one second expel cycle to expel (out through the in-line valve V6) anticoagulated blood from its chamber into the collection container 312′ (e.g., in-process container) through the flow paths F20 and F1 (through opened the in-line valve V4).

These alternating cycles continue until an incremental volume of anticoagulated whole blood enters the collection container 312′, as monitored by a weigh sensor. As FIG. 37C shows, the circuit 46′ (e.g., blood processing circuit) is programmed to operate the in-process pump station PP1 (i.e., in through the in-line valve V1 and out through the in-line valve V16) and the plasma pump PP2 (i.e., in through the in-line valve V17 and out through the in-line valve V11, with in-line valve V9 opened and the in-line valve V10 closed) to convey anticoagulated whole blood from the collection container 312′ into the processing chamber 18′ for separation, while removing plasma into the collection container 304′ (through opened valve V9) and red blood cells into the collection container 308′ (e.g., red blood cell collection container) (through open valve V2), in the manner previously described with respect to the circuit 46. This phase continues until an incremental volume of plasma is collected in the collection container 304′ (e.g., plasma collection container) (as monitored by the weigh sensor) or until a targeted volume of red blood cells is collected in the red blood cell collection container (as monitored by the weigh sensor). The donor interface pumps PP3 and PP4 toggle to perform alternating draw and expel cycles as necessary to keep the volume of anticoagulated whole blood in the collection container 312′ between prescribed minimum and maximum levels, as blood processing proceeds.

### 2. Red Blood Cell Return with In-Line Addition of Saline

When it is desired to return red blood cells to the donor (see FIG. 37D), the circuit 46′ (e.g., blood processing circuit) is programmed to operate the donor interface pump station PP3 in a ten second draw cycle (i.e., in through valve V6, with the in-line valves V13 and V7 closed) to draw red blood cells from the collection container 308′ (e.g., red blood cell container) into the pump PP3 (through open the in-line valves V2, V3, and V5, the in-line valve V10 being closed). At the same time, the donor interface pump PP4 is operated in a one second expel cycle to expel (out through the in-line valves V14 and V18, with the in-line valves V12 and V21 closed) red blood cells from its chamber to the donor through the interior cavity 200′.

At the end of the draw cycle for pump PP3 (see FIG. 37E), the circuit 46′ (e.g., blood processing circuit) is programmed to operate the donor interface pump PP4 in a ten second draw cycle (i.e., in through the in-line valve V7, with valves V6 and V14 closed) to draw red blood cells from the collection container 308′ (e.g., red blood cell container) into the pump PP4. At the same time, the donor interface pump PP3 is operated in a one second expel cycle to expel (out through the in-line valves V13 and V18, with the in-line valve V12 closed) red blood cells from its chamber to the donor through the interior cavity 200′. These alternating cycles continue until a desired volume of red blood cells are returned to the donor.

Simultaneously, valves V24, V20, and V8 are opened, so that the drawing pump station PP3 or PP4 also draws saline from the container 288′ (e.g., saline container) for mixing with red blood cells drawn into the chamber. As before explained, the in-line mixing of saline with the red blood cells raises the saline temperature and improves donor comfort, while also lowering the hematocrit of the red blood cells.

Simultaneously, the in-process pump PP1 is operated (i.e., in through the in-line valve V1 and out through the in-line valve V16) and the plasma pump PP2 (i.e., in through the in-line valve V17 and out through the in-line valve V11, with the in-line valve V9 open) to convey anticoagulated whole blood from the collection container 312′ into the processing chamber 18′ for separation, while removing plasma into the collection container 304′ (e.g., collection container), in the manner previously described with respect to the fluid circuit 46.

### 3. In-Line Addition of Red Blood Cell Additive Solution

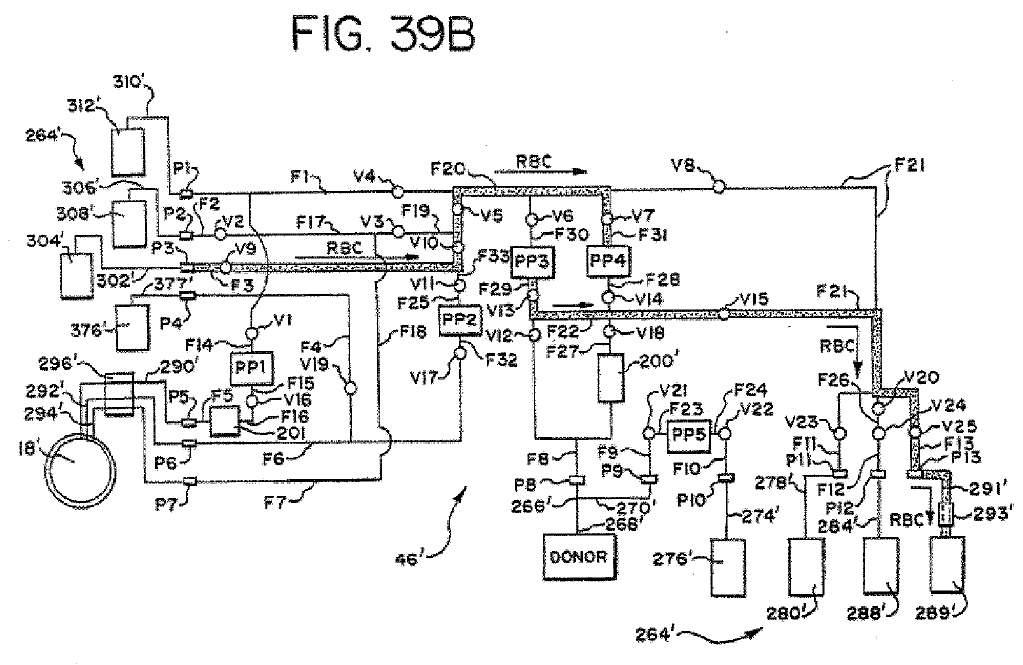

In a blood processing procedure where red blood cells are collected for storage (e.g., the Double Red Blood Cell Collection Procedure or the Red Blood Cell and Plasma Collection Procedure) the circuit 46′ is programmed to operate the donor interface pump station PP3 in a ten second draw cycle (in through the in-line valves V15 and V13, with the in-line valve V23 opened and the in-line valves V8, V12 and V18 closed) to draw red blood cell storage solution from the container 280′ into the pump PP3 (see FIG. 38A). Simultaneously, the circuit 46′ is programmed to operate the donor interface pump station PP4 in a one second expel cycle (out through the in-line valve V7, with the in-line valves V14 and V18 closed) to expel red blood cell storage solution to the container(s) where red blood cells reside (e.g., the collection container 312′ (through open the in-line valve V4) or the collection container 308′ (e.g., red blood cell collection container) (through open the in-line valves V5, V3, and V2, with the in-line valve V10 closed).

At the end of the draw cycle for pump PP3 (see FIG. 38B), the circuit 46′ (e.g., blood processing circuit) is programmed to operate the donor interface pump PP4 in a ten second draw cycle (i.e., in through the in-line valve V14, with the in-line valves V7, V18, V12, and V13 closed) to draw red blood cell storage solution from the container 280′ into the pump PP4. At the same time, the donor interface pump PP3 is operated in a one second expel cycle to expel (out through the in-line valve V6, with the in-line valves V13 and V12 closed) red blood cell storage solution to the container(s) where red blood cells reside. These alternating cycles continue until a desired volume of red blood cell storage solution is added to the red blood cells.

### 4. In-Line Leukocyte Depletion

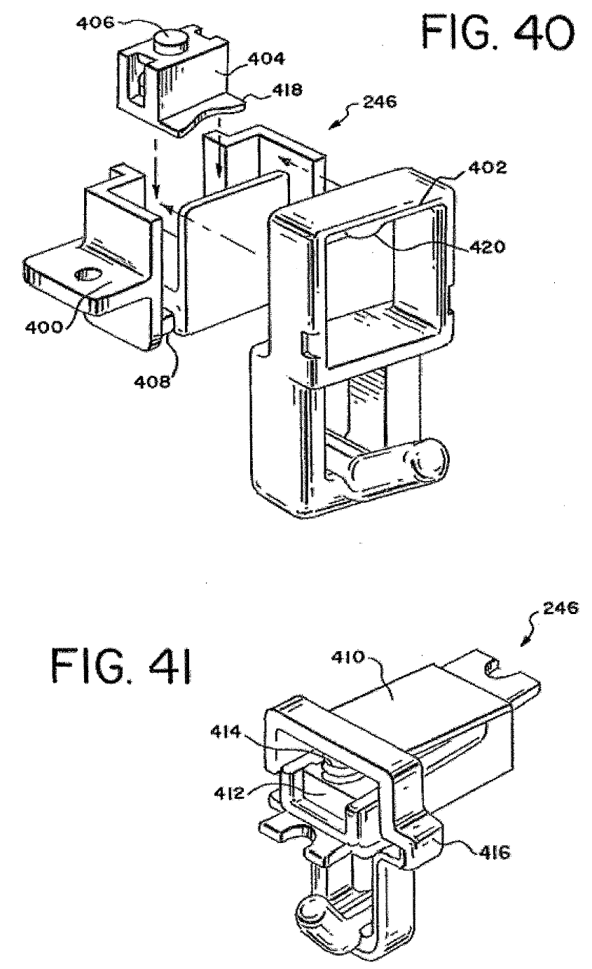

The circuit 46′ provides the capability to conduct on-line depletion of leukocytes from collected red blood cells. In this mode (see FIG. 39A), the circuit 46′ is programmed to operate the donor interface pump station PP3 in a ten second draw cycle (in through the in-line valve V6, with the in-line valves V13 and V12 closed) to draw red blood cells from the container(s) where red blood cells reside (e.g., the collection container 312′ (through open in-line valve V4) or the collection container 308′ (e.g., red blood cell collection container) (through open the in-line valves V5, V3, and V2, with the in-line valve V10 closed) into the pump PP3. Simultaneously, the circuit 46′ is programmed to operate the donor interface pump station PP4 in a one second expel cycle (out through the in-line valve V14, with the in-line valves V18 and V8 closed and the in-line valves V15 and V25 opened) to expel red blood cells through the tube 291′ through the filter 293′ to the storage container 289′ (e.g., leukocyte-depleted red blood cell storage container).

At the end of the draw cycle for pump PP3 (see FIG. 39B), the circuit 46′ (e.g., blood processing circuit) is programmed to operate the donor interface pump PP4 in a ten second draw cycle (i.e., in through the in-line valve V7, with the in-line valves V14 and V18 closed) to draw red blood cells from the collection containers 312′ or 308′ into the pump PP4. At the same time, the donor interface pump PP3 is operated in a one second expel cycle to expel (out through the in-line valve V13, with the in-line valve V12 closed and the in-line valves V15 and V25 opened) red blood cells through the tube 291′ through the filter 293′ to the storage container 289′ (e.g., leukocyte-depleted red blood cell storage container). These alternating cycles continue until a desired volume of red blood cells are transferred through the filter 293′ into the storage container 289′.

### 5. Staged Buffy Coat Harvesting

In circuit 46 (see FIG. 5), buffy coat is collected through port P4, which is served by flow line F4, which branches from flow line F28, which conveys plasma from the plasma pump station PP2 to the plasma collection container 304 (also see FIG. 10). In the circuit 46′ (see FIG. 34), the buffy coat is collected through the port P4 from the flow path F6 as controlled by the in-line valve V19. The buffy coat collection path bypasses the plasma pump station PP2, keeping the plasma pump station PP2 free of exposure to the buffy coat, thereby keeping the collected plasma free of contamination by the buffy coat components.

During separation, the system controller (already described) maintains the buffy coat layer within the processing chamber 18′ at a distance spaced from the low-G wall, away from the tube 292 (e.g., plasma collection line) (see FIG. 15A). This allows the buffy coat component to accumulate during processing as plasma is conveyed by operation of the plasma pump PP2 from the chamber into the collection container 304′ (e.g., plasma collection container).

To collect the accumulated buffy coat component, the controller opens the buffy coat collection the in-line valve V19, and closes the in-line valve V17 of the plasma pump station PP2 and the red blood cell collection the in-line valve V2. The in-process pump PP1 continues to operate, bringing whole blood into the processing chamber 18′. The flow of whole blood into the processing chamber 18′ moves the buffy coat to the low-G wall, inducing an overspill condition (see FIG. 15B). The buffy coat component enters the second tube 292′ (e.g., plasma collection line) and enters flow path F6 through the port P6. The circuit 46′ conveys the buffy coat component in F6 through the opened in-line valve V19 directly into path F4 for passage through the port P4 into the buffy coat collection container 376′.

The in-line valve V19 is closed when the sensing station 332 senses the presence of red blood cells. The plasma pumping station PP2 can be temporarily operated in a reverse flow direction (in through the in-line valve V11 and out through the in-line valve V17, with the in-line valve V9 opened) to flow plasma from the collection container 304′ through the second tube 292′ toward the processing chamber 18′ (e.g., separation chamber), to flush resident red blood from the second tube 292′ back into the processing chamber 18′ (e.g., separation chamber). The controller can resume normal plasma and red blood cell collection, by opening the red blood cell collection the in-line valve V2 and operating the plasma pumping station PP2 (in through the in-line valve V17 and out through the in-line valve V11) to resume the conveyance of plasma from the processing chamber 18′ (e.g., separation chamber) to the collection container 304′.

Overspill conditions causing the movement of the buffy coat for collection can be induced at prescribed intervals during the process period, until a desired buffy coat volume is collected in the buffy coat collection container.

### 6. Miscellaneous

As FIG. 43 shows in phantom lines, the pneumatic manifold assembly 226′ can include an auxiliary pneumatic actuator A_{AUX} to selectively apply P_{HARD} to the region of the flexible diaphragm that overlies the cavity 201′ (see FIG. 35). As previously described, whole blood expelled by the pumping station PP1 (by application of P_{HARD} by actuator PA1), enters flow path F5 through the openings 203′ and 205′ into the processing chamber 18′. During the next subsequent stroke of the PP1, to draw whole blood into the pumping chamber PP1 by application of VGEN by actuator PA1, residual whole blood residing in the cavity 201′ is expelled into flow path F5 through the opening 205′, and into the processing chamber 18′ by application of P_{HARD} by A_{AUX}. The cavity 201′ also serves as a capacitor to dampen the pulsatile pump strokes of the in-process pump PP1 serving the processing chamber 18′ (e.g., separation chamber).

It is desirable to conduct seal integrity testing of the cassette 28′ shown in FIGS. 35 and 36 prior to use. The integrity test determines that the pump and valve stations within the cassette 28′ function without leaking. In this situation, it is desirable to isolate the cassette 28′ from the processing chamber 18′. The in-line valves V16 and V17 (see FIG. 34) in the universal set 264′ (e.g., circuit) provide isolation for the first and second tubes 290′ and 292′ (e.g., whole blood inlet and plasma lines) of the processing chamber 18′. To provide the capability of also isolating the third tube 294′ (e.g., red blood cell line), an extra in-line valve V26 can be added in fluid flow path F7 serving port P7. As further shown in phantom lines in FIG. 43, an addition valve actuator VA26 can be added to the pneumatic manifold assembly 226′, to apply positive pressure to the valve V26, to close the valve V26 when isolation is required, and to apply negative pressure to the in-line valve V26, to open the valve when isolation is not required.

### VII. Blood Separation Elements

### A. Molded Processing Chamber

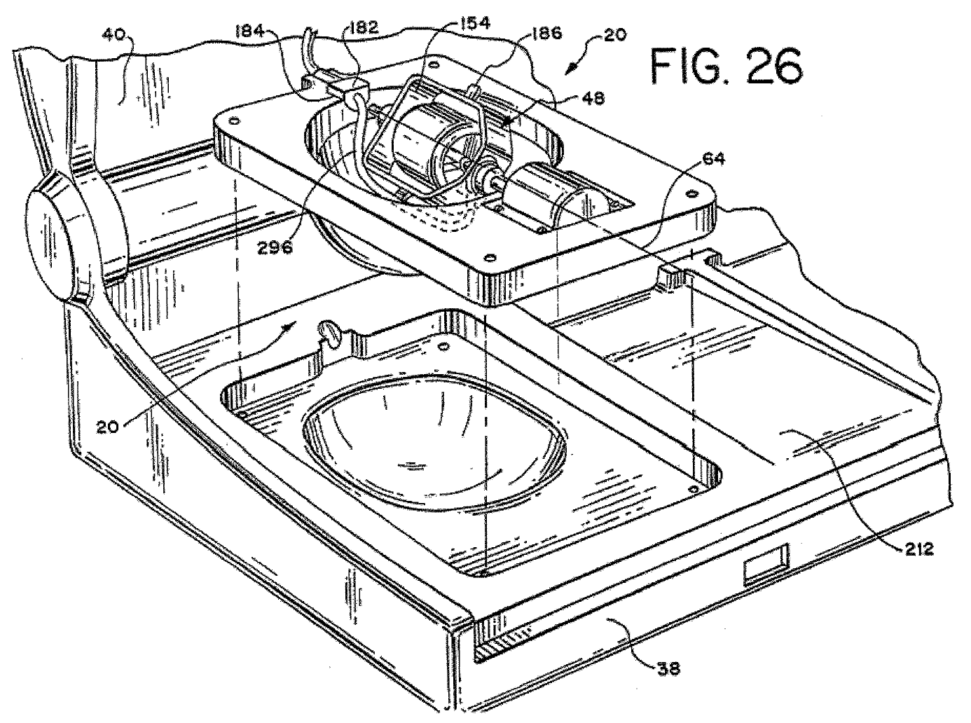

FIGS. 21 to 23 show an example of the centrifugal processing chamber 18, which can be used in association with the system 10 shown in FIG. 1.

In the illustrated example, the processing chamber 18 is preformed in a desired shape and configuration, e.g., by injection molding, from a rigid, biocompatible plastic material, such as a non-plasticized medical grade acrylonitrile-butadiene-styrene (ABS).

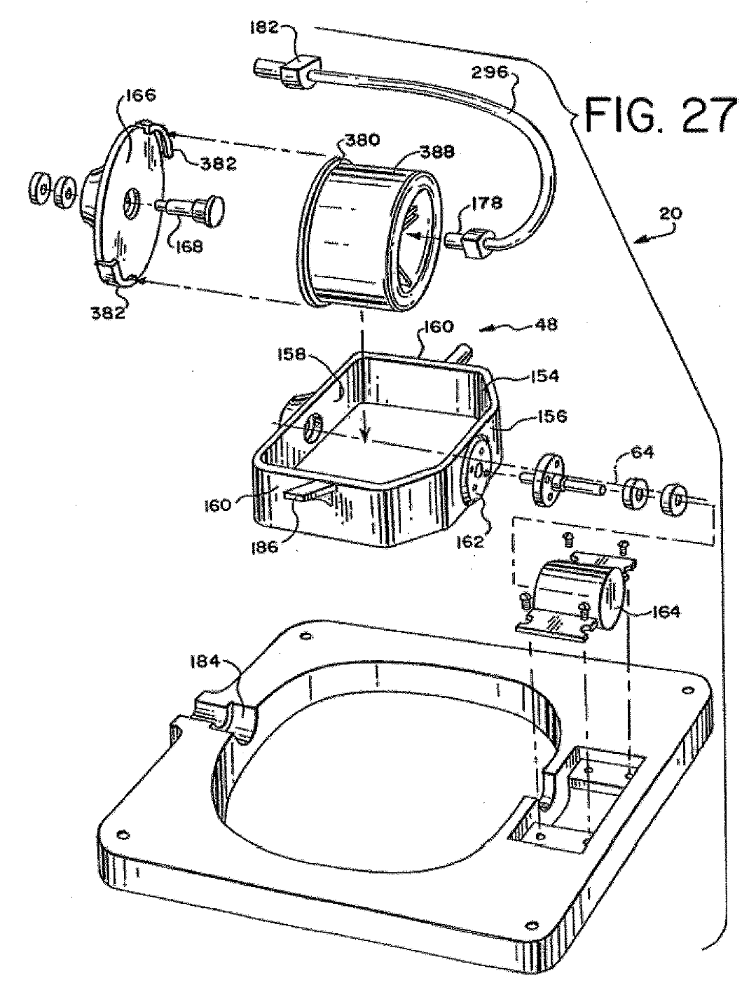

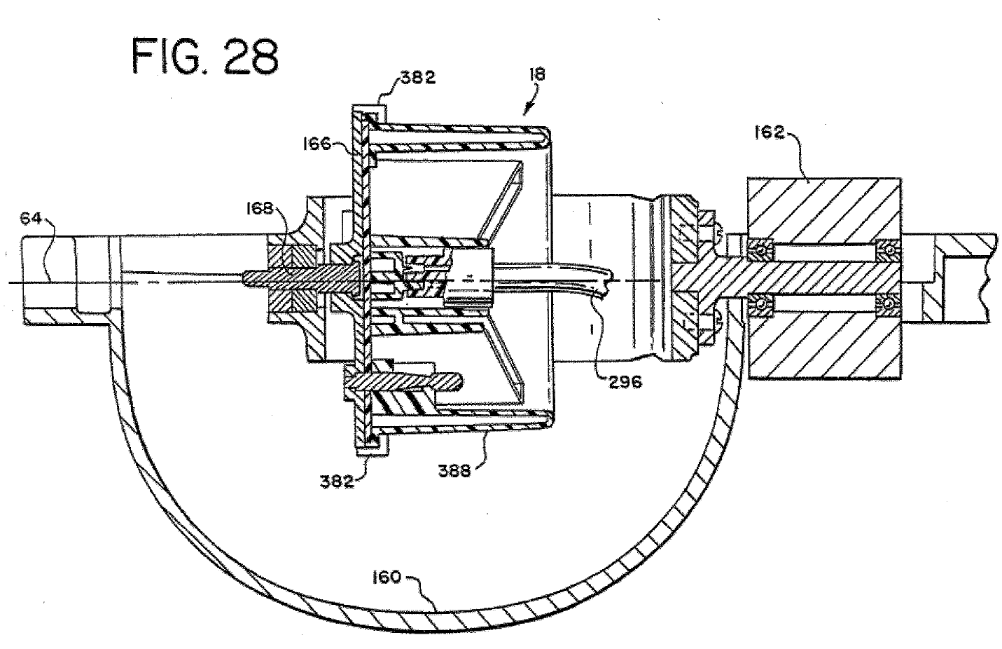

The preformed configuration of the chamber 18 includes a unitary, molded base 388. The base 388 includes a center hub or hub 120. The hub 120 is surrounded radially by inside and outside annular walls 122 and 124 (see FIGS. 21 and 23). Between them, the inside and outside annular walls 122 and 124 define a circumferential blood separation channel or channel 126. A molded annular wall 148 closes the bottom of the channel 126 (see FIG. 22).

The top of the channel 126 is closed by a separately molded, flat lid 150 (which is shown separated in FIG. 21 for the purpose of illustration). During assembly, the lid 150 is secured to the top of the chamber 18, e.g., by use of a cylindrical sonic welding horn.

All contours, ports, channels, and walls that affect the blood separation process are preformed in the base 388 in a single, injection molded operation. Alternatively, the base 388 can be formed by separate molded parts, either by nesting cup shaped subassemblies or two symmetric halves.

The lid 150 comprises a simple flat part that can be easily welded to the base 388. Because all features that affect the separation process are incorporated into one injection molded component, any tolerance differences between the base 388 and the lid 150 will not affect the separation efficiencies of the chamber 18.

The contours, ports, channels, and walls that are preformed in the base 388 can vary. In the example shown in FIGS. 21 to 23, circumferentially spaced pairs of stiffening walls 128, 130, and 132 emanate from the hub 120 to the inside annular wall 122. The stiffening walls 128, 130, 132 provide rigidity to the chamber 18.

As seen in FIG. 23, the inside annular wall 122 is open between one pair of the stiffening walls 130. The opposing stiffening walls form an open interior region 134 in the hub 120, which communicates with the channel 126. Blood and fluids are introduced from the umbilicus 296 into and out of the channel 126 (e.g., separation channel) through this open interior region 134.

In this example (as FIG. 23 shows), a molded interior wall or wall 136 formed inside the open interior region 134 extends entirely across the channel 126, joining the outside annular wall 124. The wall 136 forms a terminus in the channel 126 (e.g., separation channel), which interrupts flow circumferentially along the channel 126 during separation.

Additional molded interior walls divide the open interior region 134 into first, second and third passages 142, 144, and 146. The passages 142, 144, and 146 extend from the hub 120 and communicate with the channel 126 on opposite sides of the wall 136 (e.g., terminus wall). Blood and other fluids are directed from the hub 120 into and out of the channel 126 through these passages 142, 144, and 146. As will be explained in greater detail later, the passages 142, 144, and 146 can direct blood components into and out of the channel 126 in various flow patterns.

The underside of the base 388 (see FIG. 22) includes a shaped receptacle or receptacle 179. Three preformed nipples 180 occupy the receptacle 179. Each of the nipples 180 leads to one of the passages 142, 144, 146 on the opposite side of the base 388.

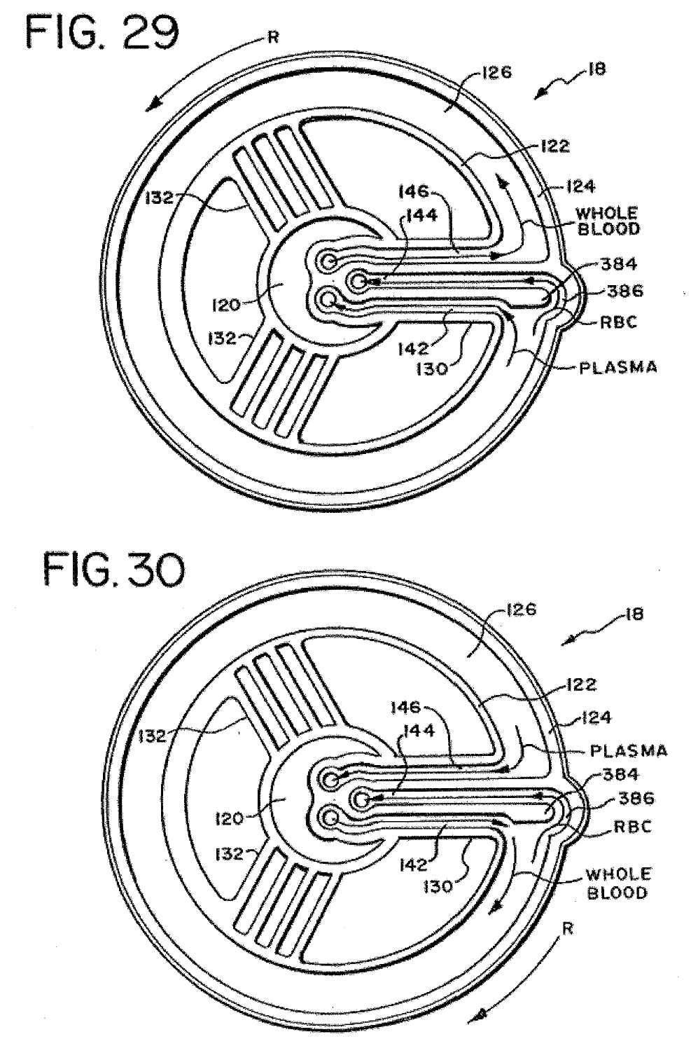

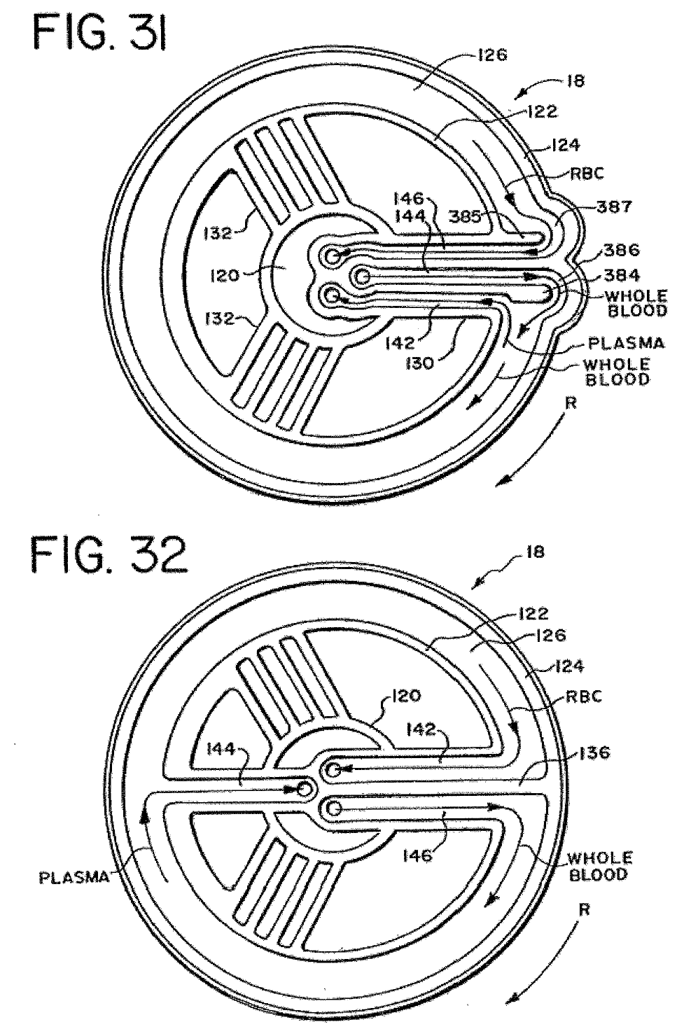

The far end of the umbilicus 296 includes a shaped mount or mount 178 (see FIGS. 24 and 24A). The mount 178 is shaped to correspond to the shape of the receptacle 179. The mount 178 can thus be plugged into the receptacle 179 (as FIG. 25 shows). The mount 178 includes interior lumens 398 (see FIG. 24A), which slide over the nipples 180 in the hub 120, to couple the umbilicus 296 in fluid communication with the channel 126.

Ribs 181 within the receptacle 179 (see FIG. 22) uniquely fit within a key way 183 formed on the mount 178 (see FIG. 24A). The unique fit between the ribs 181 and the key way 183 is arranged to require a particular orientation for plugging the mount 178 into the receptacle 179. In this way, a desired flow orientation among the umbilicus 296 and the passages 142, 144, and 146 is assured.

In the illustrated example, the umbilicus 296 and the mount 178 are formed from a material or materials that withstand the considerable flexing and twisting forces, to which the umbilicus 296 is subjected during use. For example, a Hytrel® polyester material can be used.

This material, while well suited for the umbilicus 296, is not compatible with the ABS plastic material of the base 388, which is selected to provide a rigid, molded blood processing environment. The mount 178 thus cannot be attached by conventional solvent bonding or ultrasonic welding techniques to the receptacle 179.

In this arrangement (see FIGS. 24 and 25), the dimensions of the receptacle 179 and the mount 178 may be selected to provide a tight, dry press fit. In addition, a capturing piece 185, formed of ABS material (or another material compatible with the material of the base 388), may be placed about the umbilicus 296 outside the receptacle in contact with the peripheral edges of the receptacle 179. The capturing piece 185 is secured to the peripheral edges of the receptacle 179, e.g., by swaging or ultrasonic welding techniques. The capturing piece 185 prevents inadvertent separation of the mount 178 from the receptacle 179. In this way, the umbilicus 296 can be integrally connected to the base 388 of the chamber 18, even though incompatible plastic materials are used.

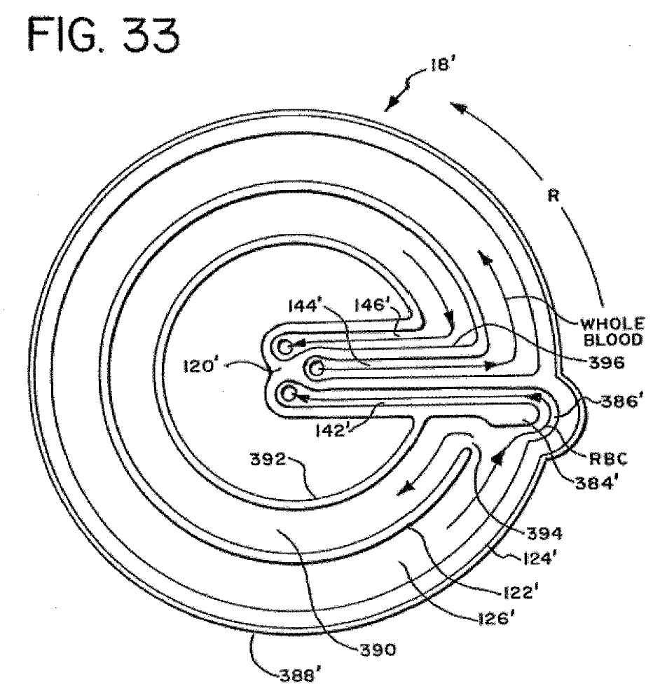

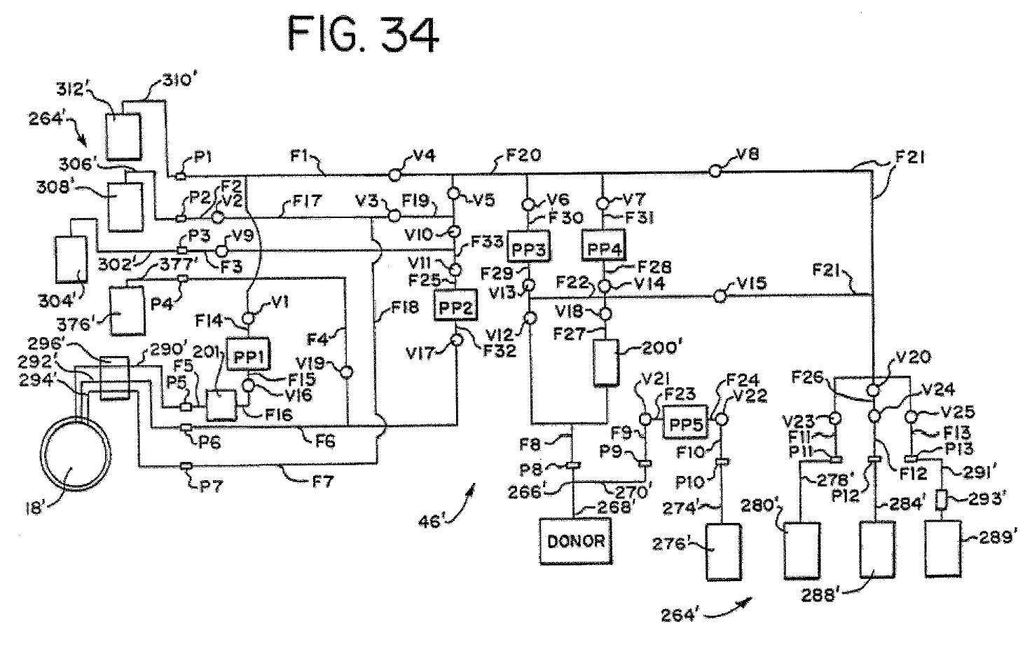

The centrifuge station 20 (see FIGS. 26 to 28) includes a centrifuge assembly 48. The centrifuge assembly 48 is constructed to receive and support the molded processing chamber 18 for use.

As illustrated, the centrifuge assembly 48 includes a yoke 154 having bottom, top, and side walls 156, 158, 160. The yoke 154 spins on a bearing element 162 attached to the bottom wall 156. An electric drive motor 164 is coupled via an axle to the bottom wall 156 of the yoke 154, to rotate the yoke 154 about an axis 64. In the illustrated example, the axis 64 is tilted about fifteen degrees above the horizontal plane of the base 38, although other angular orientations can be used.

A rotor plate 166 spins within the yoke 154 about a bearing element 168 (e.g., its own bearing element), which is attached to the top wall 158 of the yoke 154. The rotor plate 166 spins about an axis that is generally aligned with the axis 64 of the yoke 154.

The top of the processing chamber 18 includes an annular lip or lip 380, to which the lid 150 is secured. Gripping tabs 382 carried on the periphery of the rotor plate 166 make snap-fit engagement with the lip 380, to secure the processing chamber 18 on the rotor plate 166 for rotation.

A sheath 182 on the near end of the umbilicus 296 fits into a bracket 184 in the centrifuge station 20. The bracket 184 holds the near end of the umbilicus 296 in a non-rotating stationary position aligned with the axis 64 of both the yoke 154 and the rotor plate 166.

An arm 186 protruding from either or both of the side walls 160 of the yoke 154 contacts the mid portion of the umbilicus 296 during rotation of the yoke 154. Constrained by the bracket 184 at its near end and the chamber 18 at its far end (where the mount 178 is secured inside the receptacle 179), the umbilicus 296 twists about its own axis as it rotates about the axis 64 (e.g., yoke axis). The twirling of the umbilicus 296 about its axis as it rotates at one omega with the yoke 154 imparts a two omega rotation to the rotor plate 166, and thus to the processing chamber 18 itself.

The relative rotation of the yoke 154 at a one omega rotational speed and the rotor plate 166 at a two omega rotational speed, keeps the umbilicus 296 untwisted, avoiding the need for rotating seals. The illustrated arrangement also allows the electric drive motor 164 to impart rotation, through the umbilicus 296, to the yoke 154 (e.g., mutually rotating yoke) and the rotor plate 166. Further details of this arrangement are disclosed in Brown et al U.S. Pat. No. 4,120,449, which is hereby incorporated herein by reference.

Blood is introduced into and separated within the processing chamber 18 as it rotates.

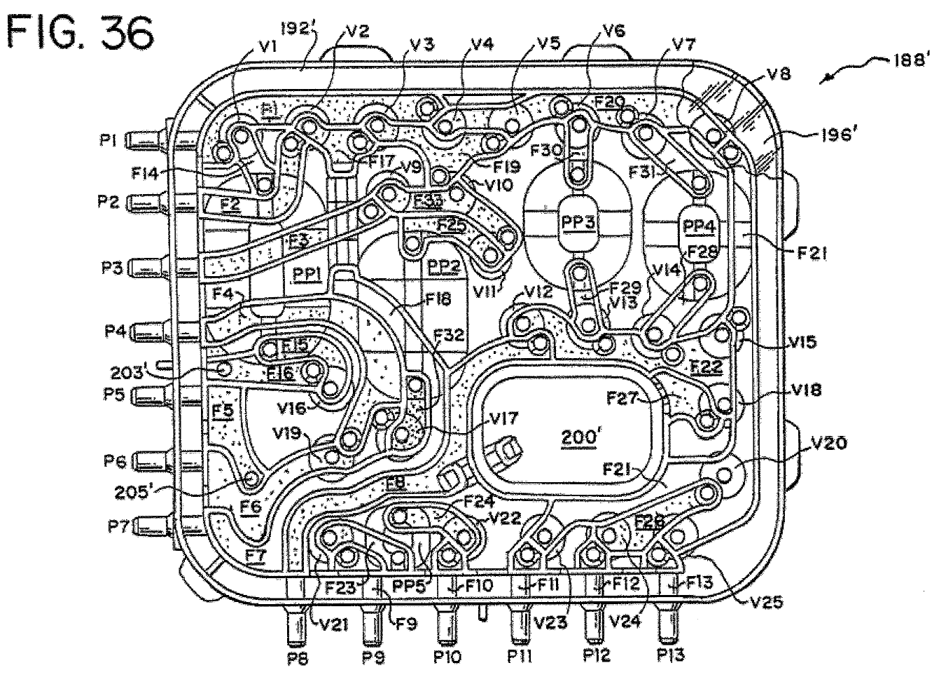

In one flow arrangement (see FIG. 29), as the processing chamber 18 rotates (arrow R in FIG. 29), the umbilicus 296 conveys whole blood into the channel 126 through the third passage 146. The whole blood flows in the channel 126 in the same direction as rotation (which is counterclockwise in FIG. 29). Alternatively, the chamber 18 can be rotated in a direction opposite to the circumferential flow of whole blood, i.e., clockwise. The whole blood separates as a result of centrifugal forces in the manner shown in FIG. 15A. Red blood cells are driven toward the outside annular wall 124 (e.g., high-G wall), while lighter plasma constituent is displaced toward the inside annular wall 122 (e.g., low-G wall).

In this flow pattern, a dam 384 projects into the channel 126 toward the outside annular wall 124 (e.g., high-G wall). The dam 384 prevents passage of plasma, while allowing passage of red blood cells into a channel 386 recessed in the outside annular wall 124 (e.g., high-G wall). The channel 386 directs the red blood cells into the umbilicus 296 through the second passage 144 (e.g., radial passage). The plasma constituent is conveyed from the channel 126 through the first passage 142 (e.g., radial passage) into umbilicus 296.

Because the channel 386 (e.g., red blood cell exit channel) extends outside the outside annular wall 124, being spaced further from the rotational axis than the high-g wall, the channel 386 (e.g., red blood cell exit channel) allows the positioning of the interface between the red blood cells and the buffy coat very close to the outside annular wall 124 during blood processing, without spilling the buffy coat into the second passage 144 (e.g., red blood cell collection passage) (creating an underspill condition). The channel 386 (e.g., recessed exit channel) thereby permits red blood cell yields to be maximized (in a red blood cell collection procedure) or an essentially platelet-free plasma to be collected (in a plasma collection procedure).

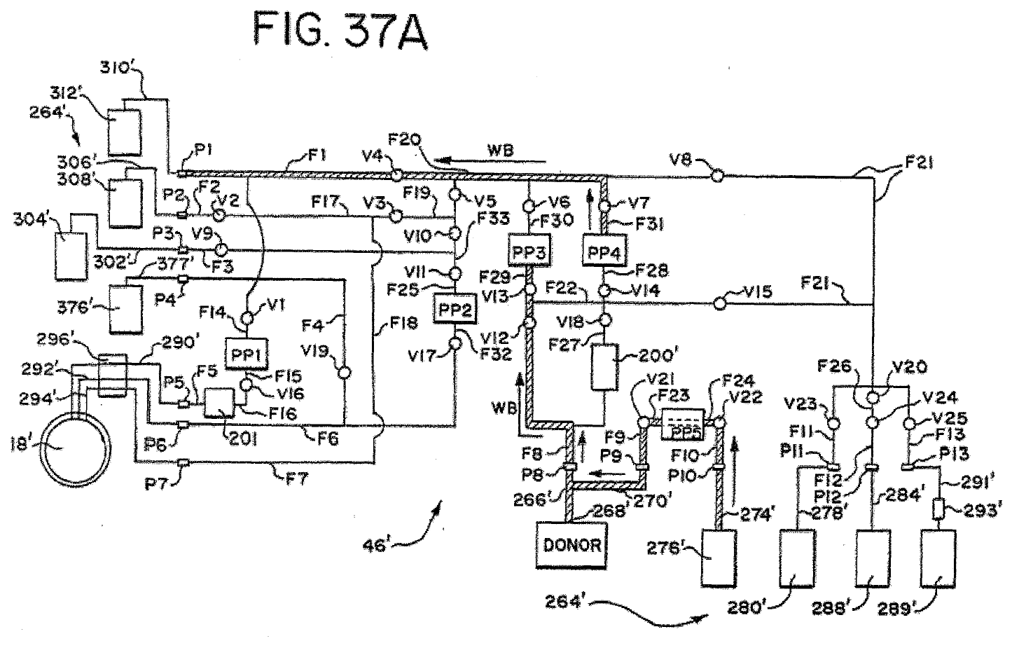

In an alternative flow arrangement (see FIG. 30), the umbilicus 296 conveys whole blood into the channel 126 through the first passage 142. The processing chamber 18 rotates (arrow R in FIG. 30) in the same direction as whole blood flow (which is clockwise in FIG. 30). Alternatively, the chamber 18 can be rotated in a direction opposite to the circumferential flow of whole blood, i.e., clockwise. The whole blood separates as a result of centrifugal forces in the manner shown in FIG. 15A. Red blood cells are driven toward the outside annular wall 124, while lighter plasma constituent is displaced toward the inside annular 122 (e.g., low-G wall).

In this flow pattern, the dam 384 (previously described) prevents passage of plasma, while allowing passage of red blood cells into the channel 386 (e.g., recessed channel). The channel 386 directs the red blood cells into the umbilicus 296 through the second passage 144 (e.g., radial). The plasma constituent is conveyed from the opposite end of the channel 126 through the third passage 146 (e.g., radial passage) into umbilicus 296.

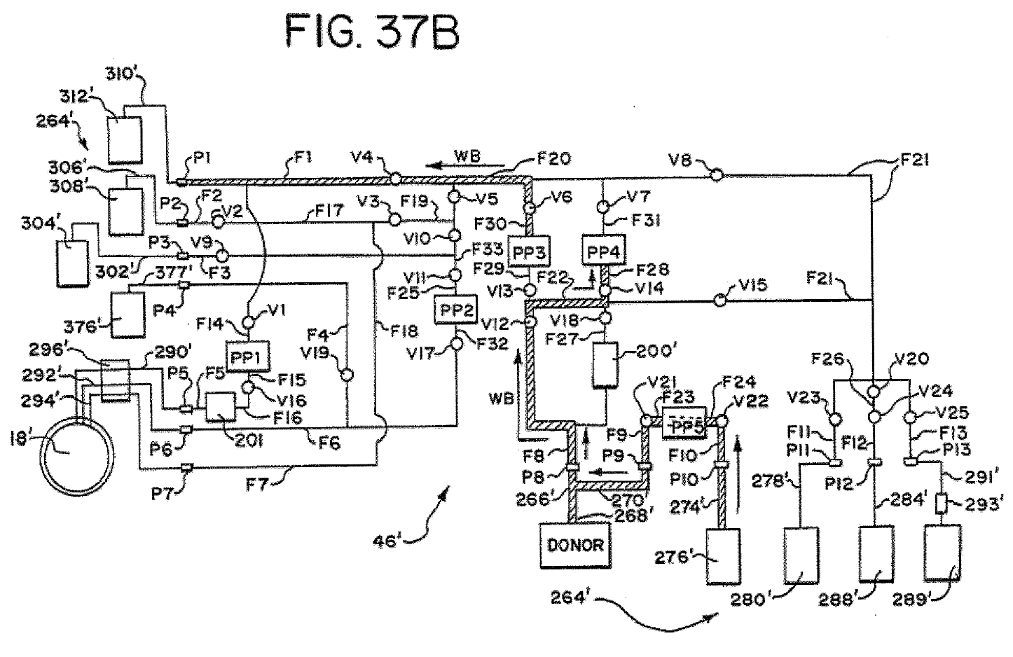

In another alternative flow arrangement (see FIG. 31), the umbilicus 296 conveys whole blood into the channel 126 through the second passage 144. The processing chamber 18 is rotated (arrow R in FIG. 31) in the same direction as blood flow (which is clockwise in FIG. 31). Alternatively, the chamber 18 can be rotated in a direction opposite to the circumferential flow of whole blood, i.e., counterclockwise. The whole blood separates as a result of centrifugal forces in the manner shown in FIG. 15A. Red blood cells are driven toward the outside annular wall 124, while lighter plasma constituent is displaced toward the inside annular wall 122 (e.g., low-G wall).

In this flow pattern, a dam 385 at the opposite end of the channel 126 prevents passage of plasma, while allowing passage of red blood cells into a recessed channel 387. The recessed channel 387 directs the red blood cells into the umbilicus 296 through the third passage 146 (e.g., radial passage). The plasma constituent is conveyed from the other end of the channel 126 through the first passage 142 (e.g., radial passage) into umbilicus 296. In this arrangement, the presence of the dam 384 and the channel 386 (e.g., recessed passage) (previously described) separates incoming whole blood flow (in the second passage 144) from outgoing plasma flow (in the first passage 142). This flow arrangement makes possible the collection of platelet-rich plasma, if desired.

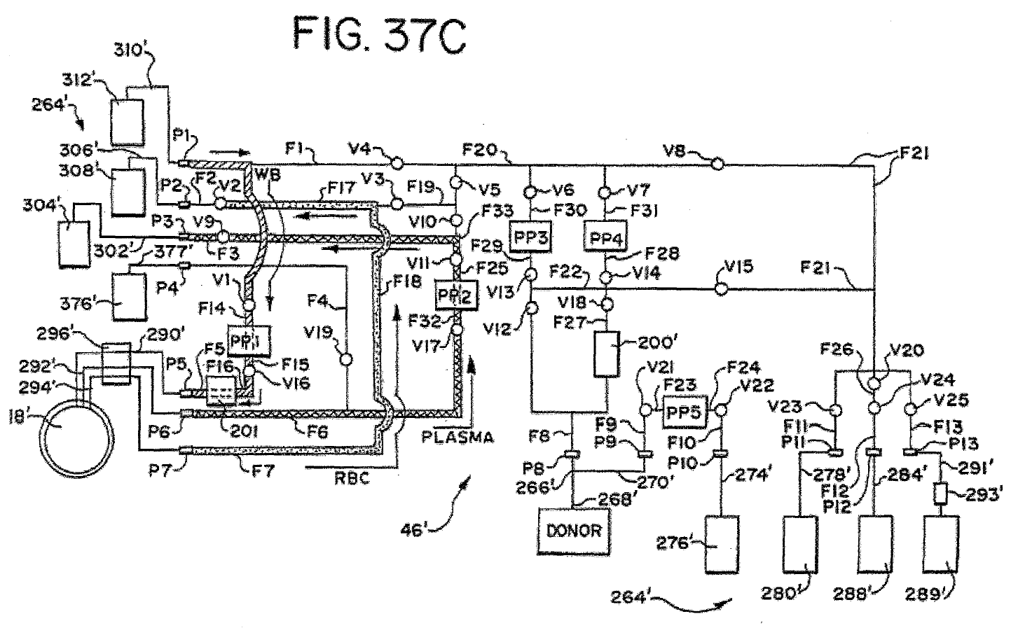

In another alternative flow arrangement (see FIG. 32), the second passage 144 extends from the hub 120 into the channel 126 in a direction different than the first and third passages 142 and 146. In this arrangement, the wall 136 (e.g., terminus wall) separates the first and third passages 142 and 146, and the second passage 144 communicates with the channel 126 at a location that lays between the first and third passages 142 and 146. In this arrangement, the umbilicus 296 conveys whole blood into the channel 126 through the third passage 146. The processing chamber 18 is rotated (arrow R in FIG. 32) in the same direction as blood flow (which is clockwise in FIG. 32). Alternatively, the chamber 18 can be rotated in a direction opposite to the circumferential flow of whole blood, i.e., counterclockwise. The whole blood separates as a result of centrifugal forces in the manner shown in FIG. 15A. Red blood cells are driven toward the outside annular wall 124, while lighter plasma constituent is displaced toward the inside annular wall 122 (e.g., low-G wall).

In this flow pattern, the second passage 144 conveys plasma from the channel 126, while the first passage 142 conveys red blood cells from the channel 126.

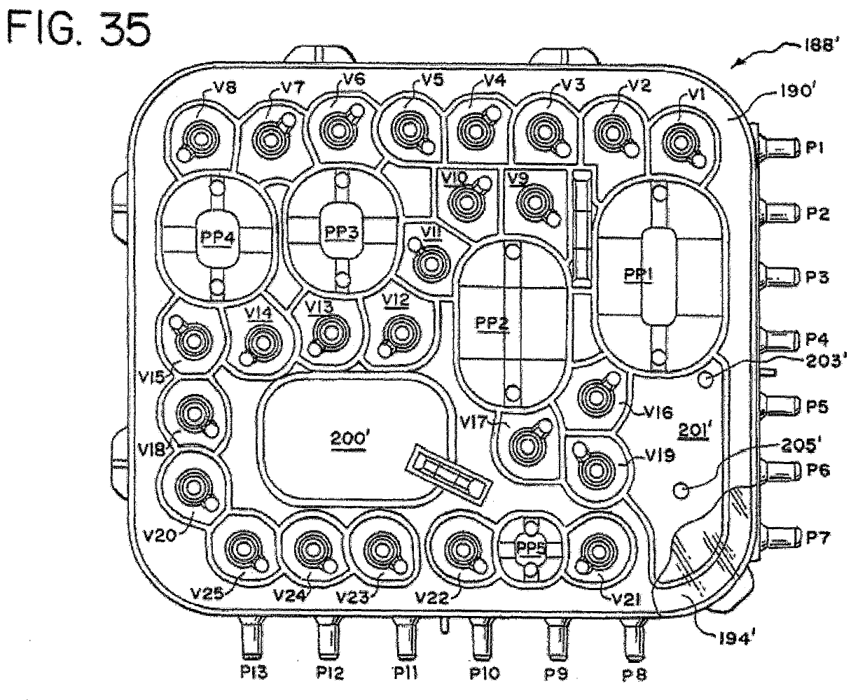

As previously mentioned, in any of the flow patterns shown in FIGS. 28 to 32, the chamber 18 can be rotated in the same direction or in an opposite direction to circumferential flow of whole blood in the channel 126. Blood separation as described will occur in either circumstance. Nevertheless, it has been discovered that, rotating the chamber 18 in the same direction as the flow of whole blood in the channel 126 during separation, appears to minimize disturbances, e.g., Coriolis effects, resulting in increased separation efficiencies.

### EXAMPLE

Whole blood was separated during various experiments into red blood cells and plasma in processing chambers 18 like that shown in FIG. 28. In one chamber (which will be called Chamber 1), whole blood circumferentially flowed in the channel 126 in the same direction as the chamber 18 was rotated (i.e., the chamber 18 was rotated in a counterclockwise direction). In the other chamber 18 (which will be called Chamber 2), whole blood circumferentially flowed in the channel 126 in a direction opposite to chamber rotation (i.e., the chamber 18 was rotated in a clockwise direction). The average hematocrit for red blood cells collected were measured for various blood volume samples, processed at different combinations of whole blood inlet flow rates and plasma outlet flow rates. The following Tables summarize the results for the various experiments.

TABLE 1
(Flow in the Same Direction as Rotation)

| Number of Blood | Average Whole Blood | Average Hematocrit of Red |
|---|---|---|
| Samples Processed | Hematocrit (%) | Blood Cells Collected |
| 7 | 45.4 | 74.8 |
| 4 | 40 | 78.8 |

TABLE 2
(Flow in the Opposite Direction as Rotation)

| Number of Blood | Average Whole Blood | Average Hematocrit of Red |
|---|---|---|
| Samples Processed | Hematocrit (%) | Blood Cells Collected |
| 3 | 43.5 | 55.5 |
| 2 | 42.25 | 58.25 |

Tables 1 and 2 show that, when blood flow in the chamber is in the same direction as rotation, the hematocrit of red blood cells is greater than when blood flow is in the opposite direction. A greater yield of red blood cells also means a greater yield of plasma during the procedure.

### B. Alternative Molded Processing Chamber

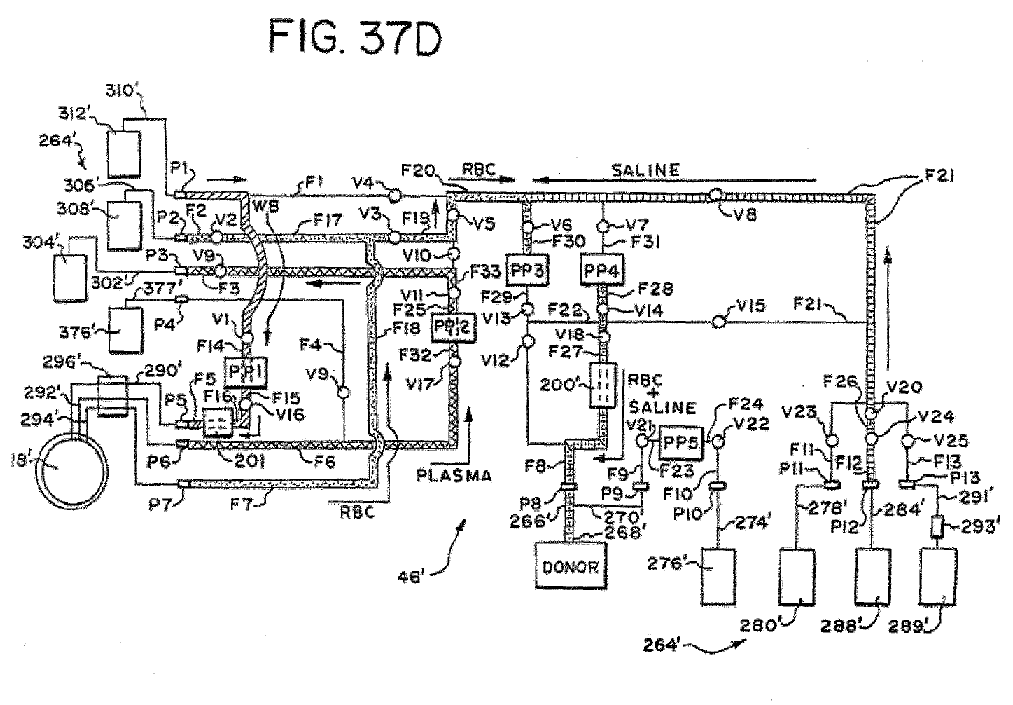

FIG. 33 shows the processing chamber 18′ having a unitary molded base or base 388′ like that shown in FIGS. 21 to 23, but in which first and second flow paths 126′ and 390 are formed. The flow paths 126′ and 390 are shown to be concentric, but they need not be. The processing chamber 18′ shares many other structural features in common with the chamber 18 shown in FIG. 23. Common structural features are identified by the same reference number marked with an apostrophe.

The base 388′ includes a center hub or hub 120′ which is surrounded radially by inside and outside annular walls 122′ and 124′, defining between them the first flow path 126′ (e.g., circumferential blood separation channel). In this example, a second inside annular wall 392 radially surrounds the hub 120′. The second flow path 390 (e.g., second circumferential blood separation channel) is defined between the inside annular walls 122′ and 392. This construction forms the first and second flow paths 126′ and 390 (e.g., concentric outside and inside separation channels).

An interruption 394 in the inside annular wall 122′ adjacent to a dam 384′ establishes flow communication between the first flow path 126′ (e.g., outside channel) and the second flow path 390 (e.g., inside channel). An interior wall 396 blocks flow communication between the flow paths 126′ and 390 at their opposite ends.

As the processing chamber 18′ rotates (arrow R in FIG. 33), the umbilicus 296 conveys whole blood into the first flow path 126′ (e.g., outside channel) through a second passage 144′. The whole blood flows in the first flow path 126′ in the same direction as rotation (which is counterclockwise in FIG. 33). Alternatively, the processing chamber 18′ can be rotated in a direction opposite to the circumferential flow of whole blood, i.e., clockwise. The whole blood separates in the first flow path 126′ (e.g., outside channel) as a result of centrifugal forces in the manner shown in FIG. 15A. Red blood cells are driven toward the outside annular wall 124′ (e.g., high-G wall), while lighter plasma constituent is displaced toward the inside annular wall 122′ (e.g., low-G wall).

As previously described, the dam 384′ prevents passage of plasma, while allowing passage of red blood cells into a channel 386′ recessed in the outside annular wall 124′ (e.g., high-G wall). The channel 386′ directs the red blood cells into the umbilicus 296 through a first passage 142′ (e.g., radial passage). The plasma constituent is conveyed from the first flow path 126′ through the interruption 394 into the second flow path 390 (e.g., inside separation channel).

The plasma flows circumferentially through the second flow path 390 (e.g., inside channel) in a direction opposite to the whole blood in the first flow path 126′ (e.g., outside channel). Platelets remaining in the plasma migrate in response to centrifugal forces against the outside annular wall 124′. The second flow path 390 directs the plasma constituent to the same end of the processing chamber 18′ where whole blood is initially introduced. The plasma constituent is conveyed from the second flow path 390 by a third passage 146′.

### C. Another Alternative Molded Processing Chamber

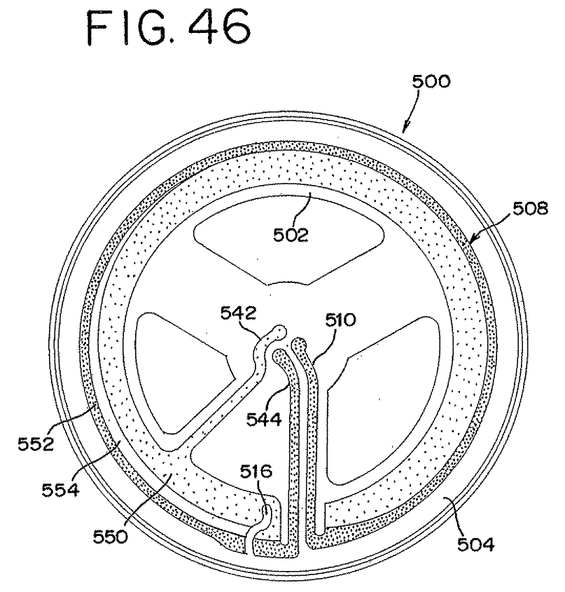

FIGS. 44-46 illustrate a further example of a chamber 500. The chamber 500 includes an inner side wall portion or first lateral wall 502 (e.g., low-g wall) spaced at a distance from an outer side wall portion or second lateral wall 504 (e.g., high-g wall). Generally, in operation, the distance between the first and second lateral walls 502 and 504 enable at least one therapeutic unit of single dose platelets to be pooled upstream of a barrier 516 without causing an overspill or underspill condition. The amount associated with one therapeutic unit may vary depending on the country. For example, in some countries one therapeutic unit may be, for example, 1.5×10¹¹ platelets, while in other countries, one therapeutic unit may be, for example, 3×10¹¹ platelets. Additionally or alternatively, the distance between the first and second lateral walls 502 and 504 enable at least approximately 6×10¹¹ platelets or 7×10¹¹ platelets to be pooled upstream of the barrier 516 without causing an overspill or underspill condition (e.g., spilling into a first outlet 542 or a second outlet 544).

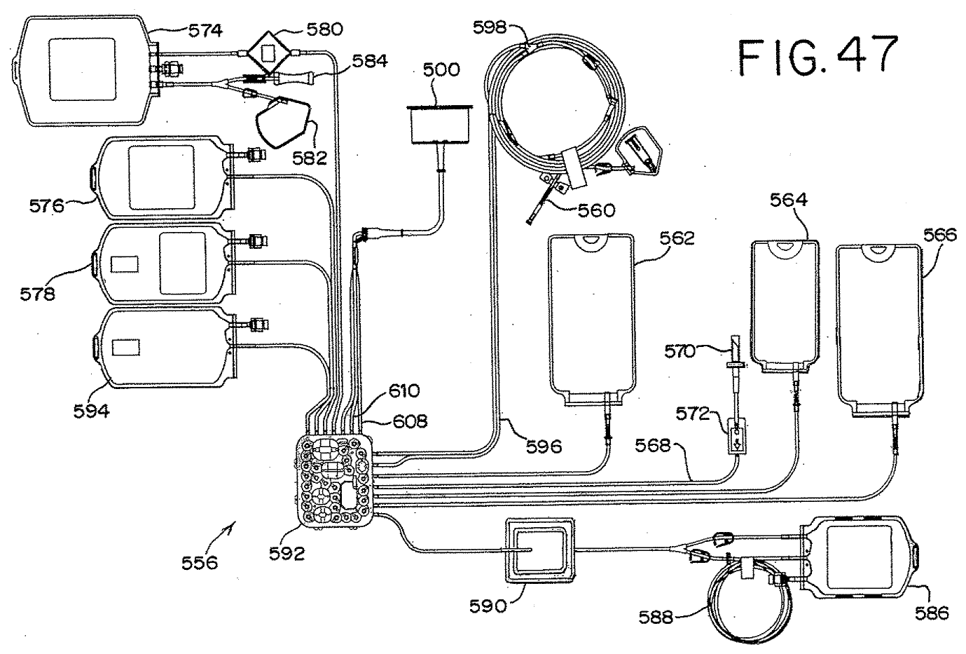

The chamber 500 includes a first end wall or base 506 and a second end wall (not shown), opposite the first end wall 506, both of which are to be positioned adjacent and/or coupled to the lateral walls 502 and 504. The lateral walls 502 and 504 and the first end wall 506 define a channel 508 through which fluids are to flow. Generally, as depicted in FIGS. 44 and 45, the first lateral wall 502 may be an interior wall of the channel 508, the second lateral wall 504 may be an exterior wall of the channel 508 and the first end wall 506 may be a bottom of the channel 508.

In some examples, the channel 508 may have varying thickness. Specifically, the channel 508 may have a first thickness 1402 adjacent a channel inlet region 1404 (e.g., upstream end of the channel 508) and a second thickness 1406 adjacent a channel outlet region 1408 (e.g., downstream end of the channel 508). A difference between the first and second thicknesses 1402 and 1406 may define an edge or step 1410 adjacent an opening 546 of a first outlet channel 1412 formed between a first radial wall 1414 and a second radial wall 1416. The step 1410 may be engaged by at least a portion of the separated plasma prior to entering the first fluid outlet channel 1412. In operation, the first outlet channel 1412 may convey separated plasma from the channel 18 to the first outlet 542.

An inlet channel 510 (e.g., whole blood inlet) having an inlet 1403 is defined between a third radial wall 512 and a fourth radial wall 514. To separate the channel inlet region 1404 from the channel outlet region 1408, the third radial wall 512 joins and/or engages the second lateral wall 504. The fourth radial wall 514 protrudes slightly into the channel 508 such that a distance between an end 4504 (FIG. 45) of the third radial wall 512 and the second lateral wall 504 is relatively less than the first thickness 1402. The position of the third radial wall 512 relative to the second lateral wall 504 enables fluid entering the channel 508, via the inlet channel 510, to initially be positioned adjacent to and/or engage the second lateral wall 504 as opposed to the first lateral wall 502.

The dam or barrier 516 extends into the channel 508 from the second lateral wall 504 toward the first lateral wall 502 adjacent the channel outlet region 1408. The barrier 516 includes a first portion 1415 that may be approximately parallel to an extension 538 (e.g., interior radial wall extension) of a fifth radial wall 1413. Additionally, the barrier 516 includes a second portion 1417 that may extend partially at an angle toward the extension 538. The position of the second portion 1417 relative to the first lateral wall 502 and the extension 538 defines a first gap 4506 and a second gap 4508, respectively. The barrier 516 includes an upstream side or first surface 518 and a downstream side or second surface 520.

An underpass 522 fluidly couples the upstream and the downstream sides 518 and 520 of the barrier 516. In FIG. 45, the underpass 522 is located at an intermediate axial position spaced above the first end wall portion 506 (e.g., bottom end wall) and spaced below the top end wall (not shown). The underpass 522 includes a first portion or downstream portion 4510 and a second portion or upstream portion 4512. The first portion 4510 of the underpass 522 is positioned adjacent a first section 524 (e.g., radially outward section) of the second lateral wall 504. The first section 524 includes a tapered surface 1418 that extends slightly toward an edge 1420 of the chamber 500 and a surface 1422. The tapered surface 1418 and the surface 1422 define a first indentation or recess 1424 adjacent the upstream side 518 of the barrier 516. The second portion 4512 of the underpass 522 is positioned adjacent a second section 526 (e.g., radially outward section) of the second lateral wall 504. The second section 526 includes a surface 1426 that, along with the downstream side 520 of the barrier 516, define a second indentation or recess 1428. Generally, the first and second recesses 1424 and 1428, formed at least partially via the second lateral wall 504, extend radially outward from a portion of the second lateral wall 504 relatively more upstream from the barrier 516. The tapered surface 1418 and the surfaces 1422 and 1426 may form an outer radial surface of the under pass 522 (e.g., the sections 524 and 526 are shown removed in FIG. 45). Additionally, a formation 4514 defines an inner radial surface 4516 of the underpass 522. The inner radial surface 4516 is positioned at a distance from the second lateral wall 504.

The second gap 4508, between the second portion 1417 of the barrier 516 and the first lateral surface 502, at least partially creates a low-g flow path 528 to enable fluid to flow through the second gap 4508 between the upstream and downstream sides 518 and 520 of the barrier 516. Generally, as shown in FIG. 44, an opening 530 of the low-g flow path 528 enables fluid to flow into the low-g flow path 528 from a more upstream location of the channel 508. The low-g flow path 528 may be defined by the first lateral wall 502, a surface 532 (e.g., intermediate end wall portion, a lower axial surface) of the formation 4514 and a surface (not shown) of the second end wall (not shown), which may be positioned adjacent (e.g., on top of) the chamber 500, as depicted in FIGS. 44 and 45. Additionally, the low-g flow path 28 may include a non-radial portion 534 and a radial portion 536. The non-radial portion 534 may be defined by the first lateral wall 502 and a radially inward surface 1430 of the barrier 516 and the first lateral wall 502. The radial portion 536 may be defined by the downstream side 520 of the barrier 516 and the extension 538 of the fifth radial wall 1413. The extension 538 extends toward the second lateral wall 404 such that an end or outer edge 540 of the extension 538 is positioned at a distance from both the first and second lateral walls 502 and 504 (e.g., at a position between the lateral walls 502 and 504).

The chamber 500 includes the first outlet 542 positioned adjacent the first outlet channel 1412 and the second outlet 544 positioned adjacent a second outlet channel 1432. The second outlet channel 1432 is defined by the third and fifth radial walls 512 and 1413, respectively. In operation, the second outlet channel 1432 may convey separated red blood cells from the channel 18 to the second outlet 544.

The opening 546 of the first outlet channel 1412 and, thus, the first outlet 542 (e.g., plasma outlet) is positioned upstream from the barrier 516. An opening 548 of the second outlet channel 1432 and, thus, the second outlet 544 (e.g., red blood cell outlet) is positioned downstream from the barrier 516. Generally, the first and second outlet channels 1412 and 1432 extend radially inward from the channel 508. Specifically, the opening 546 of the first outlet channel 1412, which in this example includes the step 1410 formed via the first radial wall 1414, is positioned adjacent the first lateral wall 502 between the first and second radial walls 1414 and 1416. The opening 548 of the second outlet channel 1432 is positioned adjacent the second lateral wall 504 between the third and fifth radial walls 512 and 1413 such that the opening 548 is fluidly coupled to the downstream side 520 of the barrier 516, via the underpass 522. While the opening 546 of the first outlet channel 1412 is depicted as being positioned at approximately a forty degree angle relative to the opening 548 of the second outlet channel 1432 in FIGS. 44-46, the opening 546 of the first outlet channel 1412 may be positioned between about a thirty degree angle and a sixty degree angle or any other angle (e.g., 5, 10, 15, 20, etc.) relative to the opening 548 of the second outlet channel 1432. Generally, the position of the opening 546 of the first outlet channel 1412 relative to the opening 548 of the second outlet channel 1432 may reduce the amount of white blood cell contamination of the collected platelets, which are to pool upstream of the barrier 516.

A lip 4518 of the chamber 500 is configured to be engaged by gripping tabs (e.g., similar to the gripping tabs 382) of a rotor plate (e.g., similar to the rotor plate 166). Additionally, the chamber 500 may includes a receptacle (e.g., similar to the receptacle 197) to receive a mount (e.g., similar to the mount 178) of the umbilicus (e.g., similar to the umbilicus 296).

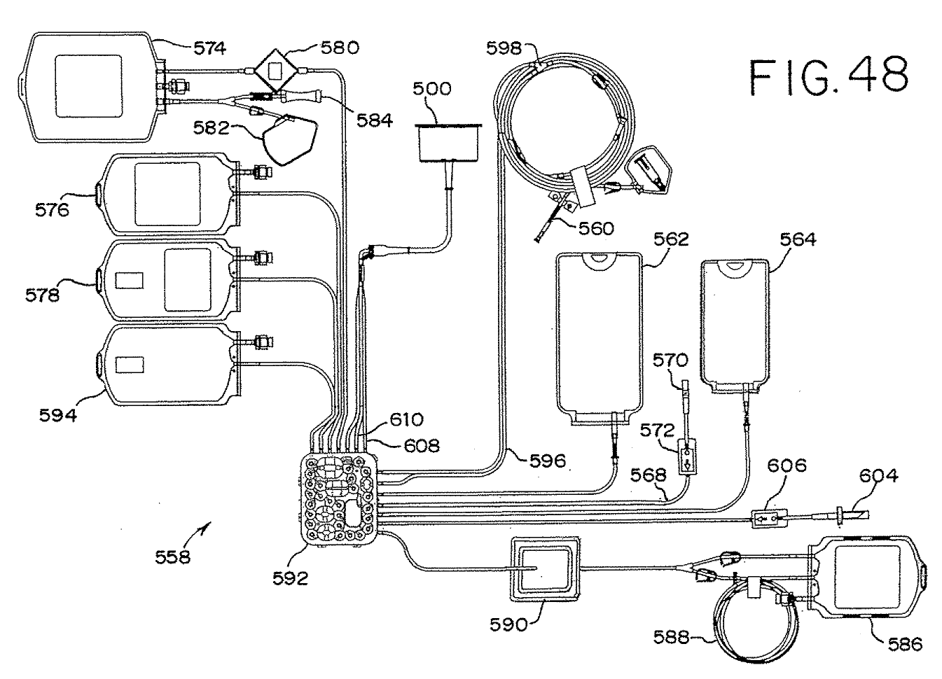

FIG. 46 shows the relative positions of plasma 550 and red blood cells 552 during normal conditions where an interface 554 is located radially intermediate the inner (e.g., low-g) and outer (e.g., high-g) wall portions 502 and 504. Plasma or a plasma/platelet layer is collected through the opening 546 in the first outlet 542 upstream of the barrier 516. As used herein, the term “plasma/platelet layer” refers to a layer containing primarily platelets and plasma. However, as will be clear from the description which follows, the constitution of the plasma/platelet layer is not limited to plasma and platelets, but may also contain amounts of white blood cells, anticoagulant, and (depending on the particular method employed) a platelet storage solution.

Further downstream, a portion of the plasma 550 is also permitted to flow into the opening 530 and through at least a portion of the low-g flow path 528. The extent of such plasma flow into the low-g flow path 528 will depend on the location of the interface 554 between the plasma and red blood cells. For example, the interface between the plasma and red blood cells is advantageously located at or near the outer edge 540 of the interior radial wall extension 538 during normal conditions. During such conditions, plasma flowing into the low-g flow path 528 will remain radially inward of the outer edge 540 until further processing steps are performed to move the interface and allow collection thereof. The red blood cells 552 are permitted to flow through the underpass 522 to the downstream side of the barrier 516, and exit the channel 508 through the second outlet 544.

### VIII. Red Blood Cell/Platelet/Plasma Collection

The processing chamber of FIGS. 44-46 is particularly well-suited for use in a procedure for collecting red blood cells/platelets/plasma from a blood source and reference will be made thereto for illustrative purposes, however the procedure which follows is not limited to any particular processing chamber.

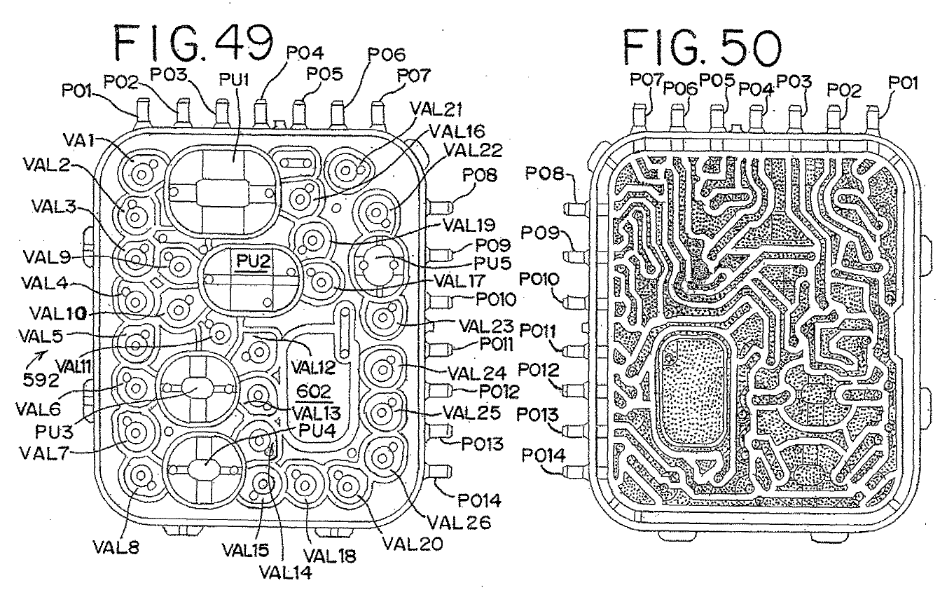

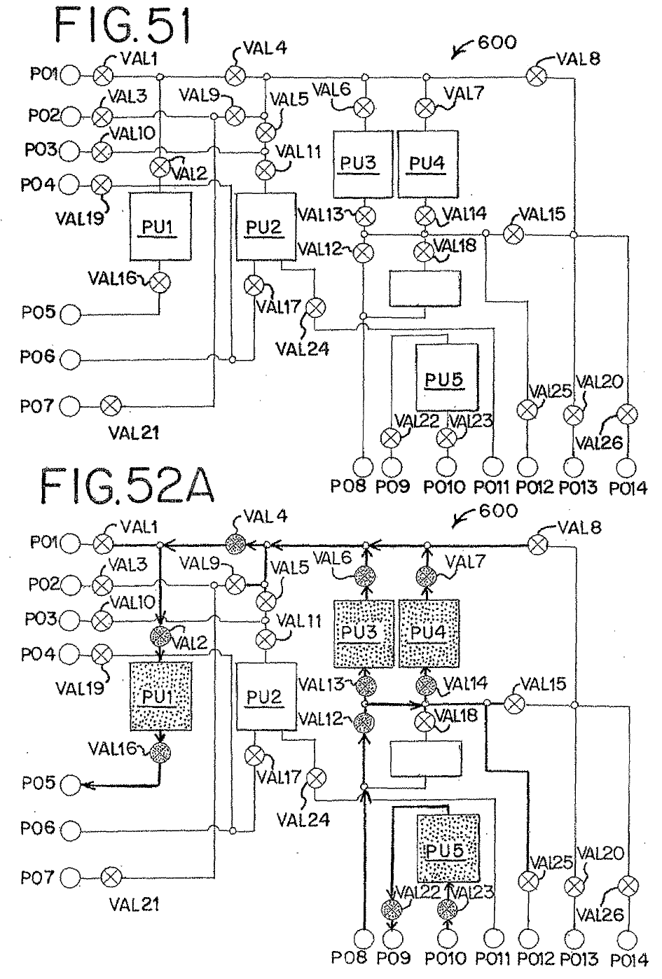

Disposable sets 556 and 558 (FIGS. 47 and 48) are suitable for use in the red blood cell/platelet/plasma collection procedure which follows. Except where noted otherwise, the individual components of the disposable sets are well-known to those having skill in the art and can be understood with reference to the corresponding components described above for use with the foregoing blood component collection procedures.

In one example, the disposable set 556 includes an access needle 560, an anticoagulant container 562, a red blood cell additive solution container 564, and a saline container 566. The disposable set 556 further includes tubing 568 leading to a connection device 570 (e.g., a spike in FIG. 47 or a luer connector in FIG. 48) for connection to a platelet storage solution container (not illustrated), if platelet storage solution is to be used. The illustrated tubing 568 includes an in-line sterility filter 572 to prevent contamination and maintain an effectively closed system. The disposable set 556 also includes a platelet collection container 574, a plasma collection container 576, and a red blood cell collection container 578 for collecting the blood components that are separated by the chamber 500. The platelet collection container 574 is illustrated with an associated in-line leukoreduction filter 580, an air burp bag 582, and a sampling pack 584. The red blood cell storage container 586, including segmented tubing 588 and an in-line leukoreduction filter 590, is also included for post-separation storage of the red blood cells, as will be described in greater detail herein.

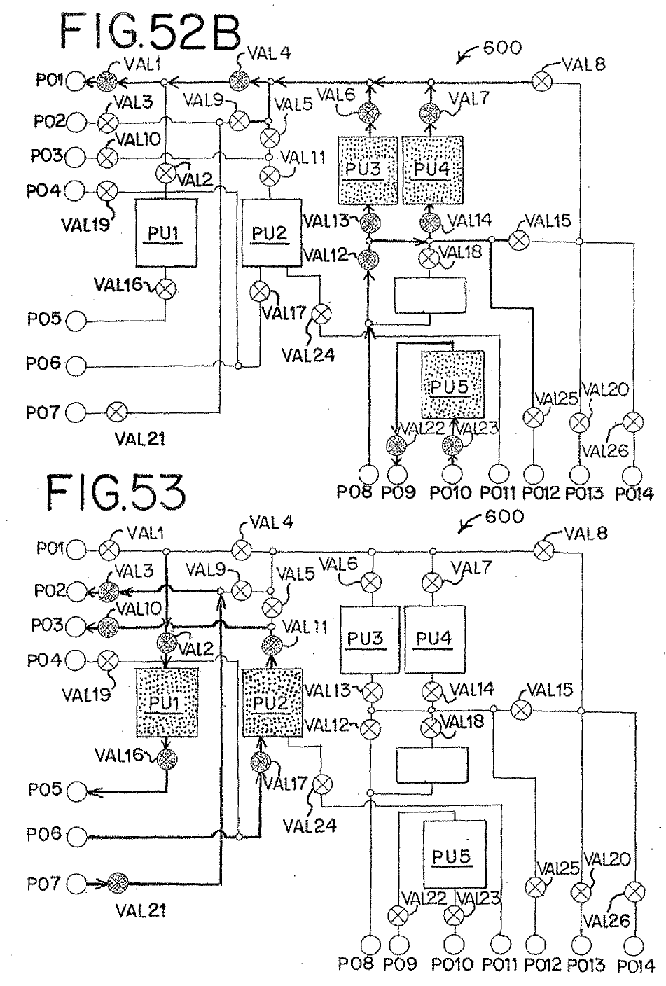

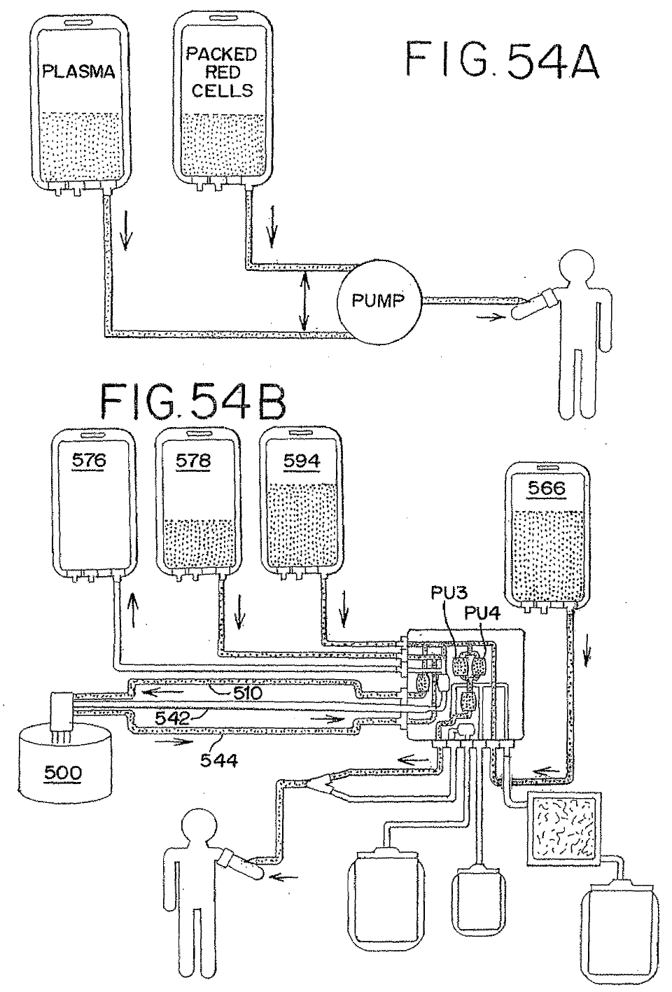

The various components of the disposable set 556 are connected via tubing to a cassette 592, which is shown in greater detail in FIGS. 49 and 50. It will be seen that the illustrated cassette 592 has fourteen ports PO1-PO14, in contrast to the 13-port cassettes 28 and 28′ illustrated in FIGS. 6-9 and 35-36 (respectively) and described with reference to the foregoing blood component collection procedures. The cassette 592 (e.g., 14-port cassette) operates according to the foregoing description of the 13-port cassettes 28 and 28′, including a total of twenty-six valves VAL1-VAL26 to allow for an additional port PO14 to communicate with the thirteen other ports PO1-PO13. Of course, the corresponding manifold assembly (not illustrated) includes 26 valve actuators, similar to the pneumatic manifold assembly 226′ of FIG. 43 and works according to the foregoing description of the pneumatic manifold assembly 226′.

More particularly, the cassette 592 includes ports PO1-PO14, each associated with a component of the disposable set via a length of tubing. Those having skill in the art will appreciate that each port may be associated with a variety of components and tasks, but in the illustrated example, the first port PO1 is associated with an in-process container 594. The second port PO2 is associated with the red blood cell collection container 578. The third port PO3 is associated with the plasma collection container 576. The fourth port PO4 is associated with the platelet collection container 574. The fifth port PO5 is associated with the inlet 510 (e.g., whole blood inlet) of the chamber 500. The sixth port PO6 is associated with the first outlet 542 (e.g., plasma outlet) of the chamber 500. The seventh port PO7 is associated with the second outlet 544 (e.g., (red blood cell outlet) of the chamber 500. The eighth port PO8 is associated with the access needle 560. The ninth port PO9 is associated with tubing 596 leading to a y-connector 598 for adding anticoagulant to whole blood from the blood source. The tenth port PO10 is associated with the anticoagulant container 562. The eleventh port PO11 is associated with the platelet additive solution container (not illustrated). The twelfth port PO12 is associated with the red blood cell additive solution container 564. The thirteenth port PO13 is associated with the saline container 566. The fourteenth port PO14 is associated with the red blood cell storage container 586.

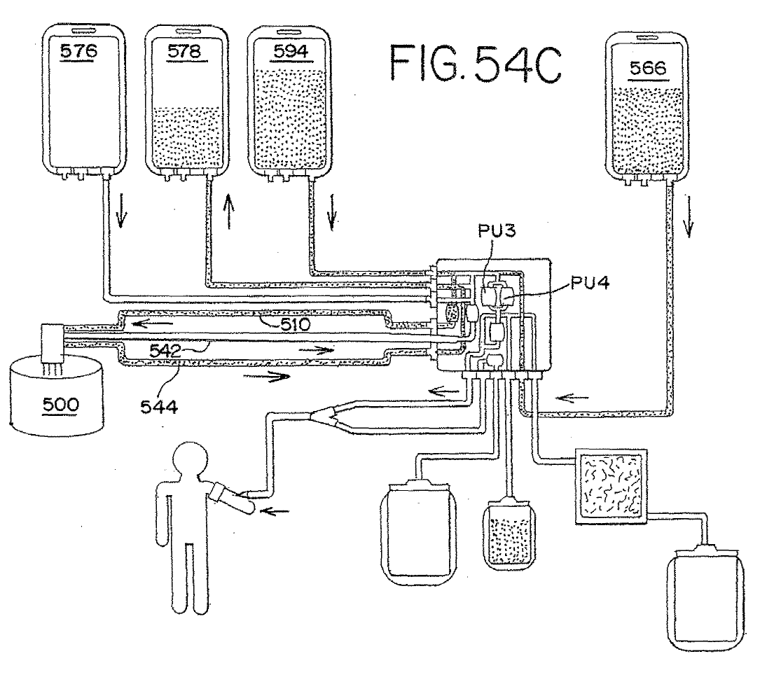

The various ports are fluidly connected to each other by flow paths defined by the cassette 592, which flow paths are regulated by valves VAL1-VAL26. The flow paths and other cavities defined by the raised cassette walls are shown with stippling in FIG. 50 to distinguish them from the walls. The location of the valves within the cassette 592 is best illustrated in FIG. 49, while the function of each valve can be understood with reference to a flow circuit 600 of FIG. 51.

In addition to defining a plurality of flow paths and valves, the cassette 592 further defines a plurality of pumps PU1-PU5 and a filter cavity 602. The pumps and filter cavity correspond generally to those described above with regard to the cassette 28′ of FIGS. 35-36. More particularly, the first pump PU1 is an in-process pump, the second pump PU2 is a plasma pump, the third and fourth pumps PU3 and PU4 are donor pumps, and the fifth pump PU5 is an anticoagulant pump. The filter cavity 602 forms a station that may hold a blood filter material to remove clots and cellular aggregations that can form during blood processing.

As for the disposable set 558 of FIG. 48, it is similar to the disposable set 556 of FIG. 47, with the exception that the saline container is omitted and replaced by a spike 604 and an in-line sterility filter or filter 606. The spike 604 allows a separate saline container to be connected to the disposable set 558, while the filter 606 maintains an effectively closed system. Other disposable sets may also be employed without departing from the scope of the present disclosure.

### A. Pre-Processing

Prior to processing, an operator selects the “RBC/Platelet/Plasma” protocol from a touch screen display or other user interface system. If the blood source is a donor, the operator then proceeds to enter various parameters, such as the donor gender/height/weight. In one example, the operator also enters the target yield for the various blood components. In an exemplary procedure, the pre-selected yields are one unit each of single dose platelets, packed red cells, and platelet poor plasma. As will be described in greater detail herein, an amount of plasma may be used to harvest platelets and packed red cells from the chamber and act as a platelet storage fluid, so it may be advantageous to specify an additional amount of plasma (e.g., approximately 335 ml extra-300 ml to harvest and store the platelets and 35 ml to harvest the packed red cells) to ensure that one unit remains in the collection container after the platelets and packed red cells have been harvested.

The operator also selects the collection control system, which may be based on, for example: (1) the amount of whole blood to process, (2) a donor platelet pre-count and the target platelet yield, or (3) the target platelet yield. The third option is used when a donor platelet pre-count is not available and implicates use of an online estimator, whereby a volume of whole blood is processed and optical measurements are taken to estimate the platelet pre-count and/or the amount of whole blood that is processed to achieve the target platelet yield. The online estimator will be described in greater detail herein.

Further, before processing begins, any separate containers (e.g., a platelet storage solution container) are connected to the disposable set, the disposable set is secured to the blood processing system (e.g., one according to the foregoing description of system 10), an integrity check of the disposable set is performed, the blood source is connected to the disposable set (e.g., by phlebotomizing a donor), and the chamber 500 is primed by saline from the saline container 566.

### B. Draw Stage

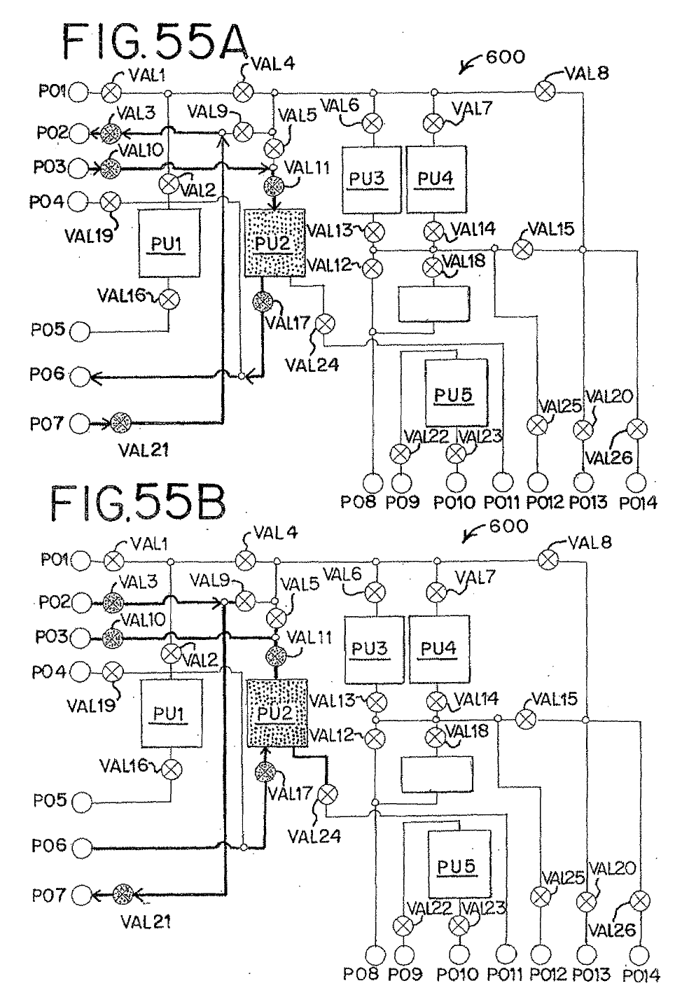

FIGS. 52A and 52B show whole blood being pumped from the blood source (port PO8) into the chamber 500 (port PO5) and the in-process container 594 (port PO1), respectively. Anticoagulant from the anticoagulant container 562 (port PO10) is added to the whole blood (via port PO9) by operation of the anticoagulant pump PU5. The anticoagulated blood may flow into the chamber 500 either from the blood source, or may flow from the in-process container 594, where the blood from the blood source is temporarily stored for subsequent processing by the chamber 500. In one example, blood is drawn from the source by one of the donor pumps PU3/PU4 while the other donor pump PU3/PU4 expels the blood to the chamber 500 (port PO5) or the in-process container 594 (port PO1). This allows for simultaneous blood draw and pumping to the chamber 500 or the in-process container 594.

In one example, the blood is alternately pumped to the chamber 500 (FIG. 52A) and then to the in-process container 594 (FIG. 52B) at a particular ratio (e.g., 9:1) to fill both at the same time. In FIG. 52A, the whole blood that is sent to the chamber 500 is directed there by the pumping of the in-process pump PU1, through the inlet 510 (e.g., chamber inlet) (port PO5). The in-process container 594 allows blood to be simultaneously pumped into the chamber 500 (from the in-process container 594) while excess blood components are returned to the blood source, as will be described in greater detail herein.

### C. Separation Stage

Within the chamber 500, separation of the fluid components occurs based on density, as shown in FIG. 46, while the chamber spins at a “hard spin” rate of, for example, approximately 4500 RPM. It is noted that the angular velocities used herein conventionally are “two omega” (i.e., the spin speed of the chamber itself) although “one omega” (i.e., the speed at which the umbilicus is orbited around the chamber) may also be used, as well as some combination thereof. Further detail of this separation is set forth in Brown, “The Physics of Continuous Flow Centrifugal Sell Separation,” Artificial Organ, 13(1):4-20 (1989). A higher density component such as the red blood cells 552 is forced towards the outer or high-side wall portion and a lower density component such as the plasma 550 (e.g., platelet poor plasma) is forced towards an inner or low-g side wall portion. The interface 554 between the red blood cells and the plasma contains a buffy coat layer which includes at least a portion of platelets and white blood cells, although the components of the interface will vary based on the particular procedure employed.

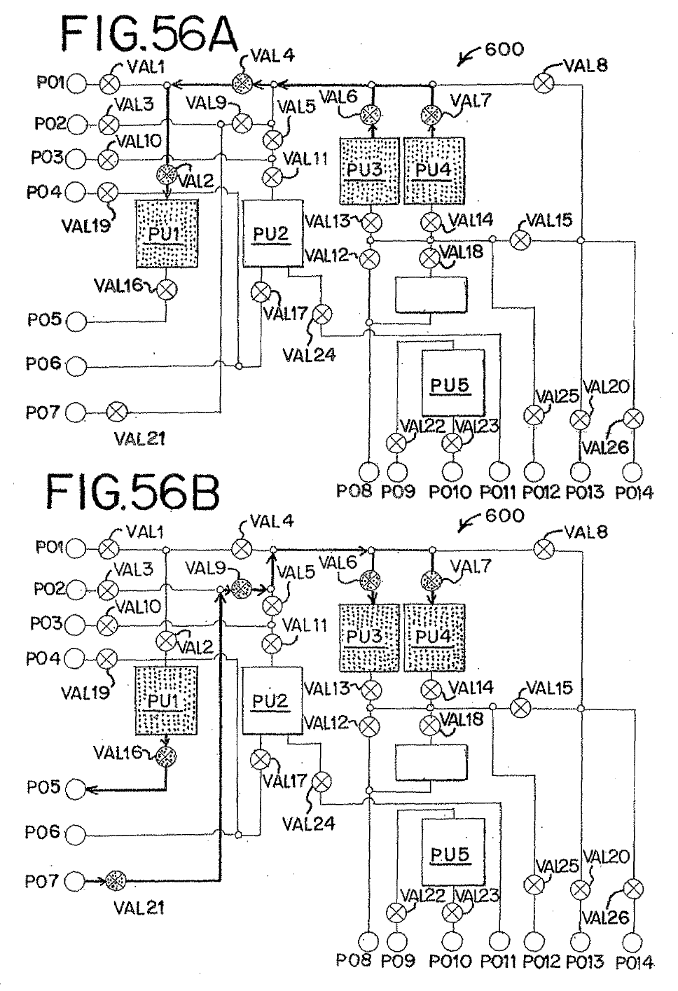

As the interface is pooling upstream of the barrier 516, fluid may be collected separately from either side of the interface—or both sides thereof—through the respective outlet 542 or 544 depending on the requirements of the procedure. For example, in one example shown in FIG. 53, some platelet poor plasma is collected radially inward of the interface through the first outlet 542 (e.g., plasma outlet) (port PO6) and conveyed into the plasma collection container 576 (port PO3). Simultaneously, some red blood cells are collected radially outward of the interface through the second outlet 544 (e.g., red blood cell outlet) (port PO7) and conveyed into the red blood cell collection container 578 (port PO2). The barrier 516 in the chamber 500 allows accumulation of platelets which are contained in the buffy coat/interface during such plasma or red blood cell collection, but platelet collection is not yet initiated.

In one example, the stages of drawing whole blood into the chamber and collecting platelet poor plasma and red blood cells (while retaining buffy coat in a pool upstream of the barrier 516) are repeated until a predetermined amount of platelets is present in the pooled buffy coat. The amount of platelets that may be pooled in the chamber without causing an overspill or underspill condition depends, in part, upon the distance between the low-g and high-g walls. In one example, the low-g and high-g walls are sufficiently spaced from each other to allow for at least one therapeutic unit of single dose platelets or 6×10¹¹ platelets to be pooled upstream of the barrier without causing an overspill or underspill condition. In another example, the low-g and high-g walls are sufficiently spaced from each other to allow for at least approximately 7×10¹¹ platelets to be pooled upstream of the barrier without causing an overspill or underspill condition. As an additional benefit of such a channel configuration, the interface will be farther spaced from the first outlet 542 (e.g., plasma outlet), resulting in less white blood cell contamination of the collected platelets.

### D. Return Stage

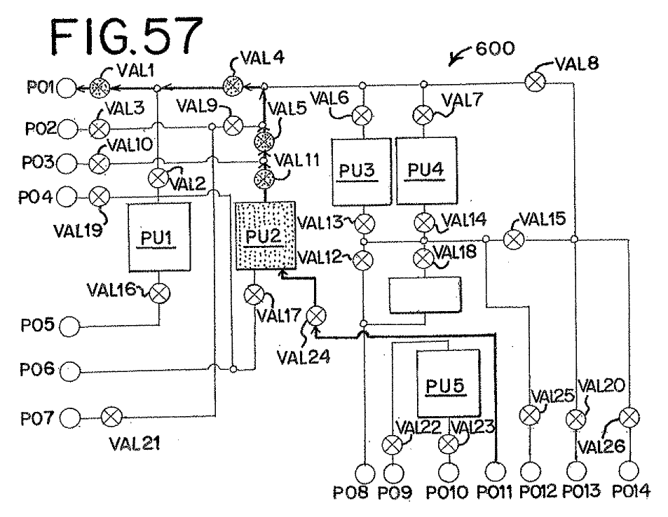

Typically, the amount of blood that is processed to collect one therapeutic unit of single dose platelets results in a surplus of separated platelet poor plasma and red blood cells. Accordingly, periodically during the pooling process, while whole blood is being pumped from the in-process container 594 (port PO1) to the chamber 500 (port PO5), an amount of the collected platelet poor plasma and red blood cells may be returned to the blood source. This may be achieved according to conventional methods, i.e., returning the plasma and red blood cells separately with saline or, more advantageously, the returning plasma and red blood cells may be interleaved as they are being returned to the blood source. An illustrative interleaving process is shown in FIGS. 54A-54C.

In one phase of the interleaving process (FIG. 54B), red blood cells from the red blood cell collection container 578 are returned to the blood source by operation of the donor pumps PU3 and PU4 during a red blood cell pumping interval. As illustrated, red blood cells from the second outlet 544 (e.g., red blood cell outlet) and/or saline from the saline container 566 may also be returned to the donor at this time. This phase operates for a selected number of pump strokes while separated platelet poor plasma from the chamber is directed into the plasma collection container 576.

Once the foregoing phase has been completed, a second phase (illustrated in FIG. 54C) is initiated. In this phase, plasma from the plasma collection container 576 is returned to the donor by operation of the donor pumps PU3 and PU4 during a plasma pumping interval. As illustrated, plasma from the first outlet 542 (e.g., plasma outlet) and/or saline from the saline container 566 may also be returned to the donor at this time. This phase operates for a selected number of pump strokes while separated red blood cells from the chamber are directed into the red blood cell collection container 578.

These two phases are alternated repeatedly to return any excess plasma and red blood cells to the blood source. The duration of each pumping interval (i.e., the number of pump cycles) and, hence, the volume of plasma or red blood cells conveyed to the blood source during a particular phase, depends on the ratio of red blood cells vs. plasma to be returned to the blood source (the “interleaving ratio”), taking into account any other relevant factors as well. It will be appreciated that the resulting fluid returned to the source will be similar to anticoagulated blood, having a lower citrate concentration than plasma, thereby improving donor comfort (if the blood source is a human donor), and a lower viscosity than concentrated red blood cells, thereby decreasing the return time. Further, the return time will also be shorter than known procedures whereby saline is interleaved with the returning fluid, as no time is spent returning excess saline volume.

### E. Red Blood Cell/Platelet Flush Stage

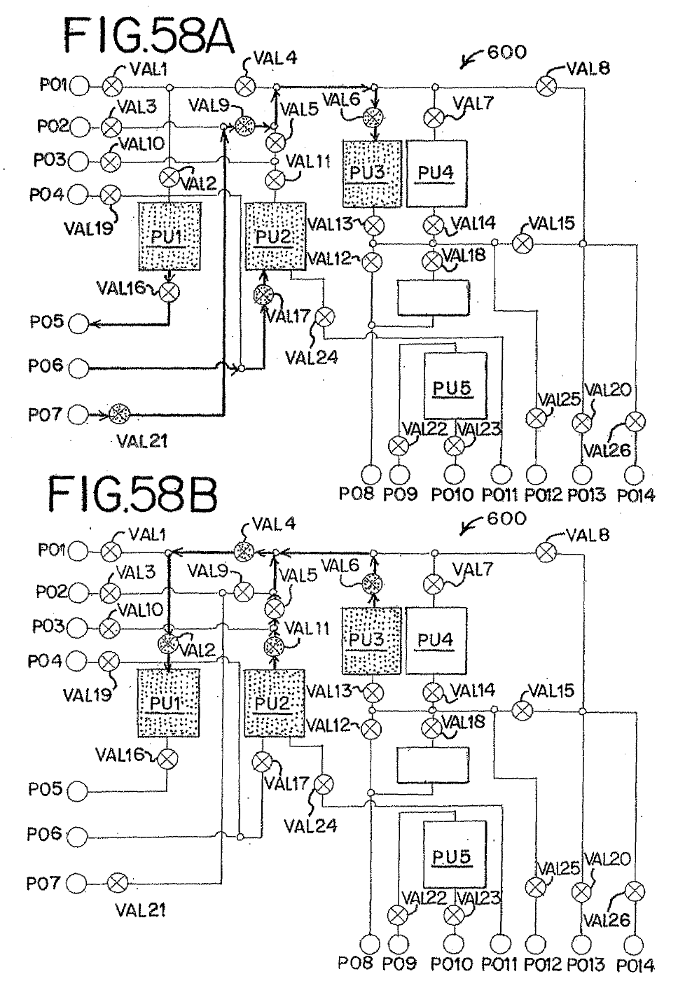

At the end of the pooling process and when it has been determined that the required amounts of plasma, red blood cells, and platelets are present in the system, it may be advantageous for an underspill condition to be imposed upon the fluid components. The underspill condition is shown in FIG. 55A. The underspill may be forced by stopping the in-process pump PU1 and reversing the plasma pump PU2, thereby causing plasma to return to the chamber 500 through the first outlet 542 (e.g., plasma outlet) (port PO6). The plasma entering the chamber 500 displaces red blood cells and buffy coat into the second outlet 544 (e.g., red blood cell outlet) (port PO7).

An optical sensor (such as the second optical sensor 336 described above) associated with tubing 608 leading away from the second outlet 544 (e.g., red blood cell outlet) detects that a portion of the interface is exiting the outlet, which usually has red blood cells exiting therethrough. The underspill condition is empirically determined based on the optical transmissivity of light through the components in the tubing 608 (e.g., outlet tubing). The optical sensor data is converted to a hematocrit. A decrease in hematocrit of the fluid moving through the tubing 608 (e.g., outlet tubing) registers as an underspill condition.

Forcing an underspill condition allows the interface to be forced radially outward as compared to the radial location of the interface during normal collection operation. The underspill condition allows removal of red blood cells into the red blood cell collection container 578 (port PO2) until the resulting fluid in the chamber has a hematocrit in a target range of, for example, approximately 20 to 40 percent.

The forced underspill may be followed by an “add RBC” phase to return a controlled amount of packed red cells from the second outlet 544 (e.g., red blood cell outlet) (port PO7) to the chamber 500, thereby ensuring that the optimal amount of red blood cells are present in the chamber. Such a procedure may be achieved by exiting platelet poor plasma from the chamber using the plasma pump PU2 while preventing flow into the chamber via the inlet 510 (e.g., whole blood inlet) (port PO5), which has the effect of drawing the last-exiting fluid from the second outlet 544 (e.g., red blood cell outlet) (port PO7) back into the chamber 500. Such a procedure is illustrated in FIG. 55B.

Once a desired hematocrit level is achieved, the fluid in the chamber 500 is advantageously kept within the desired hematocrit range. For example, the flow of plasma may be stopped to prevent flow to the plasma collection container 576 (port PO3) and the flow of red blood cells from the chamber 500 may also be stopped. Such flow may be stopped by operation of the valves and/or by stopping operation of one or more pumps, such as the plasma pump PU2. The in-process pump PU1 may continue to operate, although it may be advantageous for it to be operated at a lower flow rate.

At this time, the excess collected red blood cells and plasma may be returned to the blood source, followed by the blood source being disconnected from the system. An additional amount of red blood cells may be returned to the blood source, with the understanding that the red blood cell harvesting stage (which will be described in greater detail herein) will ultimately bring the amount of collected red blood cells up to the target yield.

### F. Recombination Stage

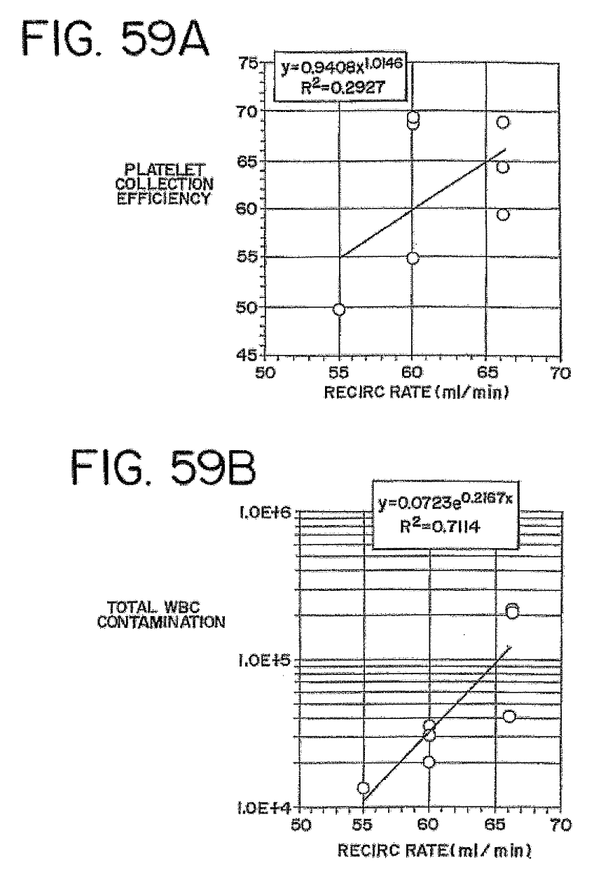

The exemplary method further includes the recombination of the separated fluid components within the chamber. In one example, recombination is performed by rotation of the chamber 500 in both clockwise and counterclockwise directions, whereby the chamber 500 is rotated alternately in clockwise and counterclockwise directions one or more times. During this recombination stage, the valves VAL17 and VAL19 associated with the first outlet 542 (e.g., plasma outlet) (port PO6) are closed, thereby causing the contents of the chamber 500 to exit or enter via the inlet 510 (e.g., whole blood inlet) (port PO5) and the second outlet 544 (e.g., red blood cell outlet) (port PO7). The donor pumps PU3 and PU4 and the in-process pump PU1 are operated to force the remaining components into and out of the chamber, as generally illustrated in FIGS. 56A and 56B.

In the phase illustrated in FIG. 56A, the contents of the donor pumps PU3 and PU4 flow to the in-process pump PU1. In the phase illustrated in FIG. 56B, the contents of the in-process pump PU1 are pumped through the chamber (in through port PO5 and out through port PO7) and into the donor pumps PU3 and PU4. These phases alternate as the chamber 500 is rotated alternately in clockwise and counterclockwise directions.

The recombination stage results in a uniform blood-like mixture which includes plasma, red blood cells, platelets, and white blood cells having an approximate chamber hematocrit as previously described. The recombination stage may last approximately one to three minutes, although this time period may vary. The rotation of the chamber in either direction may be at a rate much lower than the rate of rotation during initial separation of the components and may be, for example, in the range of approximately 300 to 600 RPM, although other rates of rotation are possible.

### G. Platelet Storage Solution Prime Stage

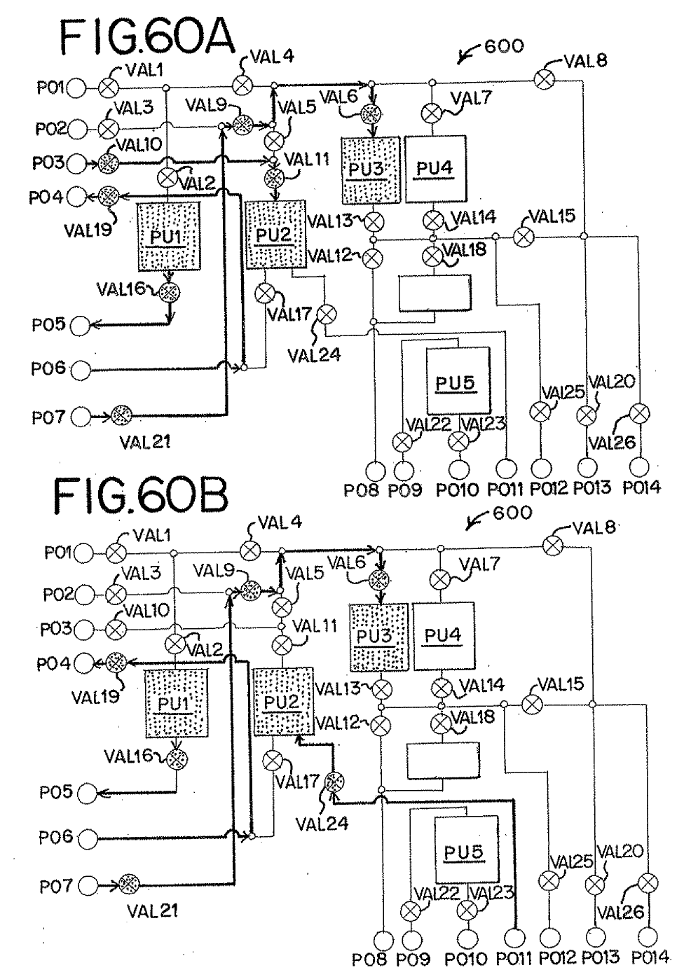

If a platelet storage fluid other than plasma (e.g., PAS III) is to be used, as will be described in greater detail herein, it may be advantageous to initiate a “platelet storage solution prime” stage after the recombination stage. Such a stage is illustrated in FIG. 57. In such a stage, an amount of (non-plasma) platelet storage solution is pumped from a platelet storage solution container (port PO1) to the in-process container 594 (port PO1) by the plasma pump PU2. This moves any air from the platelet storage solution container into the in-process container 594, ensuring that it will not remain in the flow path during the processing steps which follow.

An amount of (non-plasma) platelet storage solution may be pumped into the chamber to displace some of the plasma into the plasma collection container 576. This may be advantageous if it is desired for the resulting platelet storage solution to have a higher non-plasma platelet storage solution to plasma ratio than what is typically achieved by the present procedure.

### H. Recirculation Stage

### 1. Recirculation Phase 1

After a sufficient recombination period, the rotor is then restarted to rotate the chamber in a uniform direction, with the flow within the chamber being generally directed from the inlet 510 to the first and second outlets 542 and 544 (although fluid is still prevented from exiting the chamber via the first outlet 542 (e.g., plasma outlet)). The specific speed of the rotor may vary, but may be a “slow spin” of approximately 2500-2700 RPM, which separates a red blood cell layer from a layer containing plasma and platelets. During this time, the valves VAL17 and VAL19 associated with the first outlet 542 (e.g., plasma outlet) are closed, thereby forcing the fluid in the chamber to exit via the second outlet 544 (e.g., red blood cell outlet) (port PO7), where it is routed back into the inlet 510 (e.g., chamber inlet) (port PO5) by operation of the donor pumps PU3 and PU4 and the in-process pump PU1. The fluid flow path of this phase of the recirculation stage is identical to that of the recombination stage (FIGS. 56A and 56B) and continues for a sufficient time to allow the red blood cell layer to settle within the chamber.

### 2. Recirculation Phase 2

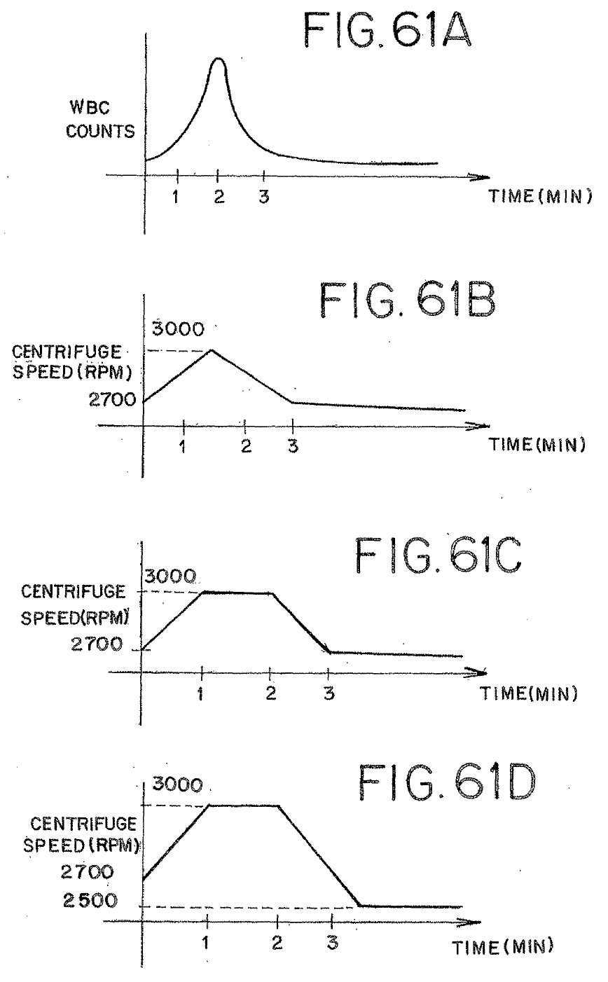

After the red blood cell layer has settled within the chamber, the first outlet 542 (e.g., plasma outlet) (port PO6) is opened to allow flow therethrough. During this phase, the red blood cell layer continues exiting the chamber via the second outlet 544 (e.g., red blood cell outlet) (port PO7), but the layer including plasma and platelets (and any non-plasma platelet storage solution) is allowed to exit the chamber via the first outlet 542 (e.g., plasma outlet) (port PO6). The red blood cell layer is directed to one of the donor pumps PU3 and the plasma/platelet layer is directed to the plasma pump PU2 (FIG. 58A).

Thereafter, the contents of the donor pump PU3 and the plasma pump PU2 are emptied into the in-process pump PU1 (FIG. 58B), which subsequently pumps the combined fluids back to the chamber 500 (FIG. 58A). These sub-phases alternate, thereby creating a recirculation loop into and out of the chamber.

During recirculation, no plasma, platelets, or red blood cells are collected. The platelet concentration in the plasma/platelet layer generally increases during this phase, with platelets from the interface becoming suspended in the plasma.

Recirculation of the components continues until an optical sensor (such as the first optical sensor 334 described above) associated with tubing 610 leading away from the first outlet 542 (e.g., plasma outlet) detects a plasma/platelet layer which has a desired concentration of platelets and which is visually low in red blood cells. As discussed above, the hematocrit of the recirculated mixture is approximately between 20-40 percent. Recirculation may also be modified so as to recirculate only one of the components, either plasma or red blood cells, as desired.

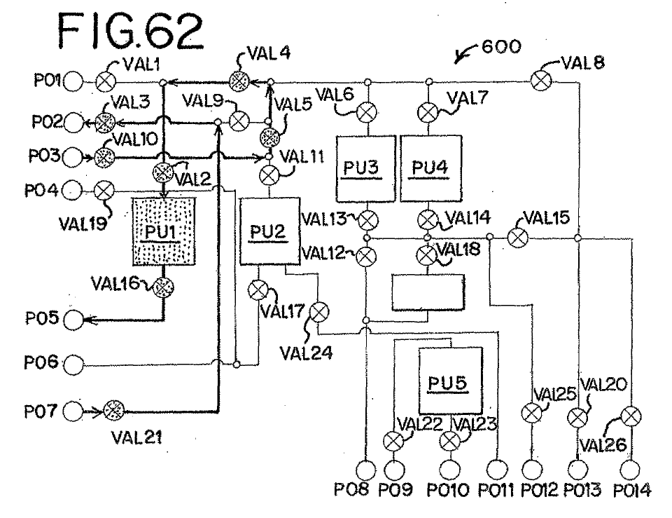

During the recirculation stage, an illustrative pump flow rate ratio of the in-process pump PU1 and plasma pump PU2 is 60/40, although other pump rates may be used depending on the particular conditions of the system. Recirculation may also allow an increasing concentration of white blood cells to settle to the interface between the plasma/platelet layer and the red blood cells. Such pump ratio has also been found to have a direct influence on the number of white blood cells that contaminate the plasma/platelet layer and the overall platelet concentration collection efficiency. By way of example and not limitation, FIGS. 59A and 59B show a collected fluid having a higher concentration of platelets (FIG. 59A) and a lower concentration of white blood cells (FIG. 59B). In FIGS. 59A and 59B, such fluid was collected from a chamber having approximately 120 cm² surface area, which was operated at a speed of approximately 2500 RPM with a chamber hematocrit of approximately 25%. Other collection efficiencies may be developed for different chamber surface areas, centrifugal speeds and chamber hematocrits.

Recirculation of the plasma/platelet layer may continue for several minutes (approximately two to four minutes in one example), which duration may vary depending upon the particular procedure. During this time, the content of the plasma/platelet layer in the tubing 610 associated with the first outlet 542 (e.g., plasma outlet) may be monitored by the aforementioned optical sensor. For best results, this monitoring is typically delayed until the plasma/platelet layer is substantially uniform. The sensor can detect the presence of platelets in the plasma, and the data collected by the sensor can be used during recirculation to calculate a number of quantities. Those having skill in the art will appreciate that the plasma/platelet layer will have a higher platelet concentration than typical “platelet rich plasma” (i.e., a plasma/platelet layer that is formed by subjecting whole blood to a “soft spin” without the prior removal of an amount of platelet poor plasma), so the signal will be stronger and the resulting data will tend to be more reliable than data collected by observing typical “platelet rich plasma.”

Among the various quantities that can be calculated, the data collected by the optical sensor can be used to estimate the current platelet yield. The difference between a baseline optical density and the detected optical density is indicative of the platelet concentration of the plasma/platelet layer, so a “snapshot” of the platelet content can be estimated by comparing the two values over a period of time and then integrating the area therebetween during that time. The integrated value can be extrapolated to the total volume of blood processed to estimate the current yield.

When the current platelet yield is known, the platelet pre-count of the donor can be estimated. This may be estimated, for example, by considering the amount of detected platelets and the volume of blood that has been processed (i.e., the current platelet yield), then comparing those values (along with any other necessary information, such as donor hematocrit, weight, and gender, for example) to empirical data indexing such values with known platelet pre-counts. These calculations may be performed by the software of the system controller or the data may be transmitted to an external integrator before the results are returned to the system as a platelet pre-count.

This information may be used to calculate a number of other values, for example, the volume of blood to be processed to collect a target amount of platelets. In one example, this is calculated by feeding the calculated platelet pre-count, the target platelet yield, and any other necessary information (such as donor hematocrit, weight, and gender) into a predictor that calculates the volume of blood to be processed. If the calculated volume is greater than the volume of blood in the system, then the process may be modified to include additional draw stages to draw additional blood from the donor or the system may give the operator the option to collect less platelets than the target amount.

This information may also be used to calculate the processing time required to collect a target amount of platelets using, for example, a calculation process similar to that described previously with regard to the volume of blood to be processed to collect a target amount of platelets. If the calculated processing time exceeds a selected “maximum” processing time (due, for example, to a donor having a below-average platelet pre-count), the system may present the operator with a number of options. For example, in one example, the expected products are one unit of single dose platelets, one unit of red blood cells, and one unit of plasma. In this case, the operator can be given the option of collecting only the red blood cells and plasma (while returning the platelets to the donor) or collecting the full amounts of red blood cells and plasma and a partial dose of platelets. Alternatively, the choice to modify the expected products during the procedure may be made by the system controller rather than by the operator.

Other adjustments may also be made to the collection procedure during processing for optimal performance. For example, in one example, the target range for collected platelets is between 3.0×10¹¹ (the industry requirement) and 4.7×10¹¹ (the maximum platelet capacity of an exemplary platelet collection container). If it is determined that the platelet yield will exceed the target value or range, the spin speed of the chamber may be increased to sediment some of the platelets out of the plasma/platelet layer. As an additional benefit, increasing the spin speed will also reduce the white blood cell content of the plasma/platelet layer. Alternatively, if it is determined that the platelet yield will fall below a targeted value or range, the spin speed of the chamber may be decreased to pull more platelets from the interface into the plasma/platelet layer. Yet another option is to use the calculated platelet yield to calculate the optimal amount of platelet storage fluid (e.g., platelet poor plasma or non-plasma storage solution or a combination thereof) to use for storing the platelets.

Those having skill in the art will appreciate that other quantities can also be calculated by measuring the amount of platelets in the tubing 610 (e.g., outlet tubing) during this recirculation stage.

### I. Platelet Harvesting Stage

After a sufficient recirculation period, the plasma/platelet layer is collected through the first outlet 542 (e.g., plasma outlet) (port PO6) into the platelet collection container 574 (port PO4). This is achieved by continuing the immediately preceding recirculation stage, but adding a platelet storage fluid (platelet poor plasma from the plasma collection container 576 and/or non-plasma storage solution from the platelet storage solution container) to the circulating fluid. The additional fluid replaces the fluid volume lost within the chamber 500 due to collection of the plasma/platelet layer.

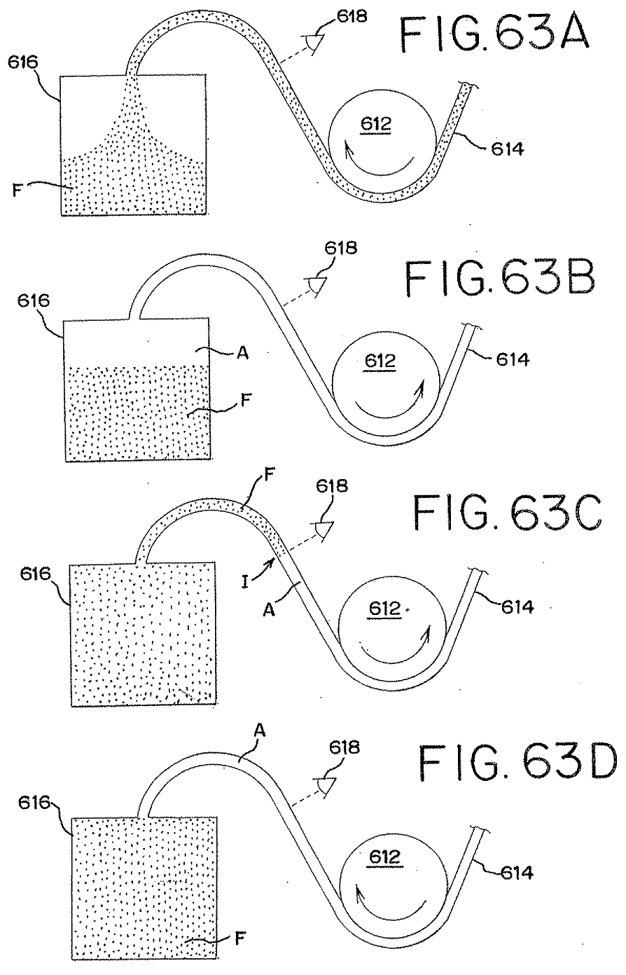

In particular, as shown in FIG. 58B, the contents of the plasma pump PU2 and the contents of the donor pump PU3 flow to the in-process pump PU1. The contents of the in-process pump PU1 are then pumped into the chamber 500 (port PO5) as the donor pump PU3 is filled with packed red cells exiting the chamber 500 (port PO7) and the plasma pump PU2 is filled with a platelet storage fluid. In one example, illustrated in FIG. 60A, the plasma pump PU2 is filled with plasma from the plasma collection container 576 (port PO3). In another example, illustrated in FIG. 60B, the plasma pump PU2 is instead filled with non-plasma storage solution from the platelet storage solution container (port PO11).

With this additional fluid in the plasma pump PU2, the contents thereof and the contents of the donor pump PU3 again flow into the in-process pump PU1 (FIG. 58B). Finally, the in-process pump PU1 is emptied into the chamber 500 (port PO5), with the plasma/platelet layer being displaced out of the first outlet 542 (e.g., plasma outlet) (port PO6) to the platelet collection container 574 (port PO4) and the packed red cells flowing from the second outlet 544 (e.g., red blood cell outlet) (port PO7) to the donor pump PU3 (alternatively illustrated in FIGS. 60A and 60B). These sub-phases alternate (i.e., between the sub-phase illustrated in FIG. 58B and the sub-phase illustrated in FIG. 60A/60B), thereby creating a recirculation loop into and out of the chamber, with an amount of the plasma/platelet layer being collected during each iteration of the loop.

The sub-phases illustrated in FIGS. 60A and 60B may be practiced independently (e.g., employing only the sub-phase of FIG. 60A in combination with the sub-phase of FIG. 58B to harvest and store platelets in platelet poor plasma) or combined during a given procedure. For example, the platelet harvesting stage may following a repeating loop from the sub-phase illustrated in FIG. 58B, to the sub-phase illustrated in FIG. 60A, to the sub-phase illustrated in FIG. 58B, to the sub-phase illustrated in FIG. 60B, and finally back to the beginning of the loop. Such a harvesting loop may be modified depending on the particular process, for example, by employing a loop initiating two FIG. 60A sub-phases for every FIG. 60B sub-phase that is initiated. In yet another example, non-plasma storage solution is used to displace and store platelets (i.e., the FIGS. 58B and 60B sub-phases are alternated) until a target amount of storage solution has been used, at which time platelet poor plasma is used to displace and store the platelets (i.e., the FIGS. 58B and 60A sub-phases are alternated) until the target platelet yield is achieved.

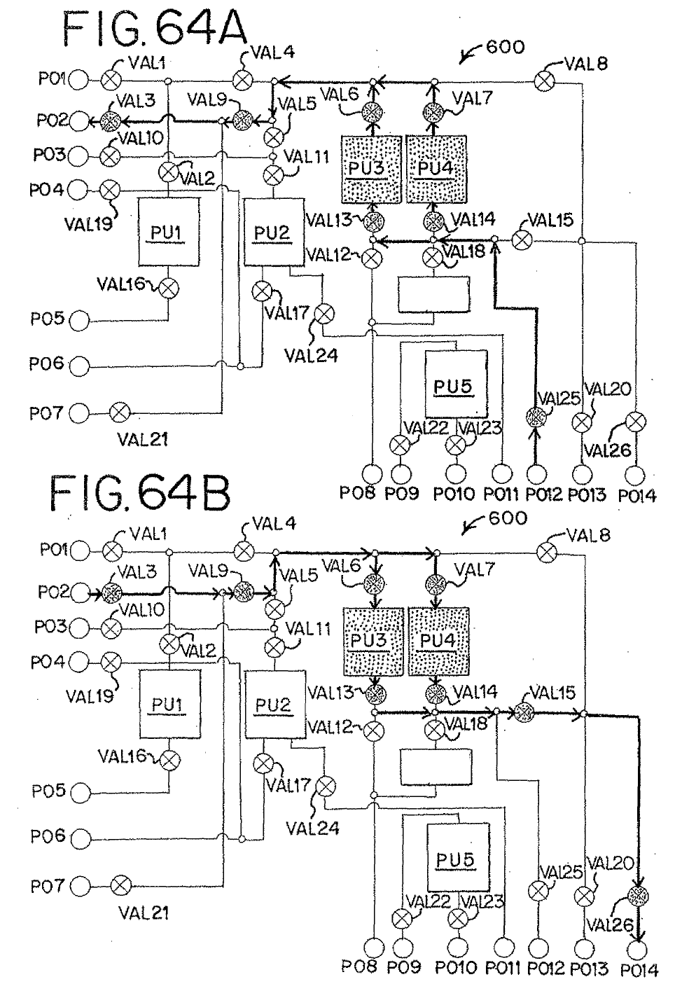

One phenomenon that has been observed is the plasma/platelet layer becoming contaminated by white blood cells during the platelet harvesting stage. Rather than a uniform or continuous contamination, the white blood cells typically surge into the plasma/platelet layer in a single “burst” shortly after the harvesting stage begins. A diagram of the white blood cell contamination is shown in FIG. 61A. Typically, this “burst” is detected approximately one minute after the beginning of the harvesting stage, which has led to the belief that the “burst” is caused by non-plasma storage solution reaching the chamber. The non-plasma storage solution is less dense than the plasma/platelet layer, and this slight difference in physical properties may disturb the interface, causing white blood cells to spill through the first outlet 542 (e.g., plasma outlet). Typically, around the two-minute mark of the harvesting stage, the white blood cell concentration (as detected by the optical sensor associated with the tubing 610 (e.g., outlet)) will begin to decrease and, around the three-minute mark, the white blood cell concentration will be at or below the level at the beginning of the platelet harvesting stage.

It is known that increasing the spin speed of the chamber 500 will force more white blood cells into the interface, so the “burst” may be combated by spinning the chamber 500 at a higher speed during the harvesting stage. However, increasing the spin speed also degrades the platelet recovery, as some of the larger platelets will be forced into the interface with the white blood cells. Accordingly, it may be advantageous to operate the chamber at an elevated spin speed only during the beginning of the platelet harvesting stage (i.e., during the time of the “burst”) and decrease the speed during the remainder of the stage, as is shown in FIGS. 61B-61D. In an exemplary example, the recirculation stage is carried out at a spin speed of approximately 2700 RPM, which may be gradually or incrementally increased to an elevated speed (around 3000 RPM in one example) before being decreased to the original spin speed.

FIGS. 61B and 61C illustrate two different spin speed profiles for combating the “burst.” In the example of FIG. 61C, the spin speed is increased at a rate of approximately 300 RPM/min, such that the chamber will be spinning at approximately 3000 RPM at the time that the “burst” typically occurs. The spin speed remains at 3000 RPM for approximately one minute and then, at the two-minute mark, the spin speed is ramped down at, for example, 300 RPM/min to the original spin speed, where it remains for the rest of the harvesting stage.

FIG. 61D illustrates yet another possible spin speed profile. This profile is similar to that of FIG. 61C, but the spin speed is ultimately ramped down to a speed below the spin speed at the beginning of the harvesting stage, for example 2500 RPM. This may be advantageous to compensate for the decreased collection efficiency during the elevated spin speed and may be employed without risking additional contamination, as it has been observed that the white blood cell concentration detected by the optical sensor is relatively low after the three-minute mark of the harvesting stage. These illustrated spin speed profiles are merely illustrative, and other “burst”-combating spin speed profiles may also be employed without departing from the scope of the present disclosure. This principle may also be employed to combat other contamination profiles, such as those characterized by multiple “bursts” or the like.

In yet another example, the platelet harvesting stage may be modified by incrementally decreasing the spin speed of the chamber while the plasma/platelet layer is being collected. So decreasing the spin speed will move the interface closer to the inner side wall portion 502 (e.g., low-g wall), thereby pushing the platelets toward the first outlet 542 (e.g., plasma outlet) and increasing the efficiency of the system. This example is best employed when only platelet poor plasma is used to collect and store the platelets, as the use of platelet poor plasma alone will typically avoid the aforementioned “burst” of white blood cells.

Regardless of the particular chamber spin speed profile that is employed during the platelet harvesting stage, it may be advantageous to continue monitoring the platelet concentration of the plasma/platelet layer as it is being collected to determine when the target amount of platelets has been collected. The yield can be calculated, for example, by comparing a curve plotting a baseline optical density to a curve plotting the detected optical density. The difference between the two values is indicative of the platelet concentration of the plasma/platelet layer, so the amount of platelets collected can be calculated by comparing the two values during the platelet harvesting stage and then integrating the area between the curves periodically. If the optical reading differs from that which is expected, the spin speed of the chamber may be changed to bring it back in line (e.g., by increasing the spin speed to decrease the optical density of the plasma/platelet layer or decreasing the spin speed to increase the optical density of the plasma/platelet layer). The optical readings taken during the platelet harvesting stage or the final platelet yield calculated during the recirculation stage (described above) may be used to make on-the-fly adjustments to the amount of storage fluid ultimately added to the platelet collection container.

When the target platelet yield has been reached, the system may operate to flow plasma and/or non-plasma storage solution directly to the platelet collection container (bypassing the chamber) if need be.

Although the majority of leukocytes in the plasma/platelet layer will sediment therefrom during the aforementioned recirculation stages, some leukocytes typically remain in the collected fluid. The illustrated disposable sets 556 and 558 show the associated in-line leukoreduction filter 580 between the chamber 500 and the platelet collection container 574. In such examples, the plasma/platelet layer that is pumped out of the chamber 500 by the plasma pump PU2 is pumped through the associated in-line leukoreduction filter 580 and into the platelet collection container 574 while the chamber 500 is still spinning and processing the blood components. In one example, a reduction of white blood cells from approximately 1.0×10⁷ to approximately 1.0×10⁴ on account of an in-line luekoreduction filter was observed.

### J. Red Blood Cell Harvesting Stage

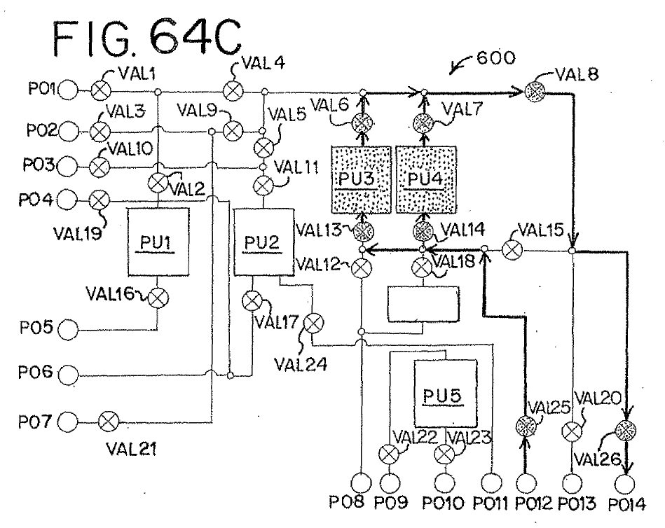

When the platelet harvesting stage is complete, the system continues with a red blood cell harvesting stage. During this stage, the valves VAL17 and VAL19 associated with the first outlet 542 (e.g., plasma outlet) are closed and the spin speed of the chamber 500 is increased to a “hard spin” of, for example, approximately 4500 RPM. The in-process pump PU1 delivers platelet poor plasma from the plasma collection container 576 (port PO3) to the chamber 500 via the inlet 510 (e.g., whole blood inlet) (port PO5), as shown in FIG. 62. The incoming plasma forces the packed red blood cells out of the second outlet 544 (e.g., red blood cell outlet) (port PO7), where they are directed to the red blood cell collection container 578 (port PO2).

### K. Post-Processing Stage

After the platelets and red blood cells have been collected, any of a number of post-processing procedures may be initiated, a number of which are described below.

### 1. Burping The Platelet Product

As a result of the manufacturing process, there may be some air present in the tubing leading from the cassette 592 to the platelet collection container 574 or in the associated in-line leukoreduction filter 580, which means that the plasma/platelet layer passing through the associated in-line leukoreduction filter 580 will force the air into the platelet collection container 574. For a number of well-known reasons, it is desirable to avoid air in the collection container. Accordingly, the platelet collection container 574 may include a length of tubing leading to the air burp bag 582, as shown in FIGS. 47 and 48. Air is removed from the collected platelet product by closing the inlet tubing (typically with a clamp) and squeezing the platelet collection container 574 (e.g., flexible container), thereby forcing air into the air burp bag 582. The operator watches the tubing to the air burp bag 582 to ensure that little to no platelet product leaves the platelet collection container 574 during the burping process.

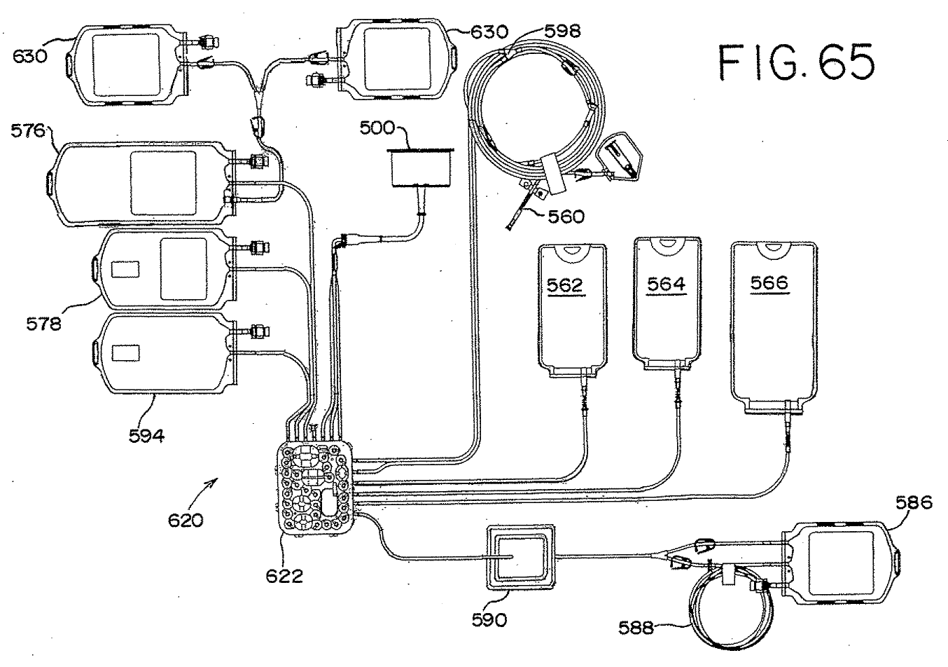

Alternatively, rather than employing a manual burping process, an automated burping process is possible. FIGS. 63A-63D show an illustrative automated burping process. First, a pump 612 is operated in a forward direction to pump fluid “F” through a conduit 614 to a flexible collection container or collection container 616 (FIG. 63A). When all of the fluid “F” has been pumped into the collection container 616, there will be an amount of air “A” above the fluid “F.” To remove the air, the pump 612 is operated in a reverse direction to pull the air “A” and fluid “F” back out of the collection container 616 (FIG. 63B). As air “A” and fluid “F” are being removed from the collection container 616, an optical sensor 618 (e.g., a QPrOX™ sensor from Quantum Research Group Ltd. of Hamble, England) monitors the conduit 614. The optical sensor 618 is adapted to distinguish between air and fluid in the conduit 614 and may be configured according to known design.

When the optical sensor 618 detects the air-fluid interface “I” in the conduit 614 (FIG. 63C), it signals for the pump 612 (or signals to an intermediary, such as a controller, that commands the pump) to stop operating in the reverse direction and switch to operating in the forward direction. The pump 612 continues to run in the forward direction until the fluid “F” in the conduit 614 has been returned to the collection container 616, with the air “A” remaining in the conduit 614 (FIG. 63D). The volume of fluid “F” in the conduit 614 can be calculated, based on the geometry of the conduit 614 and the distance between the collection container 616 and the optical sensor 618, so the pump 612 may be operated for a predetermined number of forward cycles (each of which returns a calculable volume of fluid “F” to the collection container 616) to return the fluid “F” to the collection container 616. It will be appreciated that such an automated process may be employed to remove air from the collected blood component(s) in any of the collection containers described herein.

This automated burping process may be variously modified without departing from the scope of the present disclosure. For example, rather than performing a predetermined number of pump cycles to return fluid from the conduit 614 to the collection container 616, the operator may be given the option (via a touch screen or other user interface system) to enter the number of cycles to perform. In another example, the operator may be given the option to order a pump cycle (either a forward or reverse cycle) at the touch of a button or icon. In yet another example, the system controller may automatically burp the collection container and thereafter give the operator the option of confirming that there has been sufficient purgation and, if not, allow the operator to order individual or multiple pump cycles.

### 2. Red Blood Cell Storage and Filtration

The disposable sets 556 and 558 illustrated in FIGS. 47 and 48 include the red blood cell storage container 586, which is distinct from the red blood cell collection container 578. For reasons that are well-known, it is beneficial to add an additive solution (e.g., Adsol® or SAG-M) to packed red cells. While it is possible to add an additive solution from the red blood cell additive solution container 564 to the packed red cells in the red blood cell collection container 578 after processing, doing so requires an additional mixing step that is typically performed manually. Rather than carrying out such a procedure, it may be advantageous to automatically mix the packed red cells and additive solution as they are flowing into the red blood cell storage container 586. This can be achieved, for example, by an interleaving process whereby a first phase of pumping an amount of packed red cells from the red blood cell collection container 578 to the red blood cell storage container 586 is alternated with a phase of pumping an amount of additive solution from the red blood cell additive solution container 564 to the red blood cell storage container 586. By alternating the two phases, the contents of the red blood cell storage container 586 are automatically mixed without requiring manual intervention.

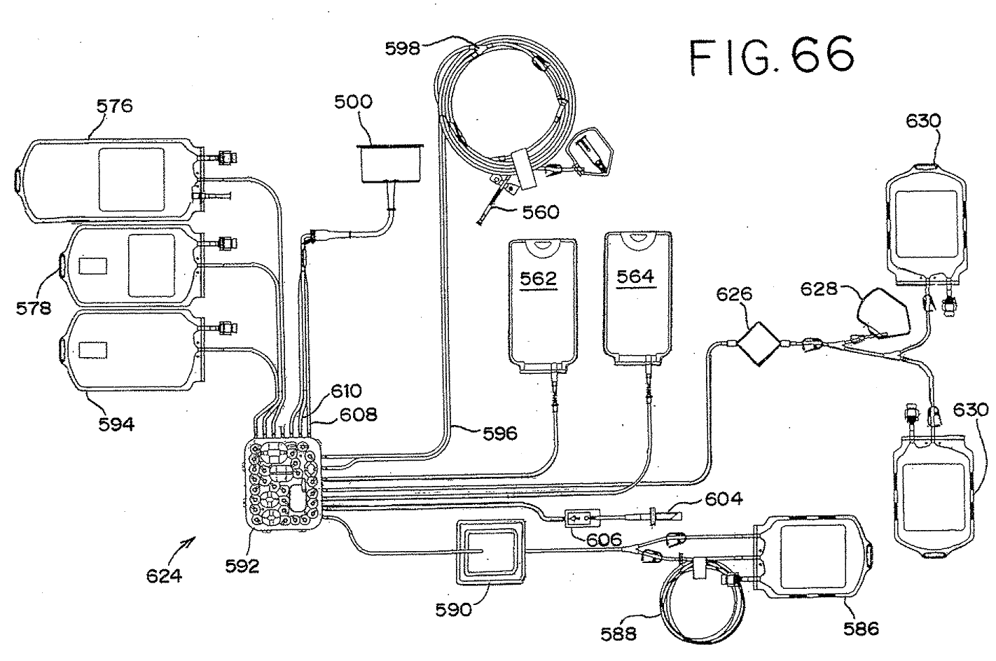

The above mixing procedure is illustrated in greater detail in FIGS. 64A-64C. FIG. 64A shows an additive solution prime stage, whereby the donor pumps PU3 and PU4 are operated to flow additive solution from the red blood cell additive solution container 564 (port PO12) to the red blood cell collection container 578 (port PO2), thereby priming the tubing between the red blood cell additive solution container 564 and the cassette 592. Next, FIG. 64B shows the donor pumps PU3 and PU4 operating to flow packed red cells from the red blood cell collection container 578 (port PO2) to the red blood cell storage container 586 (port PO14).

As shown in the disposable sets 556 and 558 of FIGS. 47 and 48, there may be the in-line leukoreduction filter 590 associated with the tubing between the cassette 592 and the red blood cell storage container 586, thereby filtering the packed red cells as they are pumped to the red blood cell storage container 586. After a certain number of pump cycles, the system switches to pumping additive solution from the red blood cell additive solution container 564 (port PO12) to the red blood cell storage container 586 (port PO14) for a certain number of pump cycles (FIG. 64C), and then the phases of pumping packed red cells and additive solution are alternated until the red blood cell collection container 578 is empty.

If the amount of additive solution required to achieve a target ratio (2.1:1 in one example) has not been pumped to the red blood cell storage container 586 by the time the red blood cell collection container 578 is empty, a final phase of pumping additional additive solution to the red blood cell storage container 586 may be initiated.

### 3. Platelet Poor Plasma Storage and Filtration

In addition to filtering the collected packed red cells, any platelet poor plasma remaining in the plasma collection container 576 may be similarly pumped through a leukoreduction filter and stored in a plasma storage container (not illustrated).

A manual or automated burping process (e.g., the automated process described above with regard to the collected platelets) may be employed to remove any excess air from the filtered plasma and/or packed red cells. If the disposable set is not provided with an air burp bag for a particular filtered blood component, the air may be directed to one of the empty containers, for example, to the empty red blood cell collection container 578.

When the various blood components are in their final storage containers, the containers are typically weighed or otherwise analyzed to confirm that the target yield has been achieved and thereafter separated from the disposable set, which is discarded. Depending on the configuration of the disposable set, samples of the various components may also be taken using, for example in the disposable sets 556 and 558 of FIGS. 47 and 48, the sampling pack 584 for the harvested platelets and a length of the segmented tubing 588 for the harvested packed red cells.

### L. Other Modifications

Various modifications to the above-described method are possible. One modification includes operating the in-process pump PU1 between at least two different pumping rates to effect recombination of the blood components. For example, fluid may be pumped into the chamber 500 by the in-process pump PU1 at a first flow rate while being rotated in a clockwise or counterclockwise direction, and then the rotation in either direction is repeated at a second flow rate. The centrifugal force may be decreased, such as by decreasing the rotor speed, where more than one flow rate is used.

Another modification includes operating the plasma pump PU2 during recombination. Plasma is collected through the first outlet 542 (e.g., plasma outlet) and flows into the in-process container 594. Simultaneously, the flow at the inlet 510 (e.g., whole blood inlet) is reversed using the in-process pump PU1 so that fluid from the chamber 500 also flows into the in-process container 594 through the inlet 510 (e.g., whole blood inlet). The fluid in the in-process container 594 is then allowed to flow back into the chamber 500 through the inlet 510 (e.g., whole blood inlet). Therefore, the fluid components are mixed together outside of the chamber 500 and then re-enter the chamber.

It is further possible to modify the pump ratio between the in-process PU1 and plasma pumps PU2 during the collection phase to different ratios at different times during the procedure.

In yet another example, a 13-port cassette (e.g., one according to the foregoing description of the cassettes 28 and 28′) may be employed rather than the cassette 592 (e.g., 14-port cassette). This may be achieved, for example, by collecting and storing platelets using only platelet poor plasma, which allows the non-plasma platelet storage solution container to be omitted, thereby alleviating the need for one cassette port. Other modifications are also possible.

### IX. Red Blood Cell and Plasma Collection with Enhanced Functionality

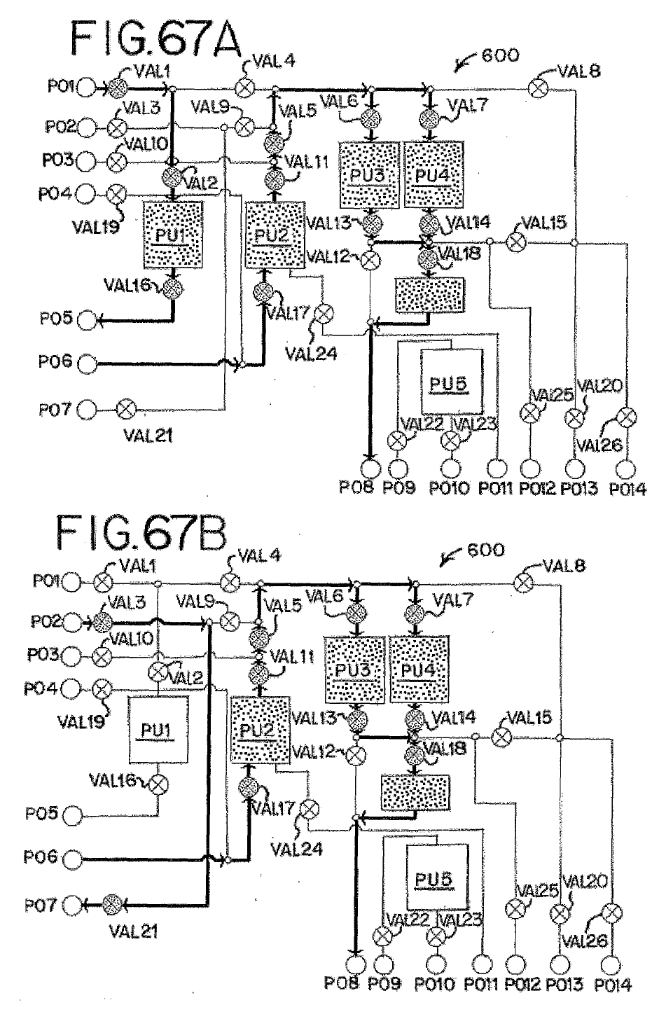

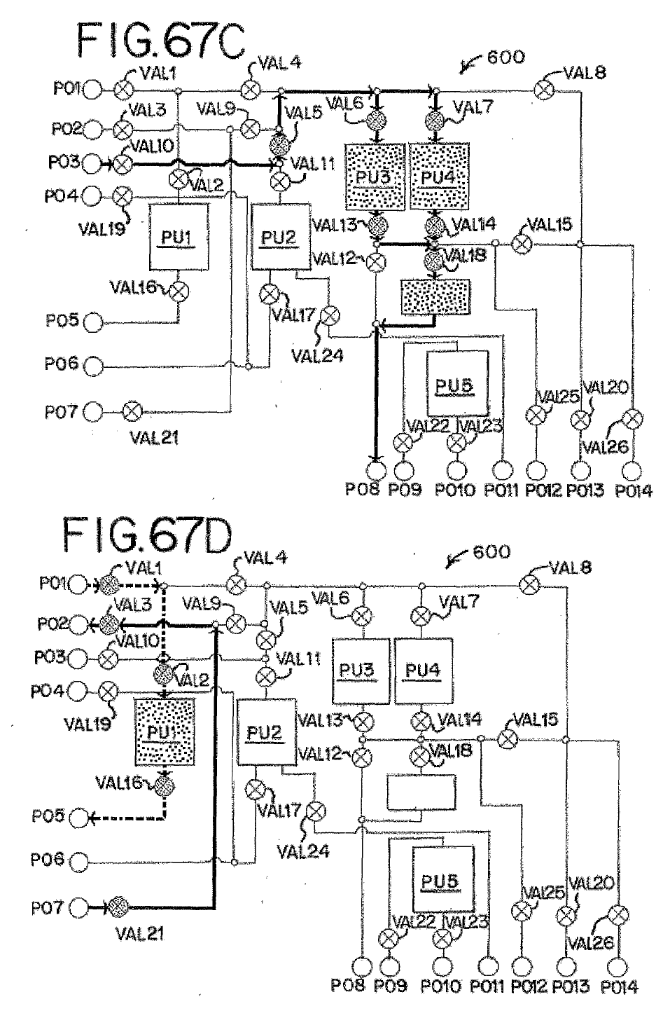

Another benefit of a disposable set incorporating a 14-port cassette is that it can be used to provide enhanced functionality to procedures typically carried out with a 13-port cassette. For example, FIG. 65 illustrates a disposable set 620 with a 13-port cassette 622 that is suitable for use in practicing the previously described red blood cell and plasma collection process. The disposable set 620 is adequate when there is no need to filter the collected plasma, such as for procedures that are carried out in the United States. However, European standards for plasma purity are higher than in the United States, and it is advantageous to filter the collected plasma to remove cellular blood components (particularly white blood cells). Hence, a disposable set 624 (FIG. 66) incorporating the cassette 592 (e.g., 14-port cassette) may be provided. The additional port allows for the inclusion of tubing leading to an in-line filter 626, an air burp bag 628, and a pair of plasma storage containers or storage containers 630. It will be seen that the disposable set 624 is similar to the sets illustrated in FIGS. 47 and 48, differing principally in the omission of a platelet collection container and a platelet storage solution container, and the inclusion of the in-line filter 626, the air burp bag 628, and the storage containers 630 associated with cassette port PO11.

### A. Draw Stage

In an exemplary procedure for harvesting red blood cells and plasma using the disposable set 624 of FIG. 66 (in combination with a suitable blood processing device, such as the one illustrated in FIG. 1), whole blood is pumped from a blood source to a separation device (e.g., the chamber 500 of FIGS. 44-46) and the in-process container 594. Anticoagulant from the anticoagulant container 562 is added to the whole blood by operation of the anticoagulant pump PU5 of the cassette 592. The anticoagulated blood may flow into the chamber 500 either from the blood source, or may flow from the in-process container 594, where the blood from the blood source is temporarily stored for subsequent processing by the chamber 500. The draw procedure can be understood with further reference to the flow diagrams illustrated in FIGS. 52A and 52B.

### B. Separation and Collection Stage

Next, within the chamber 500, the fluid components are separated based on density, as shown in FIG. 46, while the chamber spins at a “hard spin” rate of, for example, approximately 4500 RPM. As the interface 554 is pooling upstream of the barrier 516, fluid may be collected separately from either side of the interface—or both sides thereof—through the respective outlet 542 or 544 depending on the requirements of the procedure. For example, in one example (corresponding generally to the flow diagram of FIG. 53), of the plasma 550 (e.g., some platelet poor plasma) is collected radially inward of the interface 554 through the first outlet 542 (e.g., plasma outlet) and into the plasma collection container 576. Simultaneously, some of the red blood cells 552 are collected radially outward of the interface 554 through the second outlet 544 (e.g., red blood cell outlet) and flow into the red blood cell collection container 578.

### 1. Reactive Spill Prevention and Control

In one example, the plasma collection rate is determined by the operating rate of the plasma pump PU2 of the cassette 592. The operating rate of the plasma pump PU2 may be constantly ramped to bias the system toward an overspill condition. This may be advantageous because an overspill condition can typically be corrected more quickly than an underspill condition. In particular, an overspill condition can be corrected by stopping the plasma pump PU2, thereby placing the second outlet 544 (e.g., red blood cell outlet) of the chamber 500 in a “flow-through” condition until a calculated volume of blood has been pumped into the chamber 500. Thereafter, the fluid in the outlets 542 and 544 (e.g., plasma and red blood cell outlets) may be recirculated back into the chamber 500 (via the in-process pump PU1) to flush the associated outlet tubing lines of undesirable material.

In contrast, an underspill condition can be corrected by closing the second outlet 544 (e.g., red blood cell outlet) and operating the plasma pump PU2 in a “flow-through” state until a set volume of blood has been pumped into the chamber 500 or an overspill condition is detected. The underspill condition is finally corrected by opening the second outlet 544 (e.g., red blood cell outlet) and operating the plasma pump PU2 at a lower rate until a set volume of fluid has flown through the second outlet 544 (e.g., red blood cell outlet) or an overspill condition is detected.

If the plasma is deemed to be lipemic, it may be advantageous to instead operate the plasma pump PU2 at a constantly decreasing rate to bias the system toward an underspill condition. Such bias protects the collected plasma product from platelet contamination, as it may be difficult for the optical sensor associated with the plasma outlet line to distinguish between platelets and lipemic plasma.

### 2. Predictive Spill Prevention and Control

In an alternative example, the hematocrit of the fluid exiting the second outlet 544 (e.g., red blood cell outlet) may be monitored by an optical sensor. The hematocrit is indicative of the radial location of the interface 554, so the detected hematocrit may be employed to assess the location of the interface 554 and change the chamber spin speed to avoid a spill condition.

The reactive and predictive spill control systems may also be practiced together, for example, with the detected hematocrit being the primary means of controlling the location of the interface 554 and the biased pumping system being used as a back-up.

### C. Return Stage

The separation and collection stage typically will continue until the desired amount of plasma and red blood cells have been collected or are present in the system. For example, in one example, the amount of red blood cells includes the packed red cells in the red blood cell collection container 578, the red blood cells present in the whole blood remaining in the in-process container 594, and the red blood cells in the chamber 500 that have yet to be collected.

Depending on the target yields, the target amount of one component (typically red blood cells) may be present in the system before the target amount of the other component (typically plasma) has been collected, so the duration of the separation and collection stage will be determined by the time required to collect one of the components. In the event that the target volume of one of the components (e.g., red blood cells) is obtained before the other (or is expected to be obtained before the other), that component may be periodically returned to the blood source during the separation and collection stage. Most advantageously, such return phase is carried out while blood is being pumped from the in-process container 594 to the chamber 500, as described above with regard to the Red Blood Cell/Platelet/Plasma collection procedure, to allow for simultaneous processing and fluid return.

### D. Final Return and Collection Stage

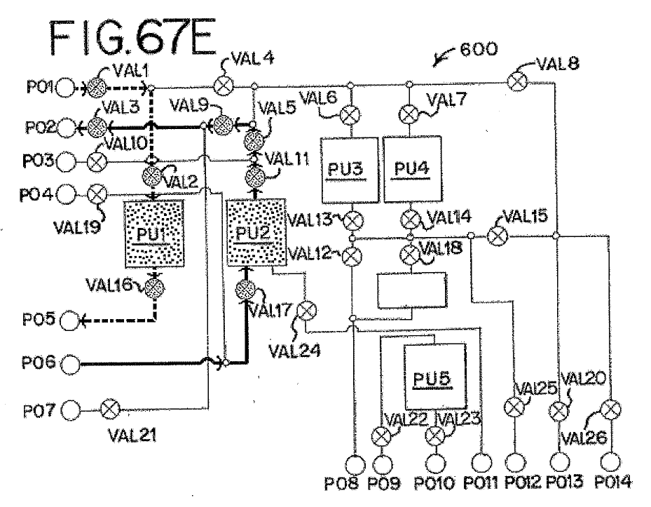

With the target amounts of red blood cells and plasma present in the system, the system may move into a final return and collection stage. In one example, any plasma remaining in the chamber 500 is first returned to the blood source. This is achieved by maintaining the chamber at a “hard spin” speed while operating the in-process pump PU1 to convey blood from the in-process container 594 (port PO1) into the chamber 500 via the inlet 510 (port PO5), as shown in FIG. 67A. The blood entering the chamber 500 forces plasma out of the first outlet 542 (e.g., plasma outlet) (port PO6), and the plasma is then conveyed to the blood source (PO8) by operation of the plasma pump PU2 and the donor pumps PU3 and PU4.

Returning the plasma to the blood source has the effect of moving the interface closer to the inner side wall portion 502 (e.g., low-g wall) of the chamber 500. To return the interface layer to the blood source, the spin speed of the chamber 500 is reduced while the in-process pump PU1 continues to convey blood from the in-process container 594 (port PO1) into the chamber 500 via the inlet 510 (port PO5), as shown in FIG. 67A. At the lower spin speed, the interface will be close to the inner side wall portion 502 (e.g., low-g wall), so the blood entering the chamber 500 forces the interface out of the first outlet 542 (e.g., plasma outlet) (port PO6), and the interface is then conveyed to the blood source (port PO8) by operation of the plasma pump PU2 and the donor pumps PU3 and PU4. This “flush interface” phase continues until the in-process container 594 falls below a set volume, as may be determined by a weight sensor associated with the in-process container 594. In one example, the “flush interface” phase continues until the in-process container 594 is empty.

When the interface has been flushed from the chamber 500, the volume of packed red cells in the red blood cell collection container 578 is assessed to determine whether there are any excess red blood cells in the system. If so, the in-process pump PU1 is stopped, while the plasma pump PU2 and the donor pumps PU3 and PU4 continue to operate, thereby pulling some packed red cells from the red blood cell collection container 578 (port PO2) into the chamber 500 via the second outlet 544 (e.g., red blood cell outlet) (port PO7), as shown in FIG. 67B. The red blood cells entering the chamber 500 force excess red blood cells in the chamber 500 out the first outlet 542 (e.g., plasma outlet) (port PO6), to be returned to the blood source (port PO8). It will be appreciated that the hematocrit of the packed red cells entering the chamber 500 from the red blood cell collection container 578 is greater than that of the red blood cells exiting the chamber 500, thereby effectively increasing the hematocrit of the fluid in the chamber 500.

Next, the volume of plasma in the plasma collection container 576 is assessed to determine whether there is any excess plasma in the system. If so, the plasma pump PU2 is stopped, while the donor pumps PU3 and PU4 continue to operate, and the flow path through the cassette 592 is modified to direct any excess plasma from the plasma collection container 576 (port PO3) to the blood source (port PO8), entirely bypassing the chamber 500 to avoid lowering the hematocrit of the fluid therein. This phase is illustrated in FIG. 67C. The blood source may be disconnected from the system at this time.

Next, air from the empty in-process container 594 (port PO1) is pumped into the chamber 500 by the in-process pump PU1, as shown in FIG. 67D. The valves VAL17 and VAL19 associated with the plasma outlet port PO6 are closed, thereby causing the air entering the chamber 500 to force the red blood cells therein out the second outlet 544 (e.g., red blood cell outlet) (port PO7) to the red blood cell collection container 578 (port PO2). This phase continues until the red blood cells in the chamber 500 have been conveyed to the red blood cell collection container 578, which may be identified when the weight sensor associated with the red blood cell collection container 578 stops registering an increase in volume.

When the red blood cells have been conveyed from the chamber 500 to the red blood cell collection container 578, the valve VAL21 associated with the red blood cell outlet port PO7 is closed and the plasma outlet port PO6 is opened, while continuing to pump air into the chamber 500 from the in-process container 594 (FIG. 67E). The air pumped into the chamber 500 is directed out the first outlet 542 (e.g., plasma outlet) (port PO6), thereby flushing any red blood cells in the plasma pump PU2 or outlet line to the red blood cell collection container 578 and completing collection of the red blood cells. If the blood source is still attached to the system, saline from a saline container may be pumped to the blood source to flush any blood components in the return line (typically red blood cells) to the blood source, and then the blood source is finally disconnected from the system.

### E. Flush Stage

The above final return and collection stage may be replaced by a conditional “flush” stage that is employed if the collection procedure is stopped prematurely or otherwise interrupted.

The “flush” stage operates to return fluid to the blood source. In one example, the chamber spin speed is ramped down to zero while blood from the in-process container 594 is conveyed to the blood source and excess red blood cells and plasma are returned from their respective collection container, with the material being returned using the donor pumps PU3 and PU4 of the cassette 592. Most advantageously, the contents of the containers are returned to the blood source while bypassing the chamber 500, which can be achieved by properly programming the valves VAL1-VAL26 of the cassette 592. If the plasma or red blood cell level is below the target volume (e.g., if the procedure was stopped prematurely), the operator may be given the option to convey the entire contents of the associated collection container to the blood source. Alternatively, the system may attempt to salvage some of the components by retaining an amount less than the target volume, such as by retaining one unit of a component after an interruption prevents collection of the targeted two units.

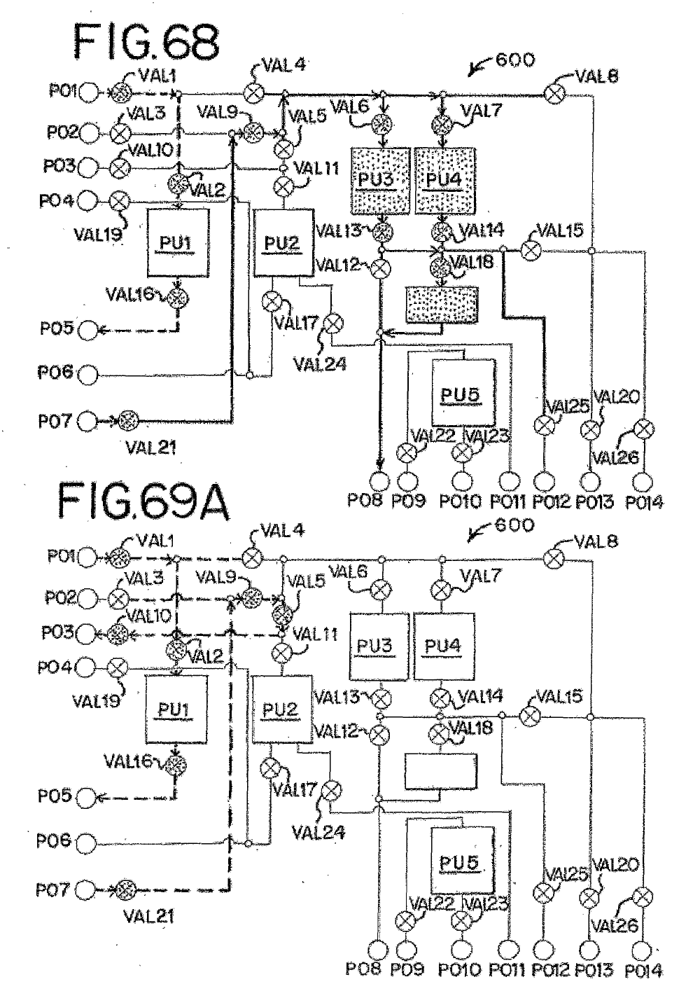

When the chamber 500 has stopped spinning, the system moves to an “air flush” phase to begin flushing any excess fluid remaining in the system to the blood source. In this phase, the in-process pump PU1 conveys air from the in-process container 594 into the chamber 500 (FIG. 68). The air forces some (about half) of the contents of the chamber 500 out of the second outlet 544 (e.g., red blood cell outlet) (port PO7), before the donor pumps PU3 and PU4 are operated to return the flushed contents to the blood source (port PO8).

Next, the various pumps are stopped and the chamber spin speed is increased to a “flush chamber” speed of, for example, about 1000 RPM. When the spin speed has reached the target level, the above “air flush” phase (FIG. 68) is repeated to flush more of the contents of the chamber 500 to the blood source. This may be followed by a “saline return” stage, whereby the donor pumps PU3 and PU4 of the cassette 592 pump saline from a saline container (not illustrated) to the blood source, thereby flushing cells in the tubing back to the blood source.

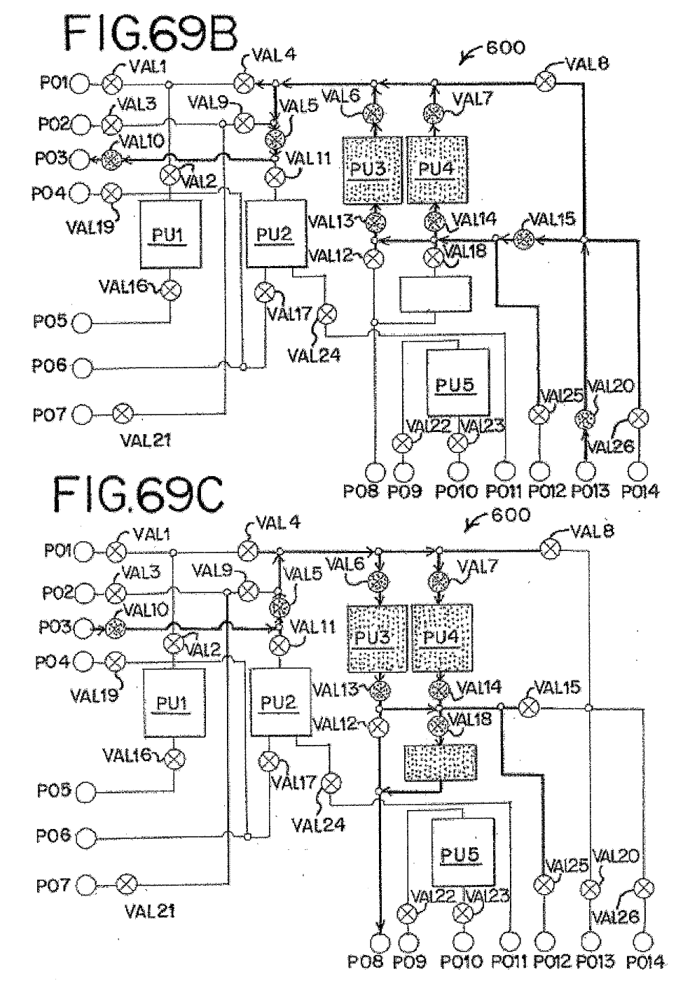

However, if the contents of the plasma collection container 576 were previously returned to the blood source (e.g., when the decision has been made to not salvage any of the collected plasma), the “saline return” stage may be preceded by an additional “air flush” phase. Such a third “air flush” phase is illustrated in FIGS. 69A-69C. First, the above “air flush” phase is repeated, with the contents of the chamber 500 being flushed to the plasma collection container 576 (port PO3), rather than being returned to the blood source (FIG. 69A). This additional “air flush” phase substantially empties the chamber 500.

Finally, the flow path to the plasma collection container 576 is primed with saline (FIG. 69B) and the contents of the plasma collection container 576 are returned to the blood source (FIG. 69C). Thereafter, the blood source may be disconnected from the system.

### F. Filtration Stage

If at least one of the collected components (i.e., plasma or packed red cells) is being retained, the final return and collection of “flush” stage may be followed by a leukoreduction stage. As shown in FIG. 66, the disposable set 624 may include the red blood cell storage container 586 and at least one of the storage container 630 (e.g., plasma storage container). Each storage container includes the in-line leukoreduction filter 590 and/or the in-line filter 626, such that the component is filtered as it is pumped from the collection container to the storage container by the cassette 592. The leukoreduction of the packed red cells and/or plasma can be understood with reference to the corresponding stage of the Red Blood Cell/Platelet/Plasma collection procedure, described above.

### X. Other Blood Processing Functions

The many features of the present subject matter have been demonstrated by describing their use in separating whole blood into component parts for storage and blood component therapy. This is because the present subject matter is well adapted for use in carrying out these blood processing procedures. It should be appreciated, however, that the described features equally lend themselves to use in other blood processing procedures.

For example, the systems and methods described, which make use of a programmable cassette in association with a blood processing chamber, can be used for the purpose of washing or salvaging blood cells during surgery, or for the purpose of conducting therapeutic plasma exchange, or in any other procedure where blood is circulated in an extracorporeal path for treatment.

It will be understood that the examples described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims.

1. A centrifugal processing chamber, comprising:
first and second lateral walls spaced at a distance from one another;
a channel at least partially defined by the first and second lateral walls;
an inlet fluidly coupled to the channel to convey blood to the channel;
a first outlet fluidly coupled to the channel having a first opening adjacent the first lateral wall, wherein the first outlet is to convey separated plasma from the channel; and
a second fluid outlet fluidly coupled to the channel having a second opening adjacent the second lateral wall, wherein the second outlet is to convey separated red blood cells from the channel; and
a barrier formed along the second lateral wall to intercept platelets, wherein the first and second lateral walls are spaced such that the distance between the first and second lateral walls enables at least one therapeutic unit of single dose platelets to pool adjacent the barrier without spilling into the first outlet or the second outlet.

2. The centrifugal processing chamber as defined in claim 1, wherein the first opening is positioned between about a thirty degree angle and a sixty degree angle relative to and upstream from the second opening.

3. The centrifugal processing chamber as defined in claim 1, wherein the distance between the first and second lateral walls enables 6×10¹¹ platelets to pool adjacent the barrier without spilling into the first outlet or the second outlet

4. The centrifugal processing chamber as defined in claim 1, wherein the distance between the first and second lateral walls enables 7×10¹¹ platelets to pool adjacent the barrier without spilling into the first outlet or the second outlet.

5. The centrifugal processing chamber as defined in claim 1, wherein the first outlet is positioned on a first side of the barrier and wherein the second outlet is positioned on a second side of the barrier.

6. The centrifugal processing chamber as defined in claim 1, further comprising a first fluid outlet channel to fluidly couple the first outlet to the channel, wherein the first fluid outlet channel is defined by a first radial wall and second radial wall.

7. The centrifugal processing chamber as defined in claim 6, further comprising a step formed by the first lateral wall and the first radial wall, wherein the step is to be engaged by at least a portion of the separated plasma prior to entering the first fluid outlet channel.

8. The centrifugal processing chamber as defined in claim 1, further comprising a fluid inlet channel to fluidly couple the inlet to the channel, wherein the fluid inlet channel is defined by a third radial wall and a fourth radial wall.

9. The centrifugal processing chamber as defined in claim 8, wherein the fourth radial wall extends into the channel to enable the blood entering the channel from the fluid inlet channel to initially be positioned adjacent to the second lateral wall.

10. The centrifugal processing chamber as defined in claim 8, wherein the third radial wall engages the second lateral wall to separate a channel inlet region and a channel outlet region.

11. The centrifugal processing chamber as defined in claim 1, further comprising a second fluid outlet channel to fluidly couple the second outlet to the channel, wherein the second fluid outlet is defined by a third radial wall and a fifth radial wall.

12. The centrifugal processing chamber as defined in claim 1, further comprising an underpass to fluidly couple an upstream side of the barrier and a downstream side of the barrier.

13. The centrifugal processing chamber as defined in claim 1, further comprising a gap between an end of the barrier and the first lateral surface to enable fluid to flow between the gap.

14. The centrifugal processing chamber as defined in claim 1, further comprising a first recess adjacent an upstream side of the barrier and a second recess adjacent a downstream side of the barrier.

15. A disposable set for use with a blood processing system, comprising:
a processing chamber, comprising:
first and second lateral walls spaced at a distance from one another;
a channel at least partially defined by the first and second lateral walls;
an inlet fluidly coupled to the channel to convey blood to the channel;
a first outlet fluidly coupled to the channel having a first opening adjacent the first lateral wall, wherein the first outlet is to convey separated plasma from the channel;
a second fluid outlet fluidly coupled to the channel having a second opening adjacent the second lateral wall, wherein the second outlet is to convey separated red blood cells from the channel; and
a barrier formed along the second lateral wall to intercept platelets, wherein the first and second lateral walls are spaced such that the distance between the first and second lateral walls enables at least one therapeutic unit of single dose platelets to pool adjacent the barrier without spilling into the first outlet or the second outlet;
an umbilicus fluidly coupled to the processing chamber to convey fluids to and from the processing chamber;
a plurality of containers, wherein at least some of the containers are to store different blood components and other of the containers are to store different fluids;
a phlebotomy needle; and
a cassette, wherein the cassette is fluidly coupled to the processing unit, the umbilicus, the plurality of containers and the phlebotomy needle.

16. The disposable set as defined in claim 15, wherein the first opening is positioned between about a thirty degree angle and a sixty degree angle relative to and upstream from the second opening.

17. The disposable set as defined in claim 15, wherein the first outlet is positioned on a first side of the barrier and wherein the second outlet is positioned on a second side of the barrier.

18. The disposable set as defined in claim 15, further comprising a gap between an end of the barrier and the first lateral surface to enable fluid to flow between the gap.

19. A blood processing device, comprising:
a base comprising a centrifugal station;
a lid hingably coupled to the base, wherein the lid comprises a pump and valve station; and
a disposable set, comprising:
a processing chamber positioned adjacent the centrifugal station, wherein the processing chamber comprises:
first and second lateral walls spaced at a distance from one another;
a channel at least partially defined by the first and second lateral walls;
an inlet fluidly coupled to the channel to convey blood to the channel;
a first outlet fluidly coupled to the channel having a first opening adjacent the first lateral wall, wherein the first outlet is to convey separated plasma from the channel;
a second fluid outlet fluidly coupled to the channel having a second opening adjacent the second lateral wall, wherein the second outlet is to convey separated red blood cells from the channel; and
a barrier formed along the second lateral wall to intercept platelets, wherein the first and second lateral walls are spaced such that the distance between the first and second lateral walls enables at least one therapeutic unit of single dose platelets to pool adjacent the barrier without spilling into the first outlet or the second outlet;
an umbilicus fluidly coupled to the processing chamber to convey fluids to and from the processing chamber;
a plurality of containers, wherein at least some of the containers are to store different blood components and other of the containers are to store different fluids;
a phlebotomy needle; and
a cassette positioned adjacent the pump and valve station, wherein the cassette is fluidly coupled to the processing unit, the umbilicus, the plurality of containers and the phlebotomy needle.

20. The blood processing device as defined in claim 19, wherein the first opening is positioned between about a thirty degree angle and a sixty degree angle relative to and upstream from the second opening.
